(19) United States
(12) Patent Application Publication
(10) Pub. No.: US 2026/0266675 A1
(43) Pub. Date: Sep. 10, 2026

(54) MACHINE LEARNING TO PREDICT BOLT TENSION

(71) Applicant: PREDICTANT LLC, Raleigh, NC (US)

(72) Inventors: Ethan Loewenthal, Durham, NC (US); Joshua Scott, Raleigh, NC (US); Ashtad Javanmardi, Raleigh, NC (US); Klarissa Foresman, Raleigh, NC (US)

(21) Appl. No.: 18/843,189

(22) PCT Filed: Mar. 2, 2023
(86) PCT No.: PCT/US2023/063628

§ 371 Date: Aug. 30, 2024

Related U.S. Application Data
(60) Provisional application No. 63/315,849, filed on Mar. 2, 2022.

(51) Int. Cl. G01L 5/24

(52) U.S. Cl. CPC G01L 5/246

(57) ABSTRACT

The present disclosure provides systems and methods for determining tensile stress/residual tension of a target bolt using machine learning models. An example may including a method for generating a dataset to train one or more machine learning models to predict characteristics of a target bolt in situ. The method can include setting each of a plurality of test bolts to a plurality of known levels of tension. For each known level of tension set in each test bolt, determining times of-flight of shear wave and longitudinal wave signals, a ratio thereof, temperature of the test bolt, the size of the test bolt, and a plurality of signal-characterizing features. Machine models trained on these characteristics can be used to non-destructively determine the stress/tension of target bolts by measuring times-of-flight, temperature, and signal-characterizing features of a target bolt.

### CROSS REFERENCE TO RELATED APPLICATIONS

The present application claims the benefit under 35 U.S.C. § 119 (e) of U.S. Provisional Patent Application Ser. No. 63/315,849 filed Mar. 2, 2022 and titled “Machine Learning Models to Predict Bolt Coating and Bolt Tension,” the disclosure of which is incorporated herein by reference in its entirety and made a part of this specification.

### INCORPORATION BY REFERENCE

This disclosure incorporates by reference International Patent Application No. PCT/US2021/034614 (published as WO2021243077A1) titled “DETERMINING RESIDUAL TENSION IN THREADED FASTENERS,” and filed May 27, 2021 (the “'614 application”), and U.S. Provisional Patent Application No. 63/031,524 titled “SYSTEMS AND METHODS FOR ESTIMATING RESIDUAL TORQUE AND TENSION,” and filed May 28, 2020 (the “524 application”). The '614 and '524 applications are each incorporated herein by reference in their entireties for all purposes and are expressly made a part of this specification. To the extent any part of the '614 application or the '524 application contradicts the disclosure contained in this specification, this specification is intended to supersede and/or take precedence over any such contradictory material.

### FIELD

The present disclosure generally relates to systems and methods for determining residual tension in threaded fasteners, such as bolts.

### BACKGROUND

Bolted connections in which threaded fasteners join structural members together are among the most common types of joining methods. As used herein, threaded fasteners can include bolts, studs, and any other threaded fastener that clamps two or more structural members together. A clamping force (“preload”) may be imparted by threading the fastener into a nut or into threads tapped into one of the structural members. For convenience and simplicity, the term “bolt” will be used throughout this disclosure to refer to a threaded fastener, but it should be understood that this disclosure and the inventive systems and methods herein are not limited to what is commonly referred to as a bolt and may be applied to other threaded fasteners used to join structural members.

When a clamping force is applied to a bolted joint (e.g., by tightening a nut on the bolt), the bolt will develop both stress and strain as a result of the force. Axial stress (and specifically, tensile stress) is the amount of tensile force (i.e., tension) per cross-sectional area of the bolt. This is an example of normal stress because the direction of the force is normal to the area of the bolt resisting the force. Shear stress, on the other hand, is transverse to the longitudinal axis of the bolt because the direction of the force is parallel to the area of the bolt resisting the force.

For bolted connections that support large structures, engineers typically specify an amount of torque needed to achieve a desired level of tension. This level of tension is the amount of tension that should be set in each bolt when the bolted connection is made as well as the amount of tension that should be maintained over time. The amount of tension that remains in a bolt after a bolted connection is made is commonly referred to as residual tension.

It is common for the residual tension in a bolt to decrease over time. This can be due to many reasons, including, for example, vibrations, shifting of the fastened members, joint relaxation, bolt fatigue, corrosion, temperature changes, and the like. When the residual tension of a bolt falls below an acceptable level, the bolt and the structure will not perform as designed. Under-tensioned bolts can compromise the structural integrity and stability of the structure, which can result in damage to the structure, or worse, catastrophic collapse.

It is therefore critical to periodically audit bolted joints to ensure that the residual tension in the bolts remains sufficient to meet design specifications. Unfortunately, all known methods for performing such audits are inefficient and imprecise. For example, there is currently no known instrumented method to measure tension in a set of bolts (e.g., measure clamping force in a bolted connection/joint), then to apply those measurements to determine the residual tension in other bolts. Instead, each bolt is audited independently, making the auditing process time-consuming.

Heavy equipment such as a hydraulic jack, a hydraulic pump, and/or a torque wrench are also typically used to perform the audits. The most common method to perform such audits is to use a calibrated torque wrench to apply an amount of torque to each bolt under audit to achieve the specified design tension. This method, however, is fairly imprecise because the amount of torque indicated on the torque wrench is only an indirect indication of tension—it is not a direct measurement of tension. Thus, by applying a specified amount of torque, the desired amount of tension may not be reached. The use of heavy equipment is also time- and labor-intensive, and potentially dangerous to the operators and to the structure.

There are other inefficiencies inherent in known methods. For example, because all known methods are time-consuming, periodic audits are typically performed on only a subset of bolts disposed on a structure. Large structures can employ dozens, hundreds, or even thousands of bolts in bolted joints. For that reason, periodic audits are typically performed on a small subset of the bolts (e.g., 10%). Thus, another major drawback with current methods is that periodic audits address only some bolts on a structure while leaving the remaining bolts unaudited for considerable lengths of time.

Another inefficiency is wasted time. With current methods, each bolt audited is typically torqued until it meets design specifications without first measuring the amount of tension in the bolt. This is inefficient, however, because it is possible that no maintenance needed to be performed on some of the bolts. Moreover, because torque is not a direct measurement of tension, this can also result in some bolts being deemed acceptable when, in fact, they are not set to the correct level of tension.

Other methods of auditing residual tension in bolts require baseline measurements and/or require manipulating the bolts (e.g., conducting destructive tests). For example, some methods require making a baseline measurement on a bolt either at the time of installation or by loosening a bolt in situ to zero tension to make the measurements, then comparing the baseline measurements to subsequent measurements. This method is inefficient at least because it must be done on every bolt. That is, baseline measurements for one bolt have no bearing on measurements for other bolts. Each bolt is audited independently.

In sum, all current methods for determining or estimating the amount of residual tension in bolts are imprecise, time-, labor-, and cost-intensive, potentially dangerous to personnel and to the structure, typically apply to only a small subset of all bolts disposed on a structure, and provide only indirect indications of the actual level of tension in any bolt. An efficient and precise way to determine the residual tension of bolts is therefore needed.

### SUMMARY

The present disclosure provides systems and methods for determining the residual tension of bolts through instrumentation and without the need for baseline measurements on bolts or by manipulating the bolts. As explained more fully below, the residual tension in a bolt can be determined based on a model that expresses tension and/or tensile stress as a function of wave propagation. In this way, residual tension in a bolt can be determined by applying the model and without directly measuring tension. The inventive systems and methods therefore eliminate or minimize the inefficiencies and safety hazards of all known methods used to measure residual tension.

The systems and methods disclosed herein have far-reaching applications and can be applied to determine the residual tension of bolts used in nearly any industry. For example and without limitation, these systems and methods can be applied to industries such as renewable energy, power generation and delivery, oil and petroleum refineries, telecommunications, bridges, dams, aeronautics, automotive, buildings, and many more.

One non-limiting example application is towers for wind turbines, such as tower 102 illustrated in FIG. 1. As shown, tower 102 is segmented and includes segments 102a, 102b, and 102c. As illustrated in the enlarged view, segments 102b and 102c are joined with flanges 104b and 104c, which are fastened together with a plurality of bolts 106. The plurality of bolts 106 are examples of bolts (i.e., threaded fasteners) to which the inventive systems and methods may be applied to determine residual tension. The efficiency of these systems and methods can allow an entire wind farm to be audited in a fraction of the time and for a fraction of the cost of current methods, and most importantly, will provide precise measurements of residual tension.

The invention is premised on relationships between the times-of-flight (ToF) of shear waves and longitudinal waves in a bolt and tensile stress in the bolt, where the time-of-flight is a measure of the time it takes for a wave to travel from one end of the bolt and reflect back. The ToF of shear waves and the ToF of longitudinal waves are each a function of several parameters, including tensile stress, length of the bolt, temperature, and material properties.

As explained herein, a set of test bolts can be used to create training data to train machine learning models. The training data can include the ToF of shear waves, the ToF of longitudinal waves, a ratio of the ToF of shear and longitudinal waves (referred to herein as the “UT response” or as the “ToF ratio”), bolt size, bolt length, bolt temperature, and numerous signal-characterizing features. The training data can be obtained at several known levels of tension (e.g., by setting each test bolt to a level of tension, then measuring the various characteristics). Once trained, the machine learning models can be used to predict bolt coating, bolt size, bolt length, and the tensile stress/residual tension in a target bolt.

### DRAWINGS

The foregoing and other objects, features, and advantages of the systems and methods described herein will be apparent from the following description of particular embodiments thereof, as illustrated in the accompanying figures, where like reference numbers refer to like structures. The figures are not necessarily to scale, emphasis instead being placed upon illustrating the principles of the systems and methods described herein.

FIG. 1 is an enlarged, schematic diagram illustrating an example wind tower and bolts used thereon.

FIGS. 2 and 3 are schematic diagrams illustrating an example setups of systems for collecting data relating to ultrasonic waves in a bolt.

FIG. 4 is a block diagram illustrating an example processing device.

FIG. 5 is a schematic diagram illustrating different wave phenomena in an elastic object.

FIG. 6 is a flow diagram illustrating an example method with criteria that can be used to evaluate raw data received from a transducer.

FIG. 7 is a graph diagram illustrating examples of first and second echoes from a longitudinal wave.

FIG. 8 is a graph diagram illustrating an example cross correlation for the two echoes illustrated in FIG. 7.

FIG. 9 is a flow diagram illustrating an example method for calculating the cross correlation of two echoes.

FIG. 10 is a graph diagram illustrating a typical frequency distribution of a signal.

FIG. 11 is a graph diagram illustrating various features of an echo.

FIG. 12 is a graph diagram illustrating example echoes relating to longitudinal waves in a bolt.

FIG. 13 is a flow diagram illustrating an example method for generating a dataset to train a machine learning model to predict a characteristic of a bolt.

FIG. 14 is a flow diagram illustrating a general method for training supervised regression or classification machine learning models according to embodiments of the invention.

FIG. 15 is a graph diagram illustrating an example relationship between the number of features selected to train a machine learning model and the mean squared error (MSE).

FIG. 16 is an example flow diagram for training supervised machine learning models according to embodiments of the invention.

FIG. 17 is an example flow diagram for training supervised machine learning models according to embodiments of the invention.

FIG. 18 is an example flow diagram for training supervised machine learning models according to embodiments of the invention.

FIG. 19 is an example flow diagram for training supervised machine learning models according to embodiments of the invention.

FIG. 20 is an example flow diagram for training supervised machine learning models according to embodiments of the invention.

FIG. 21 is a flow diagram illustrating an example method for using a machine learning model to determine characteristics of a target bolt.

FIG. 22 is a graph diagram illustrating an example main band of a linear regression model and outliers.

FIG. 23 is a graph diagram illustrating an example cross correlation of two echoes.

FIG. 24 is a flow diagram illustrating an example method for using a machine learning model to determine characteristics of a target bolt.

FIG. 25 is a flow diagram illustrating an example method for using a machine learning model to determine characteristics of a target bolt.

FIG. 26 is a flow diagram illustrating an example method for using a machine learning model to determine stress of a target bolt.

FIG. 27 is a graph diagram illustrating the first echo of an example filtered longitudinal wave signal.

FIG. 28 is a graph diagram illustrating the classification of each segment of the example signal of FIG. 27.

FIG. 29 is a graph diagram illustrating signal parts of first and second echoes of an example longitudinal wave signal.

FIG. 30 is a graph diagram illustrating signal parts of first and second echoes of an example longitudinal wave.

FIGS. 31A and 31B are graph diagrams illustrating 2-dimensional beam patterns for longitudinal waves.

FIG. 32 is a graph diagram illustrating ten ToF measurements for a longitudinal wave signal.

FIG. 33 is a graph diagram illustrating windows around each set of peaks in the first echo.

FIG. 34 is a graph diagram illustrating a ToF ratio for the third modal of a first echo as a function of stress.

FIGS. 35A and 35B are graph diagrams illustrating the ratios ToF_{Shear}/ToF_{Long} and ToF_{E1P-E1M3}/ToF_{Long} as functions of stress.

FIGS. 36A and 36B are graph diagrams illustrating the results of performing the ratio-comparison method on all of the data points in FIGS. 35A and 35B using a 4% agreement threshold.

FIG. 37 is a flow diagram illustrating an example method for performing ratio-comparisons.

FIG. 38 is a graph diagram illustrating an example longitudinal wave signal with windows drawn around each set of peaks that will be considered for cross correlation in this example.

FIG. 39 is a flow diagram illustrating an example method for performing a ratio-comparison and correction.

FIG. 40 is a flow diagram illustrating an example method for comparing stress predictions from two machine learning models.

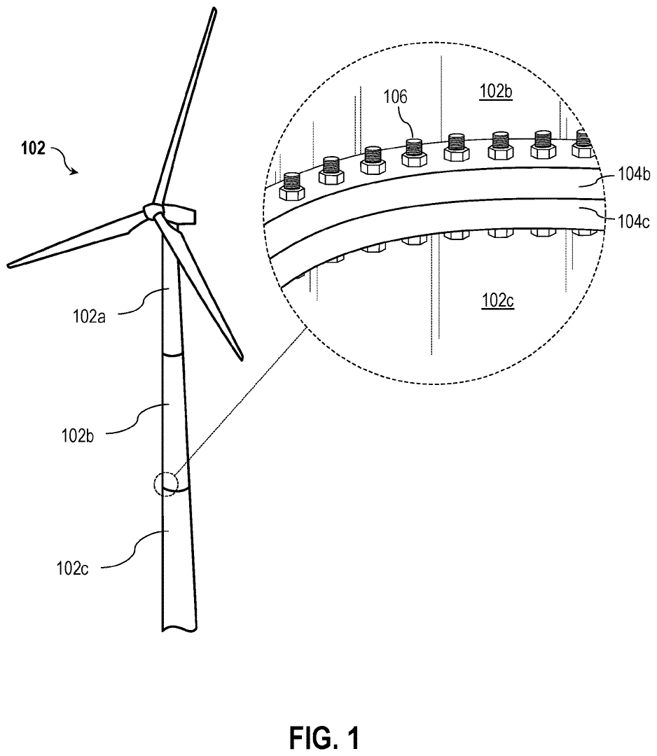

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms unless otherwise stated or clear from context.

As used herein, the terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or “the like”) provided herein, is intended merely to better illuminate the embodiments and does not pose a limitation on the scope of the embodiments. The terms “e.g.,” and “for example” set off lists of one or more non-limiting examples, instances, or illustrations. No language in the specification should be construed as indicating any unclaimed element as essential to the practice of the embodiments.

As used herein, the term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the terms “exemplary” and “example” mean “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

As used herein, the term “data” is a broad term and is to be given its ordinary and customary meaning to a person of ordinary skill in the art, and refers without limitation to any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

As used herein, the terms “memory” and “memory device” are broad terms and are to be given their ordinary and customary meaning to a person of ordinary skill in the art, and refer without limitation to computer hardware or circuitry to store information. Memory or memory device can be any suitable type of computer memory or other electronic storage means including, for example, read-only memory (ROM), random access memory (RAM), dynamic RAM (DRAM), static RAM (SRAM), ferroelectric RAM (FRAM), cache memory, compact disc read-only memory (CDROM), electro-optical memory, magneto-optical memory, masked read-only memory (MROM), programmable read-only memory (PROM), erasable programmable read-only memory (EPROM), electrically-erasable programmable read-only memory (EEPROM), rewritable read-only memory, flash memory, or the like. Memory or memory device can be implemented as an internal storage medium and/or as an external storage medium. For example, memory or memory device can include hard disk drives (HDDs), solid-state drives (SSDs), optical disk drives, plug-in modules, memory cards (e.g., xD, SD, miniSD, microSD, MMC, etc.), flash drives, thumb drives, jump drives, pen drives, USB drives, zip drives, a computer readable medium, or the like.

As used herein, the term “network” is a broad term and is to be given its ordinary and customary meaning to a person of ordinary skill in the art, and refers without limitation to any communication network including, for example, an extranet, intranet, inter-net, the Internet, local area network (LAN), wide area network (WAN), metropolitan area network (MAN), wireless local area network (WLAN), ad hoc network, wireless ad hoc network (WANET), mobile ad hoc network (MANET), or the like.

As used herein, the term “processor” is a broad term and is to be given its ordinary and customary meaning to a person of ordinary skill in the art, and refers without limitation to processing devices, apparatuses, programs, circuits, components, systems, and subsystems, whether implemented in hardware, tangibly embodied software, or both, and whether or not it is programmable. The term “processor” includes, but is not limited to, one or more computing devices, hardwired circuits, signal-modifying devices and systems, devices and machines for controlling systems, central processing units, microprocessors, microcontrollers, programmable devices and systems, field-programmable gate arrays (FPGA), application-specific integrated circuits (ASIC), systems on a chip (SoC), systems comprising discrete elements and/or circuits, state machines, virtual machines, data processors, processing facilities, digital signal processing (DSP) processors, and combinations of any of the foregoing. A processor can be coupled to, or integrated with, memory or a memory device. While various embodiments are described below with reference to example combinations of features and/or concepts, it should be understood that the features and concepts described herein may be combinable in other ways not specifically described. For example, the various embodiments are described in the paragraphs below in terms of various aspects. A feature or concept appearing in reference to one of these aspects may be combined with features and concepts described in reference to any other aspect.

As used herein, the term “target bolt” is a broad term and is to be given its ordinary and customary meaning to a person of ordinary skill in the art, and refers without limitation to a bolt that is not used to create training data for machine learning models and for which certain characteristics are unknown, but are to be predicted.

While various embodiments are described below with reference to example combinations of features and/or concepts, it should be understood that the features and concepts described herein may be combinable in other ways not specifically described. It will be appreciated that any embodiment of any aspect is generally applicable with some or all embodiments of any other aspect or with any aspect. That is, any embodiment is independently combinable with any of the aspects or embodiments identified herein, regardless of whether a combination of those embodiments or aspects are specifically identified herein.

In one aspect, a method for determining a time-of-flight of an ultrasonic wave in a bolt include receiving a signal from a test event on a bolt, wherein the signal comprises at least a first echo and a second echo of an ultrasonic wave in the bolt. The method further includes determining that the signal passes one or more signal quality checks. The method further includes performing cross correlation on the signal to determine a time-of-flight of the ultrasonic wave, wherein performing cross correlation comprises using a flexible window algorithm.

In another aspect, the one or more signal quality checks comprises determining that the signal is not clipped.

In another aspect, the one or more signal quality checks comprises determining that the signal's amplitude is greater than a threshold amount.

In another aspect, the one or more signal quality checks comprises determining that a peak-to-noise ratio of the signal is greater than a threshold amount.

In another aspect, the one or more signal quality checks comprises determining that a time separating a maximum amplitude and a minimum amplitude of each echo in the signal is less than a threshold amount.

In another aspect, the one or more signal quality checks comprises determining that a first echo of the signal arrives within a predetermined estimated range.

In another aspect, the flexible window algorithm comprises filtering the signal at a dominant frequency; establishing a first starting point for a first window for the first echo and a second starting point for a second window for the second echo; establishing a minimum and a maximum size for the first and second windows; establishing a plurality of delay times for the second window; for each delay time for the second window, establishing a plurality of window sizes for the first and second windows and determining which of the plurality of window sizes meets one or more criteria; for each window size that meets the one or more criteria, calculating a cross correlation function; determining a maximum amplitude of all cross correlation functions; and identifying the time-of-flight as a time value corresponding to the maximum amplitude.

In one aspect, a system for determining a time-of-flight of an ultrasonic wave in a bolt includes an ultrasonic wave transducer configured to detachably couple to a bolt. The system further includes a pulser/receiver configured to operatively connect to the ultrasonic transducer. The system further includes a processing device configured to operatively connect to the ultrasonic transducer and initiate a test event by transmitting one or more signals to the pulser/receiver, wherein the test event comprises causing the ultrasonic transducer to transmit ultrasonic waves in the bolt; wherein the pulser/receiver is configured to receive signals from the ultrasonic transducer, wherein the signals comprise reflections of the ultrasonic waves; wherein the processing device comprises a processor coupled to memory, wherein the memory stores instructions that, when executed by the processor, cause the processor to: receive raw data from the pulser/receiver, wherein the raw data comprises at least a first echo and a second echo of the ultrasonic waves in the bolt; determine that the raw data passes one or more signal quality checks; and perform cross correlation on the raw data using a flexible window algorithm to determine a time-of-flight of the ultrasonic waves.

In another aspect, the flexible window algorithm is configured to filter the raw data at a dominant frequency; establish a first starting point for a first window for the first echo and a second starting point for a second window for the second echo; establish a minimum and a maximum size for the first and second windows; establish a plurality of delay times for the second window; for each delay time for the second window, establish a plurality of window sizes for the first and second windows and determine which of the plurality of window sizes meets one or more criteria; for each window size that meets the one or more criteria, calculate a cross correlation function; determine a maximum amplitude of all cross correlation functions; and identify the time-of-flight as a time value corresponding to the maximum amplitude.

In one aspect, a processing device for determining a time-of-flight of an ultrasonic wave in a bolt includes an input configured to receive a signal from a test event on a bolt, wherein the signal comprises at least a first echo and a second echo of an ultrasonic wave in the bolt. The processing device further includes a display configured to display a graphical user interface, wherein the graphical user interface is configured to receive data from a user relating to the bolt. The processing device further includes a processor coupled to memory, wherein the memory stores instructions that, when executed by the processor, cause the processor to determine that the signal passes one or more signal quality checks, and perform cross correlation on the signal using a flexible window algorithm to determine a time-of-flight of the ultrasonic wave.

In another aspect, the flexible window algorithm is configured to filter the raw data at a dominant frequency; establish a first starting point for a first window for the first echo and a second starting point for a second window for the second echo; establish a minimum and a maximum size for the first and second windows; establish a plurality of delay times for the second window; for each delay time for the second window, establish a plurality of window sizes for the first and second windows and determine which of the plurality of window sizes meets one or more criteria; for each window size that meets the one or more criteria, calculate a cross correlation function; determine a maximum amplitude of all cross correlation functions; and identify the time-of-flight as a time value corresponding to the maximum amplitude.

In one aspect, a method for generating a dataset to train a machine learning model to predict a characteristic of a target bolt in situ includes setting each of a plurality of test bolts to a plurality of known levels of tension. The method further includes, for each known level of tension set in each test bolt, determining a time-of-flight of longitudinal waves in the test bolt, determining a time-of-flight of shear waves in the test bolt, determining a ratio of the time-of-flight of shear waves and the time-of-flight of longitudinal waves, determining a temperature of the test bolt, determining a size of the test bolt, and determining a plurality of signal-characterizing features.

In another aspect, determining a time-of-flight of longitudinal waves in the test bolt includes receiving a signal from a test event on the test bolt, wherein the signal comprises at least a first echo and a second echo of a longitudinal wave in the test bolt; determining that the signal passes one or more signal quality checks; and performing cross correlation on the signal to determine the time-of-flight of the longitudinal wave, wherein performing cross correlation comprises using a flexible window algorithm.

In another aspect, the flexible window algorithm is configured to filter the raw data at a dominant frequency; establish a first starting point for a first window for the first echo and a second starting point for a second window for the second echo; establish a minimum and a maximum size for the first and second windows; establish a plurality of delay times for the second window; for each delay time for the second window, establish a plurality of window sizes for the first and second windows and determine which of the plurality of window sizes meets one or more criteria; for each window size that meets the one or more criteria, calculate a cross correlation function; determine a maximum amplitude of all cross correlation functions; and identify the time-of-flight as a time value corresponding to the maximum amplitude.

In another aspect, determining a time-of-flight of shear waves in the test bolt includes receiving a signal from a test event on the test bolt, wherein the signal comprises at least a first echo and a second echo of a shear wave in the test bolt; determining that the signal passes one or more signal quality checks; and performing cross correlation on the signal to determine the time-of-flight of the shear wave, wherein performing cross correlation comprises using a flexible window algorithm.

In another aspect, determining a plurality of signal-characterizing features includes receiving a first signal from a first test event on the test bolt, wherein the first signal comprises at least a first echo and a second echo of a longitudinal wave in the test bolt; receiving a second signal from a second test event on the test bolt, wherein the second signal comprises at least a first echo and a second echo of a shear wave in the test bolt; extracting one or more features from the first signal; extracting one or more features from a cross correlation performed on the first signal; extracting one or more features from the second signal; and extracting one or more features from a cross-correlation performed on the second signal.

In one aspect, a method of training a supervised machine learning model for detecting a coating of a target bolt in situ includes receiving a training dataset generated from a plurality of test bolts, wherein the training dataset comprises a plurality of times-of-flight of shear waves (ToF_{Shear}) for the plurality of test bolts when set to a plurality of known levels of tension; a plurality of times-of-flight of longitudinal (ToF_{Long}) waves for the plurality of test bolts when set to the plurality of known levels of tension; a plurality of ratios of the ToF_{Shear} and ToF_{Long} for the plurality of test bolts; a plurality of temperatures of the plurality of test bolts when set to the plurality of known levels of tension; and a feature vector, wherein the feature vector comprises signal-characterizing features extracted from data used to determine the plurality of ToF_{Shear}, from data used to determine the plurality of ToF_{Long}, and from data used to determine the plurality of ratios. The method further includes pre-processing the training dataset, wherein pre-processing includes at least replacing missing or infinite values, removing features that are correlated with other features such that a correlation coefficient is greater than a threshold, and specifying a holdout set. The method further includes spot-checking a plurality of machine learning algorithms, wherein a spot-checking pipeline includes at least Winsorizing values above and below specified thresholds, using Sequential Feature Selection to select at least three features from the feature vector that are most impactful in predicting the coating of bolts based on the training dataset, wherein at least two features are a ratio of ToF_{Shear} and ToF_{Long} and bolt temperature, and selecting one of a plurality of classification algorithms based on best overall performance. The method further includes tuning hyper-parameters, wherein tuning comprises selecting a subset of hyper-parameters that results in a model that achieves the best cross-validation score on the training dataset. The method further includes evaluating the performance of the model based on the holdout set.

In one aspect, a method of training a supervised machine learning model for detecting a coating of a target bolt in situ includes receiving a training dataset generated from a plurality of test bolts, wherein the training dataset comprises a plurality of times-of-flight of shear waves (ToF_{Shear}) for the plurality of test bolts when set to a plurality of known levels of tension; a plurality of times-of-flight of longitudinal (ToF_{Long}) waves for the plurality of test bolts when set to the plurality of known levels of tension; a plurality of ratios of the ToF_{Shear} and ToF_{Long} for the plurality of test bolts; a plurality of temperatures of the plurality of test bolts when set to the plurality of known levels of tension; and a feature vector, wherein the feature vector comprises signal-characterizing features extracted from data used to determine the plurality of ToF_{Shear}, from data used to determine the plurality of ToF_{Long}, and from data used to determine the plurality of ratios. The method further includes pre-processing the training dataset, wherein pre-processing includes at least replacing missing or infinite values, removing features that are correlated with other features such that a correlation coefficient is greater than a threshold, and specifying a holdout set. The method further includes spot-checking a plurality of machine learning algorithms, wherein a spot-checking pipeline includes at least Winsorizing values above and below specified thresholds, using Sequential Feature Selection to select at least three features from the feature vector that are most impactful in predicting the size of bolts based on the training dataset, wherein at least two features are a ratio of ToF_{Shear} and ToF_{Long} and bolt temperature, and selecting one of a plurality of classification algorithms based on best overall performance. The method further includes tuning hyper-parameters, wherein tuning comprises selecting a subset of hyper-parameters that results in a model that achieves the best cross-validation score on the training dataset. The method further includes evaluating the performance of the model based on the holdout set.

In one aspect, a method of training a supervised machine learning model for detecting a coating of a target bolt in situ includes receiving a training dataset generated from a plurality of test bolts, wherein the training dataset comprises a plurality of times-of-flight of shear waves (ToF_{Shear}) for the plurality of test bolts when set to a plurality of known levels of tension; a plurality of times-of-flight of longitudinal (ToF_{Long}) waves for the plurality of test bolts when set to the plurality of known levels of tension; a plurality of ratios of the ToF_{Shear} and ToF_{Long} for the plurality of test bolts; a plurality of temperatures of the plurality of test bolts when set to the plurality of known levels of tension; and a feature vector, wherein the feature vector comprises signal-characterizing features extracted from data used to determine the plurality of ToF_{Shear}, from data used to determine the plurality of ToF_{Long}, and from data used to determine the plurality of ratios. The method further includes pre-processing the training dataset, wherein pre-processing includes at least replacing missing or infinite values, removing features that are correlated with other features such that a correlation coefficient is greater than a threshold, and specifying a holdout set. The method further includes spot-checking a plurality of machine learning algorithms, wherein a spot-checking pipeline includes at least Winsorizing values above and below specified thresholds, using Sequential Feature Selection to select at least three features from the feature vector that are most impactful in predicting the length of bolts based on the training dataset, wherein at least two features are a ratio of ToF_{Shear} and ToF_{Long} and bolt temperature, and selecting one of a plurality of classification algorithms based on best overall performance. The method further includes tuning hyper-parameters, wherein tuning comprises selecting a subset of hyper-parameters that results in a model that achieves the best cross-validation score on the training dataset. The method further includes evaluating the performance of the model based on the holdout set.

In one aspect, a method of training a supervised machine learning model for detecting a coating of a target bolt in situ includes receiving a training dataset generated from a plurality of test bolts, wherein the training dataset comprises a plurality of times-of-flight of shear waves (ToF_{Shear}) for the plurality of test bolts when set to a plurality of known levels of tension; a plurality of times-of-flight of longitudinal (ToF_{Long}) waves for the plurality of test bolts when set to the plurality of known levels of tension; a plurality of ratios of the ToF_{Shear} and ToF_{Long} for the plurality of test bolts; a plurality of temperatures of the plurality of test bolts when set to the plurality of known levels of tension; and a feature vector, wherein the feature vector comprises signal-characterizing features extracted from data used to determine the plurality of ToF_{Shear}, from data used to determine the plurality of ToF_{Long}, and from data used to determine the plurality of ratios. The method further includes pre-processing the training dataset, wherein pre-processing includes at least replacing missing or infinite values, removing features that are correlated with other features such that a correlation coefficient is greater than a threshold, and specifying a holdout set. The method further includes spot-checking a plurality of machine learning algorithms, wherein a spot-checking pipeline includes at least Winsorizing values above and below specified thresholds, using Sequential Feature Selection to select at least three features from the feature vector that are most impactful in predicting outliers based on the training dataset, wherein at least two features are a ratio of ToF_{Shear} and ToF_{Long} and bolt temperature, and selecting one of a plurality of classification algorithms based on best overall performance. The method further includes tuning hyper-parameters, wherein tuning comprises selecting a subset of hyper-parameters that results in a model that achieves the best cross-validation score on the training dataset. The method further includes evaluating the performance of the model based on the holdout set.

In one aspect, a method of training a supervised machine learning model for detecting a coating of a target bolt in situ includes receiving a training dataset generated from a plurality of test bolts, wherein the training dataset comprises a plurality of times-of-flight of shear waves (ToF_{Shear}) for the plurality of test bolts when set to a plurality of known levels of tension; a plurality of times-of-flight of longitudinal (ToF_{Long}) waves for the plurality of test bolts when set to the plurality of known levels of tension; a plurality of ratios of the ToF_{Shear} and ToF_{Long} for the plurality of test bolts; a plurality of temperatures of the plurality of test bolts when set to the plurality of known levels of tension; and a feature vector, wherein the feature vector comprises signal-characterizing features extracted from data used to determine the plurality of ToF_{Shear}, from data used to determine the plurality of ToF_{Long}, and from data used to determine the plurality of ratios. The method further includes pre-processing the training dataset, wherein pre-processing includes at least replacing missing or infinite values, removing features that are correlated with other features such that a correlation coefficient is greater than a threshold, and specifying a holdout set. The method further includes spot-checking a plurality of machine learning algorithms, wherein a spot-checking pipeline includes at least Winsorizing values above and below specified thresholds, using Sequential Feature Selection to select at least three features from the feature vector that are most impactful in predicting tensile stress based on the training dataset, wherein at least two features are a ratio of ToF_{Shear} and ToF_{Long} and bolt temperature, and selecting one of a plurality of regression algorithms based on best overall performance. The method further includes tuning hyper-parameters, wherein tuning comprises selecting a subset of hyper-parameters that results in a model that achieves the best cross-validation score on the training dataset. The method further includes evaluating the performance of the model based on the holdout set.

In one aspect, a method for predicting tensile stress of a target bolt in situ includes receiving an input dataset, wherein the input dataset comprises data relating to a time-of-flight of longitudinal waves in the target bolt, a time-of-flight of shear waves in the target bolt, a temperature of the target bolt, and a plurality of signal-characterizing features; providing the input dataset to a first machine learning model that is trained on bolt coating; detecting the coating of the target bolt; based on the coating of the target bolt that is detected, selecting a second machine learning model that is trained to detect outliers; providing the input dataset to the second machine learning model; determining that no outliers are present in the input dataset; based on the coating of the target bolt that is detected, selecting a third machine learning model that is trained on stress; providing the input dataset to the third machine learning model; and predicting stress in the target bolt based on the third machine learning model and the input dataset.

In one aspect, a processing device for predicting tensile stress of a target bolt in situ includes memory, wherein the memory stores a first machine learning model that is trained on bolt coating and configured to detect one of a plurality of different types of bolt coatings; a plurality of second machine learning models that are trained to detect outliers, wherein the plurality of second machine learning models correspond to different types of bolt coatings; and a plurality of third machine learning models that are trained on stress, wherein the plurality of third machine learning models correspond to different types of bolt coatings. The processing device further includes an input configured to receive raw data relating to reflections of ultrasonic shear waves and reflections of ultrasonic longitudinal waves in the target bolt. The processing device further includes a processor coupled to the memory, wherein the memory stores instructions that, when executed by the processor, cause the processor to determine a time-of-flight of shear waves (ToF_{Shear}) in the target bolt from the raw data; determine a time-of-flight of longitudinal waves (ToF_{Long}) in the target bolt from the raw data; determine a ratio of ToF_{Shear} and ToF_{Long} (ToFᵣₐₜᵢₒ); receive a temperature value of the target bolt; determine the coating of the target bolt based on the first machine learning model, ToF_{Shear}, ToF_{Long}, ToFᵣₐₜᵢₒ, and temperature value; select one of the plurality of second machine learning models based on the detected coating of the target bolt; determine that ToFᵣₐₜᵢₒ does not contain any outliers based on the second machine learning model selected, ToF_{Shear}, ToF_{Long}, ToFᵣₐₜᵢₒ, and temperature value; select one of the plurality of third machine learning models based on the detected coating of the target bolt; and predict the stress in the target bolt based on the third machine learning model selected, ToF_{Shear}, ToF_{Long}, ToFᵣₐₜᵢₒ, and temperature value.

In one aspect, a method for predicting tensile stress of a target bolt in situ includes receiving an input dataset, wherein the input dataset comprises data relating to a time-of-flight of longitudinal waves in the target bolt, a time-of-flight of shear waves in the target bolt, a temperature of the target bolt, a plurality of signal-characterizing features, and one or more alternate times-of-flight; providing the input dataset to a first machine learning model that is trained on bolt coating; detecting the coating of the target bolt; based on the coating of the target bolt that is detected, selecting a second machine learning model that is trained to detect shifted times-of-flight; providing the input dataset to the second machine learning model; detecting that the input dataset includes at least one shifted time-of-flight; determining that the number of wave periods that the at least one shifted time-of-flight is shifted does not exceed a threshold; replacing the shifted time-of-flight in the input dataset with one of the one or more alternate times-of-flight to provide a revised input dataset; based on the coating of the target bolt that is detected, selecting a third machine learning model that is trained on stress; providing the revised input dataset to the third machine learning model; and predicting stress in the target bolt based on the third machine learning model and the revised input dataset.

In one aspect, a processing device for predicting tensile stress of a target bolt in situ includes memory, wherein the memory stores a first machine learning model that is trained on bolt coating and configured to detect one of a plurality of different types of bolt coatings; a plurality of second machine learning models that are trained to detect shifted times-of-flight, wherein the plurality of second machine learning models correspond to different types of bolt coatings; and a plurality of third machine learning models that are trained on stress, wherein the plurality of third machine learning models correspond to different types of bolt coatings. The processing device further includes an input configured to receive raw data relating to reflections of ultrasonic shear waves and reflections of ultrasonic longitudinal waves in the target bolt. The processing device further includes a processor coupled to the memory, wherein the memory stores instructions that, when executed by the processor, cause the processor to determine a time-of-flight of shear waves (ToF_{Shear}) in the target bolt from the raw data; determine a time-of-flight of longitudinal waves (ToF_{Long}) in the target bolt from the raw data; determine a ratio of ToF_{Shear} and ToF_{Long} (ToFᵣₐₜᵢₒ); determine one or more alternate times-of-flight; receive a temperature value of the target bolt; determine the coating of the target bolt based on the first machine learning model, ToF_{Shear}, ToF_{Long}, ToFᵣₐₜᵢₒ, and temperature value; select one of the plurality of second machine learning models based on the detected coating of the target bolt; detect that at least one of ToF_{Shear}, ToF_{Long}, and ToFᵣₐₜᵢₒ comprises a shifted time-of-flight; determine that the number of wave periods that the shifted time-of-flight is shifted does not exceed a threshold; replace the shifted time-of-flight for the at least one of ToF_{Shear}, ToF_{Long}, and ToFᵣₐₜᵢₒ with one of the one or more alternate times-of-flight; select one of the plurality of third machine learning models based on the detected coating of the target bolt; and predict the stress in the target bolt based on the third machine learning model selected, ToF_{Shear}, ToF_{Long}, ToFᵣₐₜᵢₒ, and temperature value.

In one aspect, a method for predicting tensile stress of a target bolt in situ includes receiving an input dataset, wherein the input dataset comprises data relating to a time-of-flight of longitudinal waves in the target bolt, a time-of-flight of shear waves in the target bolt, a temperature of the target bolt, and a plurality of signal-characterizing features; providing the input dataset to a first machine learning model that is trained on bolt coating; detecting the coating of the target bolt; based on the coating of the target bolt that is detected, selecting a second machine learning model that is trained on bolt size; providing the input dataset to the second machine learning model selected; detecting the size of the target bolt; based on the coating and size of the target bolt that are detected, selecting a third machine learning model that is trained on bolt length; providing the input dataset to the third machine learning model selected; detecting the length of the target bolt; based on the coating, size and length of the target bolt that are detected, selecting a fourth machine learning model that is trained on stress; providing the input dataset to the fourth machine learning model selected; and predicting stress in the target bolt based on the fourth machine learning model and the input dataset.

In one aspect, a processing device for predicting tensile stress of a target bolt in situ includes memory, wherein the memory stores a first machine learning model that is trained on bolt coating and configured to detect one of a plurality of different types of bolt coatings; a plurality of second machine learning models that are trained on bolt size, wherein the plurality of second machine learning models correspond to different types of bolt coatings; a plurality of third machine learning models that are trained on bolt length, wherein the plurality of third machine learning models correspond to combinations of different types of bolt coatings and different bolt sizes; and a plurality of fourth machine learning models that are trained on stress, wherein the plurality of fourth machine learning models correspond to combinations of different types of bolt coatings, bolt sizes, and bolt lengths; an input configured to receive raw data relating to reflections of ultrasonic shear waves and reflections of ultrasonic longitudinal waves in the target bolt. The processing device further includes a processor coupled to the memory, wherein the memory stores instructions that, when executed by the processor, cause the processor to determine a time-of-flight of shear waves (ToF_{Shear}) in the target bolt from the raw data; determine a time-of-flight of longitudinal waves (ToF_{Long}) in the target bolt from the raw data; determine a ratio of ToF_{Shear} and ToF_{Long} (ToFᵣₐₜᵢₒ); receive a temperature value of the target bolt; determine the coating of the target bolt based on the first machine learning model, ToF_{Shear}, ToF_{Long}, ToFᵣₐₜᵢₒ, and temperature value; determine the size of the target bolt based the coating of the target bolt, one of the plurality of second machine learning models, ToF_{Shear}, ToF_{Long}, ToFᵣₐₜᵢₒ, and temperature value; determine the length of the target bolt based on the coating of the target bolt, the size of the target bolt, one of the plurality of third machine learning models, ToF_{Shear}, ToF_{Long}, ToFᵣₐₜᵢₒ, and temperature value; and determine the stress in the target bolt based on the coating of the target bolt, the size of the target bolt, the length of the target bolt, one of the plurality of fourth machine learning models, ToF_{Shear}, ToF_{Long}, ToFᵣₐₜᵢₒ, and temperature value.

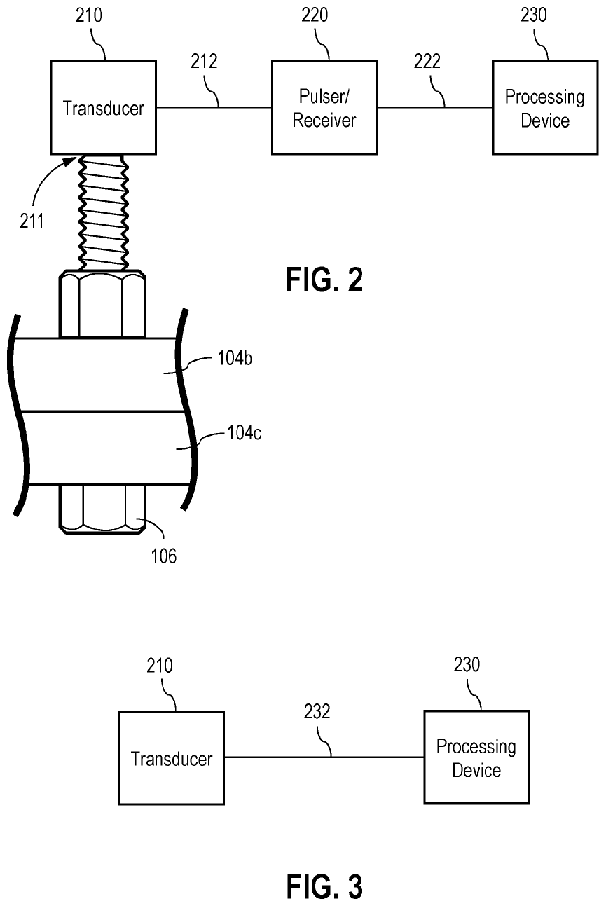

FIG. 2 is a schematic diagram illustrating an example setup of a system for collecting data relating to ultrasonic waves in a bolt 106. The system can include a transducer 210 that is detachably coupled to bolt 106. In some embodiments, a couplant may be used at the transducer/bolt interface 211 to efficiently couple the transmission of energy (e.g., ultrasonic energy) from the transducer 210 to the bolt 106. Transducer 210 can also be detachably coupled to bolt 106 with a coupling member (not shown) to place the transducer in a consistent location on a bolt each time a test event is conducted. In some embodiments, transducer 210 can be an ultrasonic transducer. In some embodiments, transducer 210 can be a shear wave transducer that generates and/or receives shear waves. In some embodiments, transducer 210 can be a longitudinal wave transducer that generates and/or receives longitudinal waves. In some embodiments, transducer 210 can be a single transducer that simultaneously generates and/or receives shear and longitudinal waves. In some embodiments, transducer 210 can be a contact transducer. In some embodiments, transducer 210 can have a nominal diameter of 0.125 inches, 0.250 inches, 0.375 inches, 0.500 inches, 0.750 inches, 1.00 inches, and the like. In some embodiments, transducer 210 can generate ultrasonic waves having frequencies of about 500 kHz, 750 kHz, 1 MHz, 1.25 MHz, 1.5 MHz, 1.75 MHz, 2 MHz, 2.25 MHz, 2.50 MHz 2.75 MHz, 3 MHz, 3.5 MHz, 5 MHz, 7.5 MHz, 10 MHz, 15 MHz, 20 MHz, 50 MHz, 100 MHz, and the like.

Transducers typically require a signal to trigger a test event and generate an acoustic wave. Transducer 210 can be triggered, for example, with pulser/receiver 220 as illustrated in FIG. 2. For example, pulser/receiver 220 can be used to transmit electrical signals to transducer 210, such as a pulse of voltages, which transducer 210 can convert into physical disturbances, such as ultrasonic waves. Pulser/receiver 220 can also be used to receive, amplify, process, and/or store signals received from transducer 210, which signals can represent physical disturbances received by transducer 210. Pulser/receiver 220 can be operatively connected to transducer 210 via communication medium 212. Communication medium 212 can be any medium capable of communicating signals and/or data between transducer 210 and pulser/receiver 220 including a wired or wireless connection. For example, in some embodiments, communication medium 212 can comprise one or more transmission lines, such as coaxial transmission lines. In some embodiments, communication medium 212 can comprise a wireless link that utilizes a suitable wireless technology such as, for example, a radio frequency (RF) technology, near field communication (NFC), Bluetooth, Bluetooth Low Energy, IEEE 802.11x (i.e., Wi-Fi), Zigbee, Z-Wave, Infrared (IR), cellular, and other types of wireless technologies. Communication medium 212 can also comprise a combination of both wired and/or wireless technologies.

In some embodiments, pulser/receiver 220 can transmit pulses to transducer 210 without external input. For example, pulser/receiver 220 can be programmed to autonomously transmit pulses to transducer 210 and receive data from transducer 210 corresponding to a test event.

In some embodiments, pulser/receiver 220 can transmit pulses to transducer 210 based on external input. For example, FIG. 2 illustrates processing device 230 operatively connected to pulser/receiver 220 via transmission medium 222. Processing device 230 can be a personal computer, laptop, tablet, smart device, and other processing devices. In some embodiments, processing device 230 can be located locally near pulser/receiver 220 (e.g., at work-site). In some embodiments, processing device 230 can be a networked device that is not located locally near pulser/receiver 220, but is connected to pulser/receiver 220 over a network (e.g., off-site). Processing device 230 can include one or more processors and memory. The memory can store software that, when executed by the one or more processors, causes pulser/receiver 220 to transmit pulses to transducer 210 to generate acoustic waves. In this way, processing device 230 can provide input to pulser/receiver 220 to cause pulser/receiver 220 to generate electrical pulses and trigger transducer 210 to generate and receive acoustic waves.

As illustrated, pulser/receiver 220 can be operatively connected to processing device 230 via communication medium 222. Communication medium 222 can be any medium capable of communicating signals and/or data between pulser/receiver 220 and processing device 230 including a wired or wireless connection. For example, in some embodiments, communication medium 222 can comprise one or more transmission lines, such as a coaxial transmission line, a USB cable, Ethernet cable, and the like. In some embodiments, communication medium 222 can comprise a wireless link that utilizes a suitable wireless technology such as, for example, a radio frequency (RF) technology, near field communication (NFC), Bluetooth, Bluetooth Low Energy, IEEE 802.11x (i.e., Wi-Fi), Zigbee, Z-Wave, Infrared (IR), cellular, and other types of wireless technologies. Communication medium 222 can also comprise a combination of both wired and/or wireless technologies.

In the system illustrated in FIG. 2, processing device 230 can receive raw data from pulser/receiver 220 in response to a test event. The raw data can include data relating to ultrasonic waves reflected from the distal end of the bolt 106 (i.e., end of the bolt opposite of where transducer 210 is detachably coupled), including but not limited to, amplitude, phase, frequency, time, voltage, and the like. Pulser/receiver 220, processing device 230, or both, can amplify, process, and/or store the raw data. In some embodiments, processing device 230 can process the raw data with one or more software applications to determine whether the raw data is usable to calculate a ToF ratio, to develop a model of ToF ratio as a function of tension or tensile stress, to determine tension or tensile stress in one or more target bolts 106, to determine the coating on one or more target bolts 106, to identify outliers in the data, and more. These software applications are explained more fully below.

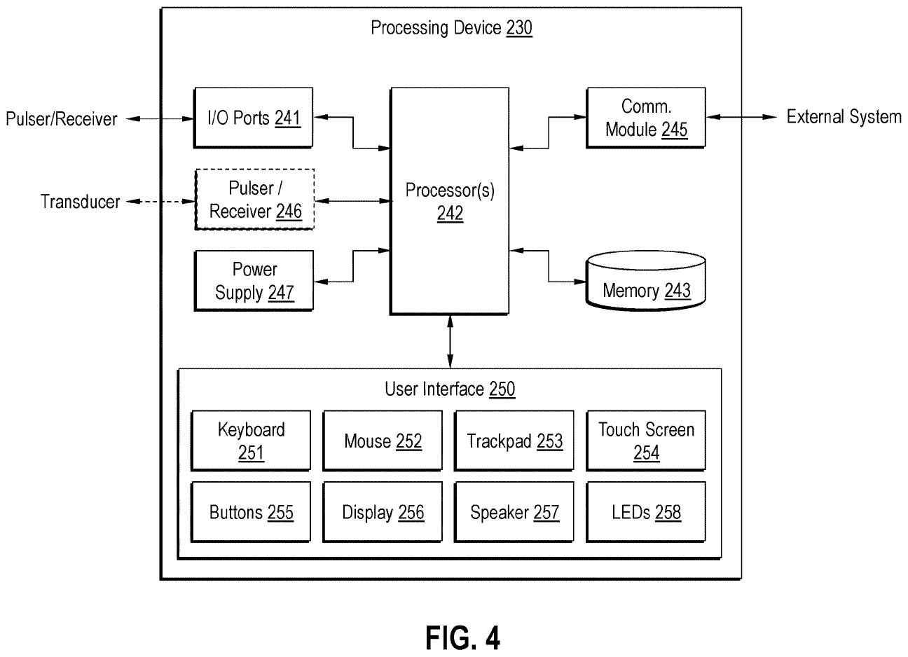

While FIG. 2 illustrates pulser/receiver 220 and processing device 230 as two separate units, they can also be one physical unit as shown in FIG. 3. For example, in some embodiments, processing device 230 incorporates the hardware, firmware, and software of pulser/receiver 220 illustrated in FIG. 2 that is needed to trigger transducer 210 and to receive signals and/or data from transducer 210 corresponding to a test event. In the embodiment shown in FIG. 3, processing device 230 can be connected to transducer 210 via communication medium 232. Communication medium 232 can be any medium capable of communicating signals and/or data between transducer 210 and processing device 230 including a wired or wireless connection. For example, in some embodiments, communication medium 232 can comprise one or more transmission lines, such as a coaxial transmission line, a USB cable, Ethernet cable, and the like. In some embodiments, communication medium 232 can comprise a wireless link that utilizes a suitable wireless technology such as, for example, a radio frequency (RF) technology, near field communication (NFC), Bluetooth, Bluetooth Low Energy, IEEE 802.11x (i.e., Wi-Fi), Zigbee, Z-Wave, Infrared (IR), cellular, and other types of wireless technologies. Communication medium 232 can also comprise a combination of both wired and/or wireless technologies.

Processing device 230 (illustrated in FIG. 2 or 3) can include hardware, firmware, and/or software that generally enables a user to interact with the system, to receive raw data from transducer 210 and/or pulser/receiver 220, to process the raw data, to analyze the raw data, to store the raw data as well as other data, and/or to transmit data (e.g., raw data, processed data, etc.) to an external system (not shown).

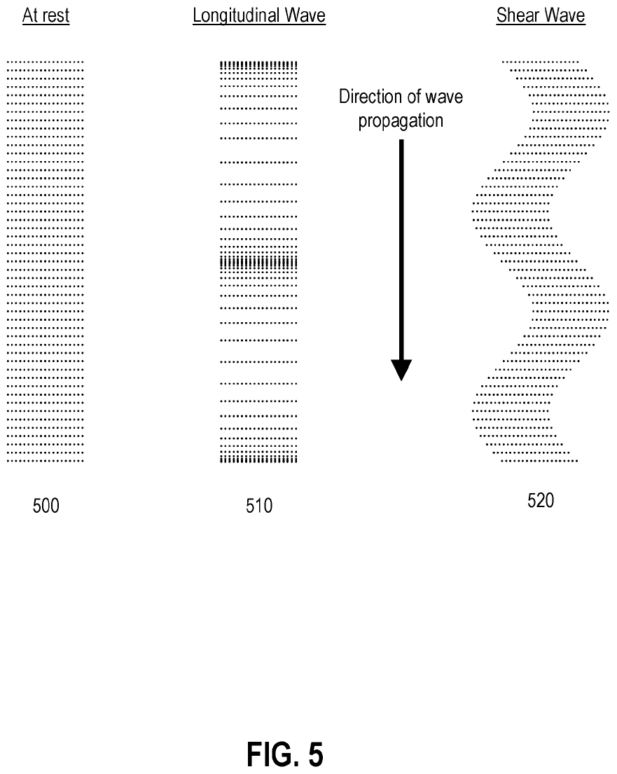

FIG. 4 illustrates a more detailed block diagram of an example processing device 230, such as that shown in FIG. 2 or 3. Processing device 230 can receive data from pulser/receiver 220 via input/output (I/O) ports 241. The I/O ports 241 can comprise ports that enable processing device 230 to communicate with peripheral equipment. For example, I/O ports 241 can comprise serial ports such as USB ports, coaxial ports, ports for communicating over RS-232, RS-422, RS-485, and other protocols, Ethernet ports, VGA ports, HDMI ports, and the like. Data received at I/O ports 241 can be transmitted to one or more processors 242.

Processor(s) 242 can include or can be coupled to memory 243. Memory 243 can store data, such as the raw data from transducer 210 or pulser/receiver 220, data received from a user, data received from an external system, and other types of data (e.g., configuration data, processed raw data, etc.). Memory 243 can also store software (i.e., computer-executable instructions). Processor(s) 242 can process data, wherein the processing can include, for example, amplifying, converting from analog to digital or digital to analog, conditioning, filtering, and/or transforming the data. Processor(s) 242 can also serve as a central control unit of processing device 230. For example, software stored in memory 243 can comprise operating system software, firmware, and other system software for controlling processing device 230, its components, and connected peripheral equipment. Software can further include data processing software, application software, machine learning models, and the like, as discussed in more detail below.

Processing device 230 can include a user interface 250 that comprises input and output components configured to allow a user to interact with processing device 230 and the system generally. For example, user interface 250 can include a keyboard 251, mouse 252, trackpad 253, touch-sensitive screen 254, one or more buttons 255, display 256, speaker 257, and one or more LED indicators 258. Processor(s) 242 can control user interface 250 and its components. For example, processor(s) 242 can receive data and commands from devices connected to I/O ports 241 and provide data and commands to components through I/O ports 241. Processor(s) 242 can execute software stored in memory 243 to cause a graphical user interface (GUI) to be displayed on display 256. The GUI can provide the user with an intuitive and user-friendly means for interacting with the system, including to provide output to the user such as prompts, messages, notifications, warnings, alarms, or the like.

The components of the user interface 250 include controls to allow a user to interact with processing device 230. For example, the keyboard 251, mouse 252, and trackpad 253 can allow input from the user. The touch-sensitive screen 254 can enable a user to interact with the GUI, for example, by inputting information, making selections, or the like. The one or more buttons 255 can provide for quick and easy selection of options or modes, such as by toggling functions on/off. Buttons 255 can be physical buttons on processing 230 or soft buttons that appear on the GUI. The display 256 can be any type of display, such as an LCD, LED, OLED, or the like. The display 256 can provide the user with visual output. The speaker 257 can provide the user with audible output, such as by alerting the user of notifications, warnings, alarms, or the like. The one or more LED indicators 258 can provide the user with visual indications. For example, one LED indication might represent whether there is sufficient battery power, or whether processing device 230 is receiving power from an external source. Another LED indication might inform the user whether processing device 230 is in an active state during a test event. Although not illustrated, the user interface 250 can include other components, such as a vibrating module to provide a user with tactile signals or alerts, a backlight to facilitate viewing the display in low light conditions, a microphone to enable controlling the system with voice, or the like.

As further illustrated in FIG. 4, processing device 230 can include communication module 245. Communication module 245 can comprise components to enable communication with an external system, such as an antenna, analog front end circuitry, and transceivers. An external system may send commands or data to, or receive commands or data from, processing device 230. For example, in some embodiments, communication module 245 can comprise components to enable communication over Ethernet, Bluetooth, Wi-Fi, or cellular technologies. Communication module 245 can also enable processing device 230 to receive software updates.

As further illustrated in FIG. 4, processing device 230 can include an optional pulser/receiver 246. For example, as explained in connection with FIG. 3, in some embodiments, processing device 230 can be operatively connected to transducer 210 without an external pulser/receiver to trigger transducer 210. Thus, the functionality of pulser/receiver 220 as shown and described in connection with FIG. 2 may be incorporated directly into processing device 230 as optional pulser/receiver 246. In such embodiments of processing device 230 that include an integrated pulser/receiver 246, data/signals can be directly transmitted to/received from transducer 210 as illustrated in FIG. 3.

As further illustrated in FIG. 4, processing device 230 can include a power supply 247, which can include rechargeable or disposable batteries. Power supply 247 may also include circuitry to receive power from an external source and to supply the necessary power to processing device 230, such as through an adapter connected to a mains supply. In some embodiments, the external source can be a computer that supplies power to processing device 230 over a USB cable.

Processing device 230 can support various other functions. For example, in some embodiments, processing device 230 can include the ability to record and playback test events received from transducer 210 and/or pulser/receiver 220, while also permitting for real-time display of the events. In some embodiments, processing device 230 can include the ability to tag events as they occur. For example, processing device 230 can include one or more buttons 255 that enables a user to insert a marker onto the raw data in real-time. In some embodiments, processing device 230 can permit remote control and monitoring. For example, processing device 230 can be communicatively coupled to an external system to enable the external system to view test events in real time and to control processing device 230.

It should be noted that FIG. 4 is not a strict architectural diagram. Thus, FIG. 4 generally illustrates the components of processing device 230, some of which may be combined, separated, or omitted. For example, communication module 245 may comprise several individual modules, some of which enable communication over wired and wireless connections. As another example, processor(s) 242 may comprise several components, such as discrete processing elements for amplifying, converting, conditioning, filtering, and transforming data, and/or programmable circuits for controlling processing device 230 (in addition to performing other functions, such as further processing data). The blocks illustrated in FIG. 4 are communicatively coupled in an appropriate manner as will be appreciated by one of ordinary skill in the art.

Software stored on processing device 230 can comprise computer-executable instructions that, when executed by processor(s) 242, cause processor(s) 242 to carry out a variety of functions. For example, as explained above, software can comprise instructions that, when executed by processor(s) 242, cause processor(s) 242 to generate a graphical user interface (GUI) on display 256. The GUI can allow a user to interact with the system. Software can further comprise instructions that, when executed by processor(s) 242, cause processor(s) 242 to receive input data from the user, receive raw data from pulser/receiver 220 (e.g., FIG. 2) or transducer 210 (e.g., FIG. 3), process data, and analyze data. For example, the data can be analyzed to determine whether it possesses certain quality characteristics such that it is usable or suitable for the embodiments disclosed herein, or for providing feedback to the user in the event the data does not possess such characteristics. This is explained in more detail below.

Software can further comprise instructions that, when executed by processor(s) 242, cause processor(s) 242 to determine a ToF of shear and/or longitudinal waves, a ratio thereof, and numerous signal-characterizing features. This is explained in more detail below.

Software can further comprise instructions that, when executed by processor(s) 242, cause processor(s) 242 to generate/execute machine learning models, e.g., to determine the coating, size, length, and temperature of a bolt, to identify outliers in data, to detect and adjust shifted ToFs, to generate or confirm ToF measurements, to determine stress/tension of a target bolt, and so forth. This is explained in more detail below.

It should be noted that software described herein is not limited to residing on, or being executed by, processing device 230. Instead, some or all of the software may reside on or be executed by an external system. As one non-limiting example, software on processing device 230 may receive raw data from pulser/receiver 220 (e.g., FIG. 2) or transducer 210 (e.g., FIG. 3). Software on processing device 230 can process the raw data and provide feedback about whether the raw data is usable or suitable to calculate a ToF. After a positive determination is made, the raw data can be analyzed in real time on processing device 230. Alternatively or additionally, the raw data, once verified to be usable or suitable for calculating a ToF, can be stored and analyzed at a later time. As another alternative, the raw data can be communicated to an external system, which can include software that analyzes the raw data (in real time or at a later time) to determine ToFs and ratios thereof. Thus, the inventions disclosed herein contemplate a distributed architecture in which raw data can be obtained from transducer 210 and analyzed on site, off site, or a combination of both.

In some embodiments, the systems illustrated in FIGS. 2 and 3 can include other components such as an oscilloscope or a spectrum analyzer. These components can be processing device 230 illustrated in FIG. 2 or 3, or can be connected to processing device 230 (e.g., via I/O ports 241). Further, processing device 230 can be connected to one or more servers, remote computing devices, the cloud, or a network, such as a private network or the Internet.

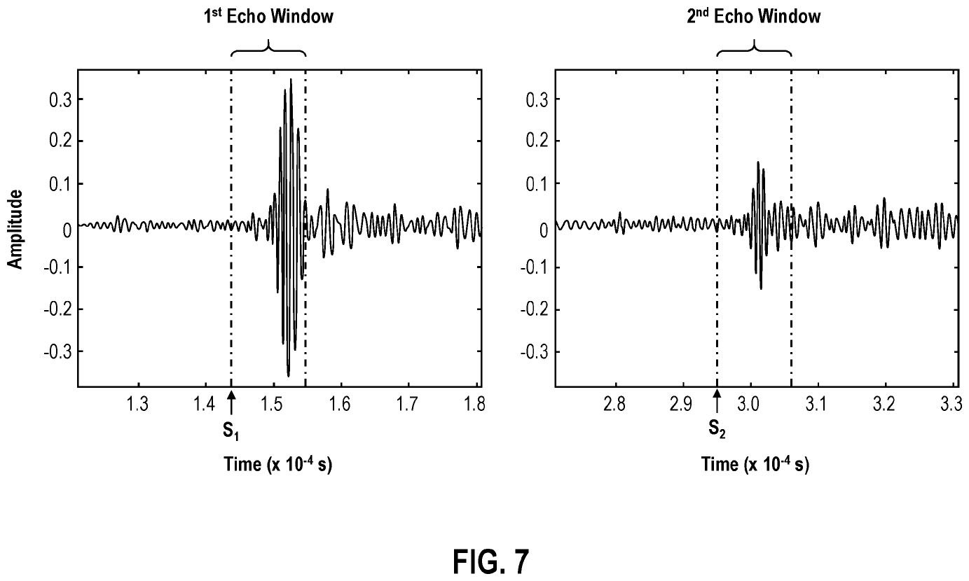

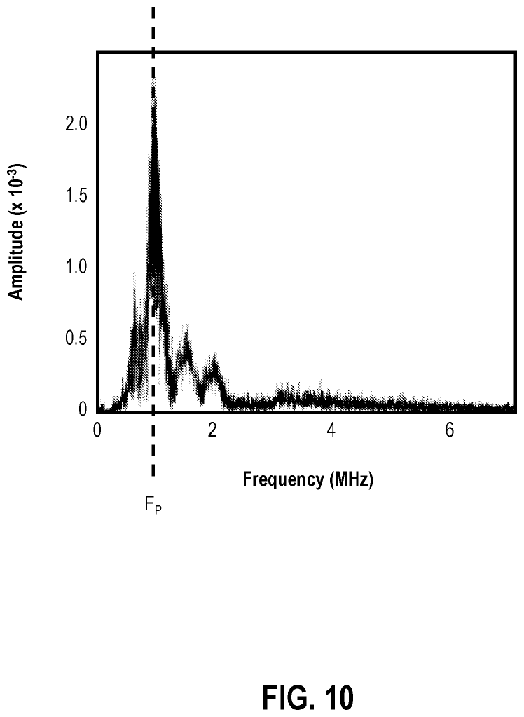

In some embodiments, processing device 230 is a special purpose computer programmed with one or more of the algorithms disclosed herein. For example, processing device 230 can be a tablet computer in which software, as explained below, is stored in memory and executed by processor(s) 242. The software can comprise one program or several programs. For example, the software can comprise a program for controlling pulser/receiver 220 (FIG. 2) or transducer 210 (FIG. 3), a program for receiving, analyzing, and processing raw data from pulser/receiver 220 (FIG. 2) or transducer 210 (FIG. 3), a program for performing individual signal quality checks (FIG. 6), a program for post-processing raw data (FIG. 9), and/or a program comprising one or more machine learning models as explained below.

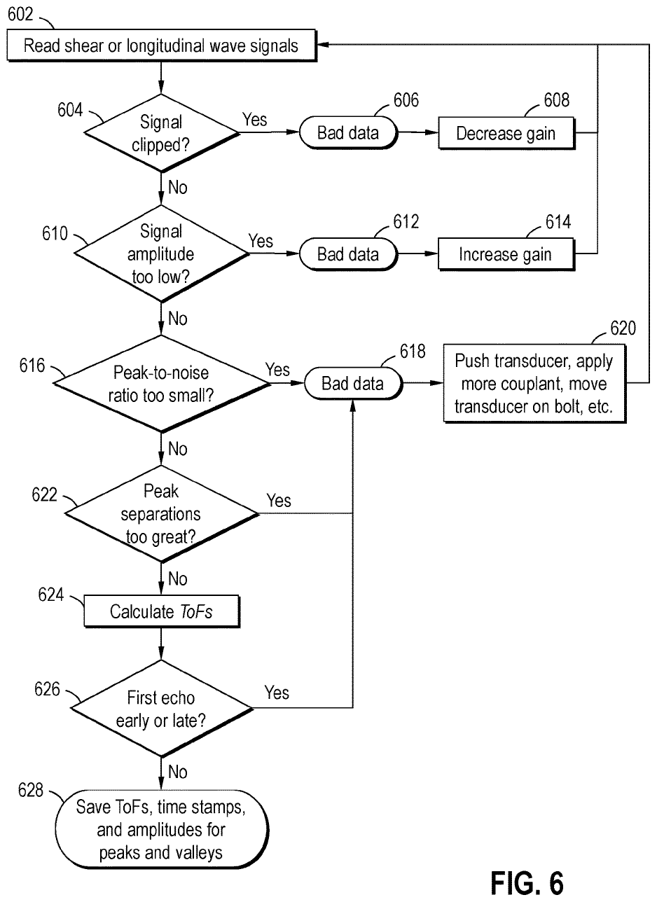

FIG. 5 is a schematic diagram illustrating different wave phenomena in an elastic object, such as in a bolt. For example, diagram 500 illustrates particles in an elastic object when the object is at rest. In this simplified and idealized diagram, the particles are generally evenly spaced throughout the object. Diagram 510 illustrates a longitudinal wave (sometimes referred to as a compression wave) in the object. As illustrated in diagram 510, the longitudinal wave causes the particles in the object to oscillate in the same direction as the wave propagation. For example, when a disturbance is created in the object that causes a downward wave propagation, a longitudinal wave will cause the particles to undergo compression (e.g., the closely-spaced particles in diagram 510) and rarefaction (e.g., the farther-spaced particles in diagram 510). In contrast, diagram 520 illustrates a shear wave (sometimes referred to as a transverse wave) in the object. As illustrated in diagram 520, the shear wave causes the particles in the object to oscillate perpendicular to the direction of wave propagation.

The inventive systems and methods disclosed herein are based, in part, on these different wave phenomena. In particular, the time that it takes a longitudinal wave and shear wave to travel from one end of a bolt and reflect back (ToF Long and ToF_{Shear}, respectively) can be measured and correlated with tensile stress/residual tension of the bolt. Specifically, the ratio of ToF_{Shear} and ToF Long can be used to model stress/tension as a function of ToF ratio and to estimate stress/tension by measuring ToFᵣₐₜᵢₒ. It is to be noted that ToFᵣₐₜᵢₒ can be expressed as ToF_{Shear}/ToF_{Long} or as ToF Long/TOF Shear. Moreover, because tensile stress is tension per cross-sectional area, one can determine the ToFᵣₐₜᵢₒ as a function of tension if tensile stress is known and vice versa, e.g., using the nominal cross-sectional area of the bolts as published by the manufacturers. As another example, higher order modes of longitudinal waves and/or shear waves may be used to compute a ToFs and/or ratios thereof.

### Signal Quality Checks

The times-of-flight for shear and longitudinal waves can be measured using ultrasonic waves. For example, transducer 210 can be an ultrasonic transducer that generates ultrasonic waves in a bolt, and the time that it takes for the wave to reflect back (i.e., echo) can be measured. Sometimes, however, the raw data produced from such a test event may not be usable or suitable to accurately measure a time-of-flight for a longitudinal wave or a shear wave, to calculate a ratio thereof, to use as training data, etc. Even if the times-of-flight can be measured, the results over a series of test events or among multiple echoes from one test event may not be consistent, thereby making a model built from such data less accurate. These issues can occur, for example, if there are air pockets at the transducer/bolt interface, which a couplant could help minimize. Other potential sources for inaccuracy or inconsistency are if the transducer is not located in the same place on a bolt for each test event, if the amount of couplant is not consistent for each test event (e.g., thickness of couplant layer), or if the amount of pressure applied to transducer 210 is not consistent for each test event.

To determine whether raw data from transducer 210 is usable or suitable, e.g., to calculate a ToF, to create training data for a machine learning model, and so forth, a method can be used (e.g., implemented with software on processing device 230) to analyze the raw data to determine whether it meets certain criteria. If the raw data fails to meet one or more criteria, the raw data can be rejected and additional data can be procured.

For example, in some embodiments, the systems of FIG. 2 or 3 may include a software application that is executed on processing device 230. The application may generate a GUI on processing device 230 that instructs the user to enter certain metadata about the bolt under investigation. For example, the application can ask the user to enter the geographical location of the bolt (e.g., ID of wind turbine tower, address of structure, etc.), at which portion of the structure the bolt is located (e.g., ring number 1, 2^{nd} floor beam 1, etc.), and which bolt number is under investigation (e.g., to keep track of bolts). The application can further ask the user to enter the size of the bolt (diameter, if known), the nominal length of the bolt (if known), and the clamp length of the bolt (e.g., length of the bolt that is under tension, if known). Other metadata can also be collected, including, for example, environmental conditions when a test event is conducted such as temperature and humidity, temperature of the bolt, material characteristics of the bolt, GPS coordinates, the name or initials of the user, and so forth. This metadata can be associated with the bolt under investigation. Some of this metadata can be collected automatically, e.g., via sensors and electronics on processing device 230, such as temperature, humidity, and GPS coordinates. The metadata can also be entered manually by the user, or it can be procured from third-party services, such as via the Internet.

The software application can further instruct the user to begin a test event, such as with a soft button. Once the test event begins, processing device 230 can generate and transmit electrical signals that cause transducer 210 either directly (e.g., FIG. 3) or through pulser/receiver 220 (e.g., FIG. 2) to generate and receive ultrasonic waves in the bolt. Processing device 230 can receive raw data resulting from the test event and analyze the raw data. If the raw data fails to meet one or more criteria, the application can provide a notification to the user that the data could not be validated and can provide feedback about why the data failed validation. The application can also provide the user with instructions about what to modify before conducting another test event, such as decreasing the gain, applying more pressure to the transducer, applying more couplant or replacing the couplant, moving the transducer to a new location on the bolt, etc. The user can then generate another test event and the new raw data can be analyzed to determine if it meets the criteria. Data that fails to meet the criteria can be discarded or stored in a location of memory. Data that meets the criteria can also be stored in memory and may be used as input other processing routines as explained below. Additionally or alternatively, the software application can be executed on an external system. That is, raw data can be collected from a work site, then analyzed off-site with an external system.

FIG. 6 is a flow diagram illustrating an example method with criteria that can be used to evaluate raw data received from transducer 210. The method of FIG. 6 can be used with the systems and methods disclosed herein, as well as other systems and methods. For example, the method of FIG. 6 can be implemented in computer-executable instructions, e.g., instructions stored in memory 243 and executed by processor(s) 242 of processing device 230.

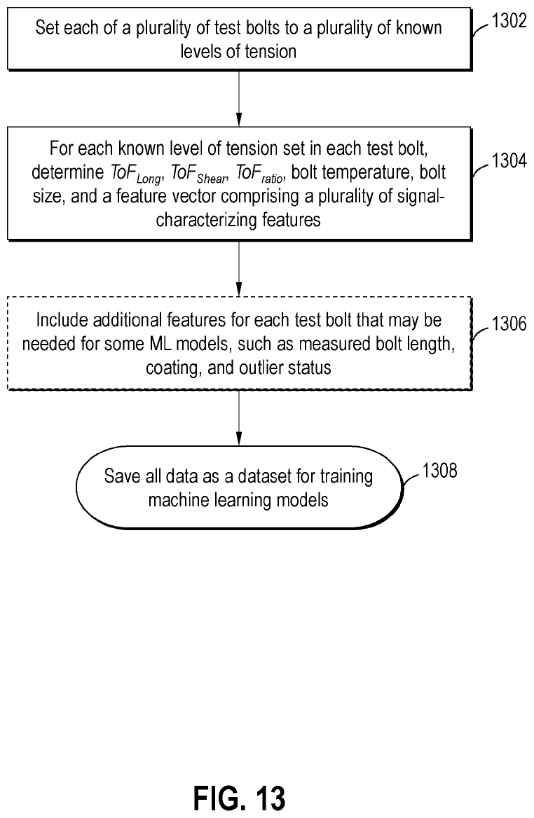

At step 602, signals from transducer 210 corresponding to a test event are received. For example, in embodiments where transducer 210 is a longitudinal wave transducer, the signals received at step 602 may relate to echoes of longitudinal waves in bolt 106. In embodiments where transducer 210 is a shear wave transducer, the signals received at step 602 may relate to echoes of shear waves in bolt 106. In embodiments where transducer 210 is a combination longitudinal wave and shear wave transducer, the signals received at step 602 may relate to echoes of longitudinal waves and shear waves in bolt 106. The signals received at step 602 may be received by pulser/receiver 220, processing device 230, or both. The signals received at step 602 may comprise raw data relating to amplitude, phase, frequency, voltage, and time of the echoes. For example, FIG. 12 is a graph diagram illustrating an example of raw data corresponding to longitudinal wave echoes in a bolt. Raw data corresponding to shear waves would result in a similar diagram. In FIG. 12, three echoes are illustrated; however, any number of echoes can be captured during a test event.

Returning to FIG. 6, raw data received at step 602 can be analyzed at step 604 to evaluate whether the signal is clipped. This can happen when the amplitude of the raw data exceeds the operating range of the transducer 210. If it is determined at step 604 that the raw data is clipped, the raw data is considered bad data at step 606. The method can proceed to step 608 and instructions can be provided to the user (e.g., via a notification on the GUI) to reduce the gain of the transducer 210. With decreased gain, another test event can be conducted and the method restarts at step 602 by receiving another set of raw data.

If it is determined at step 604 that the signal is not clipped, the raw data can be analyzed at step 610 to determine whether the signal's amplitude is too low to provide accurate ToF measurements. For example, the signal amplitude may be too low if the first echo overall positive and negative peak amplitudes both fail to exceed a minimum threshold. If it is determined at step 610 that the signal amplitude is too low, the raw data is considered bad data at step 612. The method can proceed to step 614 and instructions can be provided to the user (e.g., via a notification on the GUI) to increase the gain of the transducer 210. With increased gain, another test event can be conducted and the method restarts at step 602 by receiving another set of raw data.

If it is determined at step 610 that the signal amplitude is not too low, the raw data can be analyzed at step 616 to determine whether the peak-to-noise ratio is too small for each of the echoes, which could be an indication of a noisy signal. If the peak-to-noise ratio is too small for any of the echoes, the data is considered bad at step 618. The method can proceed to step 620 and instructions can be provided to the user (e.g., via a notification on the GUI) to push the transducer and apply more pressure, to apply more couplant at the bolt/transducer interface, or to move the transducer to a new location on the bolt. After adjustments are made, another test event can be conducted and the method can restart at step 602 by receiving another set of raw data.

If it is determined at step 616 that the peak-to-noise ratio is not too small, the raw data can be analyzed at step 622 to determine whether aspects of the echoes are within an expected range and are consistent. For example, the time separating the overall positive (maximum) peak and the overall negative (minimum) peak for each echo can be analyzed to determine whether the times are within an expected range. Other aspects of the echoes can also be used, such as, for example, the time separating the in-phase maximum and the in-phase minimum. If, at step 622, it is determined that any peak or time separations are greater than a threshold, the data is considered bad at step 618. The method can proceed to step 620 and instructions can be provided to the user (e.g., via a notification on the GUI) to push the transducer and apply more pressure, to apply more couplant at the bolt/transducer interface, or to move the transducer to a new location on the bolt. After adjustments are made, another test event can be conducted and the method can restart at step 602 by receiving another set of raw data.

If it is determined at step 622 that the echo peak separations are not too great, the raw data may be used to calculate approximate ToF values at step 624. The ToF values can be calculated in different ways, e.g., by using the systems and methods disclosed in the '614 application and/or the '524 application, the disclosures of which relating to determining a ToF are expressly incorporated herein by reference and made a part hereof.

At step 626, the arrival time of the first echo peak can be compared to the approximate ToF to determine whether the echo occurred too early or too late. First echo times that fall outside of an expected range may be an indication of a fatigued bolt and/or faulty hardware or faulty pre-processing of the signal. If, at step 626, it is determined that the first echo occurred too early or too late (i.e., out of range), the data is considered bad at step 618. The method can proceed to step 620 and instructions can be provided to the user (e.g., via a notification on the GUI) to push the transducer and apply more pressure, to apply more couplant at the bolt/transducer interface, or to move the transducer to a new location on the bolt. After adjustments are made, another test event can be conducted and the method can restart at step 602 by receiving another set of raw data.

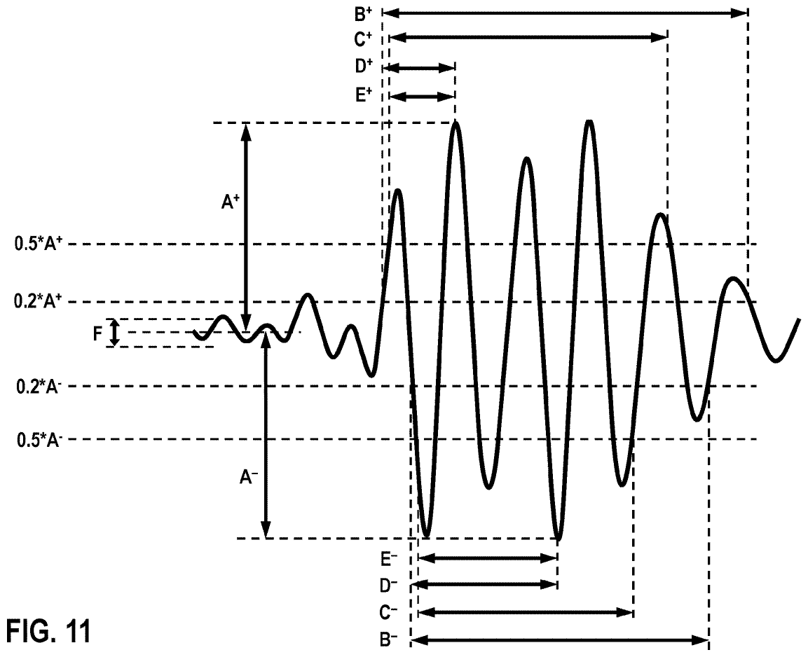

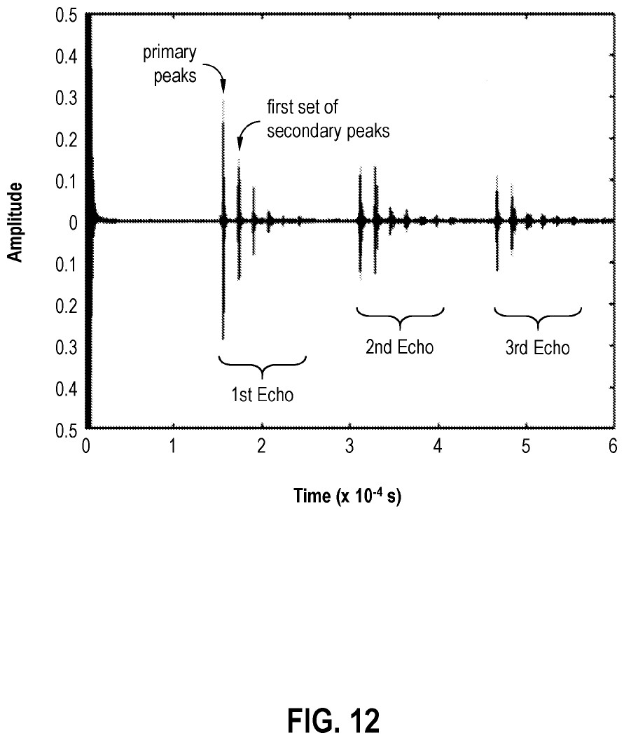

If it is determined at step 626 that the first echo did not occur too early or too late, the raw data is considered usable or suitable for further processing, such as to calculate one or more ToFs, to use as training data, etc. The method can proceed to step 628 and data corresponding to the test event and the analysis can be saved, such as ToFs measured, time stamps, and amplitudes corresponding to peaks and valleys for each of the waveforms. Other data can also be saved, such as the results of each of the checks performed. The data can be saved, for example, so that it can be analyzed to determine a ToF and numerous signal-characterizing features as explained in more detail below. It should be noted that the steps shown in FIG. 6 need not be performed in the order shown, nor must all of the steps be performed. Indeed, one of the purposes of performing the steps illustrated in FIG. 6 is to filter out bad data. Thus, one or more of the steps may be performed as desired to obtain such a data set. Additional checks can also be employed, including those disclosed in the '614 application and/or the '524 Application. Moreover, if multiple data sets are gathered before analyzing the data to find a ToF, etc., the methods of FIGS. 10 and 11 of the '614 application can be used, which methods are expressly incorporated herein by reference and made a part of this specification.

### Post Processor: Cross Correlation

Raw data received from transducer 210 during a test event can be used to calculate one or more ToFs (e.g., ToF_{Shear}, ToF_{Long}, modal ToFs). Preferably, the data will have passed one or more of the quality checks described above. The ToF can be calculated in various ways, such as described in the '614 and '524 applications. Additionally or alternatively, the ToF can be calculated using cross correlation.

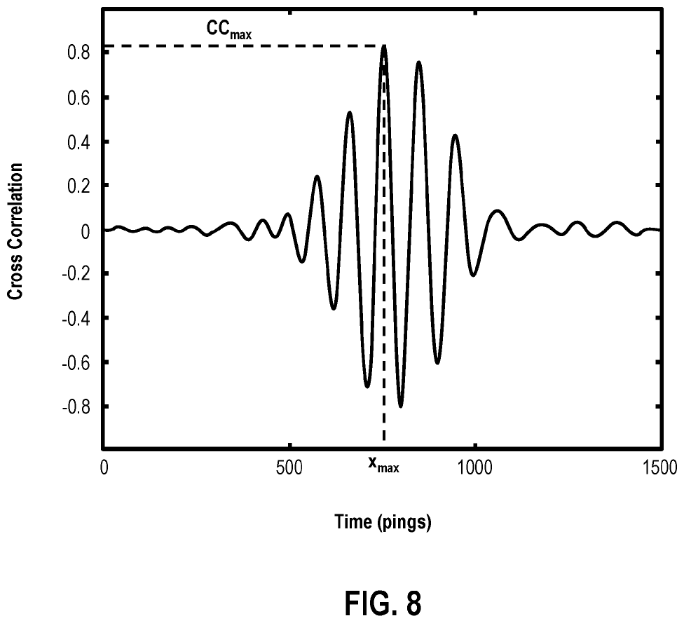

FIG. 7 is a graph diagram illustrating examples of first and second echoes from a longitudinal wave. Equal-sized snippets of the echoes are created by establishing an equal-sized window around the echoes. The cross correlation of the two snippets is then found, which entails finding the dot product for each possible relative position of the snippets that includes an overlap of at least one point from each snippet. For example, the first snippet can be held constant and the second snippet moved to a position in time before the first snippet. Then, sliding the second snippet one ping at a time across the first snippet from left to right, the dot product of the snippets is calculated until the second snippet has moved to the right of the first snippet such that the two snippets no longer overlap.

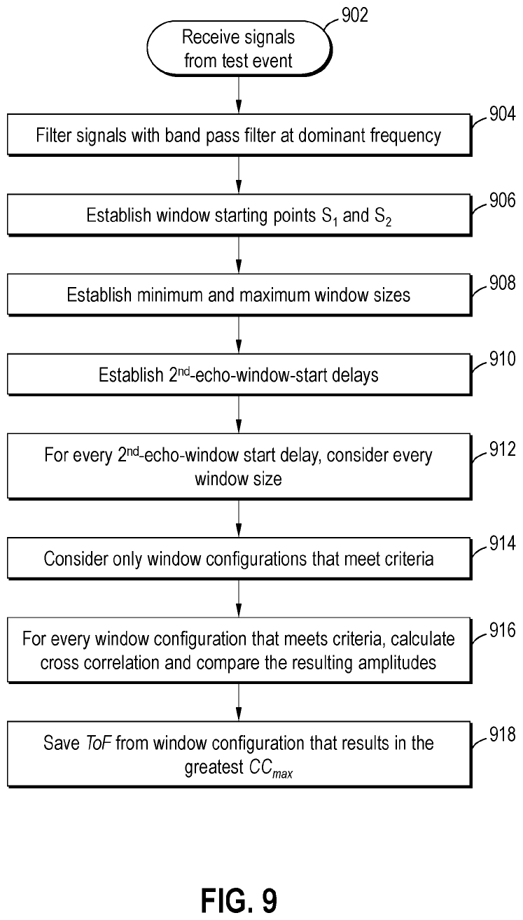

FIG. 8 is a graph diagram illustrating an example cross correlation for the two echoes (and snippets) shown in FIG. 7. The ToF can be calculated from the cross-correlation function using the following equation:

$$ToF = ( {S}_{2} - {S}_{1} ) - ( {x}_{max} - {W}_{L} ) \qquad ( 1 )$$

where ToF is the time of flight, S₁ is the starting time stamp of the 1^{st} window, S₂ is the starting time stamp of the 2^{nd} window, xₘₐₓ is the horizontal-axis value associated with the maximum amplitude of the cross-correlation function (CCₘₐₓ), and W_{L} is the length of the two windows.

### Post-Processor: Flexible-Window Algorithm

Although using cross-correlation to determine a time-of-flight is a known technique, it has its challenges. For example, the degree of consistency in the ToFs calculated using a cross-correlation function can be sensitive to the window sizes and locations of the windows. To mitigate uncertainty in the calculations, a flexible-window algorithm can be used. At a high level, the algorithm checks many different window configurations, and then uses the ToF from the configuration that produced the greatest CCₘₐₓ. Using the window configuration with the greatest CCₘₐₓ, as opposed to a single window configuration, can reduce the variation in ToFs and the incidence of outliers in the data.

FIG. 9 is a flow diagram illustrating an example method for calculating the highest cross correlation of two echoes, which can result in an accurate ToF. The example method can be used with the systems and methods disclosed herein, as well as other systems and methods.

The method begins at step 902 by receiving signals from a test event, where the signals contain at least two echoes. Preferably, the signals will have undergone and passed one or more of the signal quality checks described in relation to FIG. 6. At step 904, the signals can be band pass filtered at the dominant frequency. For example, a Fast Fourier Transform (FFT) can be applied to the signal to determine the dominant frequency, which is defined as the amplitude-weighted average of frequencies with amplitudes greater than 50% of the overall peak. The filter can then be applied to a range of frequencies surrounding the dominant frequency. For example, the filter can range from about 50% to about 170% of the dominant frequency, or preferably from about 60% to about 160% of the dominant frequency, or more preferably from about 70% to about 150% of the dominant frequency, thereby filtering out portions of the signals at frequencies above and below the range. In one non-limiting example, the filter can range from about 74% to 152% of the dominant frequency.

At step 906, the starting points S₁ and S₂ for the windows can be established. There are different ways to establish the starting points, such as defining them as a fixed amount of time that precedes each echo. Another way is to define the starting point as a percentage of an approximate ToF before an overall peak for the echo. These two ways can also be combined. For example, in one non-limiting example, the starting point S₁ for longitudinal waves is 200 pings before the overall peak for the first echo, and the starting point S₂ for longitudinal waves is 200 pings before the overall peak for the second echo. In another non-limiting example, the starting point S₁ for shear waves is 2% of the approximate ToF before the overall peak for the first echo, and the starting point S₂ is 2% of the approximate ToF before the overall peak for the second echo. The approximate ToF can be determined, for example, using the systems and methods disclosed in the '614 or '524 applications. Additionally, if the method of FIG. 6 is performed to evaluate the quality of the signals received at step 902, the ToF calculated during that performance can be stored and used in connection with the method of FIG. 9.

At step 908, the minimum and maximum window sizes can be established. In some embodiments, the minimum and maximum window sizes can be 100 pings, 125 pings, 150 pings, 200 pings, 250 pings, 300 pings, 400 pings, 550 pings, and so on, including any greater, lesser, or intermediate value in one-ping increments. In some non-limiting examples, the minimum window size for shear waves is 200 pings and the minimum window size for longitudinal waves if 500 pings, while the maximum window size for shear waves and longitudinal waves is each 500 pings.

At step 910, the delay for which to start the 2^{nd} echo window can be established. For example, the first window (starting at S₁) can be held constant throughout the method. The second window can be varied around the second starting point. For example, suppose that S₂ is established at 2900 pings. Because the 2^{nd} window will slide past the first window when calculating the cross correlation, the second window can be varied by some time factor before and after 2900 pings. The time factor can be +/−10, 20, 30, 40, 50, 75, 100, 150, 200, 300, 400, 500 pings, including any greater, lesser, or intermediate value in one-ping increments. In one non-limiting example, the 2^{nd} window is varied by +/−400 pings (centered on S₂) for shear waves and +/−200 pings (centered on S₂) for longitudinal waves.

At step 912, every window size for every 2^{nd}-echo-start delay is considered. For example, suppose that transducer 210 generates signals relating to longitudinal waves. Suppose further that S₁ is established as 1400 pings, S₂ is established as 2900 pings, the minimum window size is established as 400 pings, the maximum window size is established as 500 pings, and the 2^{nd}-echo-window-start delay is established as −200 to 200 pings. Then, starting at the first 2^{nd}-echo-start delay, which would be 2700 pings (i.e., 2900 pings (S₂)−200 pings), every possible window configuration is considered, which would include a first window and a second window that varies in size from 400 to 500 pings starting at 2700 pings. Then, the 2^{nd} echo-window-start delay is increased by one so that the second window begins at 2701 pings. Every possible window configuration that varies in size from 400 to 500 pings is again considered at this new starting point. This process can be repeated until every size window for the first and second windows are considered at every starting point based on the location of S₂ and the 2^{nd}-echo-window-start delay (in this example, from 2700 pings to 3100 pings).

At step 914, only certain window configurations from step 912 are used to calculate the cross correlation, such as window configurations that meet certain criteria. For example, in some embodiments, window configurations may not be considered unless they include: (i) the first incidence of an amplitude that is a threshold percentage of the overall max (positive or negative), such as 20%; and (ii) the overall positive and negative peaks or some percentage thereof. For example, the criterion could be different depending on the echo. In some embodiments, this criterion for the second echo window could require only the first incidence of 50% of the overall max (e.g. 2^{nd} echo for shear waves). The first criterion can help ensure that the 2^{nd} echo window includes the beginning of the 2^{nd} echo. The second criterion can help ensure that the windows include enough of each echo.

For the window configurations that meet the criteria at step 914, at step 916, the cross correlation between the first and second echoes for each configuration can be calculated and compared to identify the configuration that resulted in the greatest amplitude. In some embodiments, it could be advantageous to use a normalized cross correlation function when performing the calculations since the length of the windows will likely vary. Otherwise, longer windows would be unfairly advantaged when the cross correlation amplitudes are compared.

At step 918, the ToF that results from the greatest cross correlation value (CCₘₐₓ) can be saved for later application, e.g., as input to machine learning models.

Because numerous window configurations (in 1-ping increments) are considered for numerous S₂ starting points (in 1-ping increments), computation time for performing the method of FIG. 9 can be fairly significant. One modification to the method is to consider only some 2^{nd}-echo-window-start delays and some window sizes until a largest cross correlation is identified, and then re-running the algorithm with more granularity around that value. For example, in some embodiments, the method of FIG. 9 includes considering only every 10th 2^{nd}-echo-window-start delay and every 10th window size. After finding the configuration with the highest CCₘₐₓ, the method narrows the set of possibilities around that configuration. The method is performed again, but this time by considering only every 5th delay and every 5th window size in that narrower set of possibilities. Then, again, the method reduces the set of possibilities around that configuration, and then considers every delay and every window size within that smaller set. Finally, the ToF from the window configuration that produces the greatest CCₘₐₓ in that final set is the ToF output for that signal by the post processor. In this way, the same solution can be reached with fewer computations.

### Post-Processor: Feature Production

As explained elsewhere herein, a machine learning model can be trained on, or receive as input, the ToF for shear waves, ToF for longitudinal waves, the UT response (i.e., ratio of ToFs), and numerous signal-characterizing features, among other values. The signal-characterizing features are related to the time, frequency, and energy of the shear and longitudinal signals and can be used to train models or to make predictions (e.g., bolt coating, size, length, stress predictions, etc.).

One feature is the maximum cross correlation between two echoes, which characterizes how well the echoes correlate with each other. Another set of features relates to frequency information. For example, the peak frequency (F_{P}) can be identified from a frequency response of the signal (e.g., by converting the signal from the time domain to the frequency domain). FIG. 10 is a graph diagram illustrating a typical frequency distribution of a signal, with the peak frequency identified as F_{P}. Another frequency characteristic is the weighted-average frequency (F_{A}) of all amplitudes greater than half the peak amplitude. Also, each transducer has a rated operating frequency F_{R}. From the characteristics F_{R}, F_{P}, and F_{A}, additional features can be found such as the ratio of F_{P}/F_{A}, which indicates the degree of symmetry in frequency distribution, the ratio of F_{P}/F_{R}, which compares the peak frequency of the signal to the rated frequency of the transducer, and the ratio of F_{A}/F_{R}, which compares the weighted-average frequency from the signal with the rated frequency of the transducer.

Additional signal-characterizing information can be ascertained or derived from each echo. For example, FIG. 11 is a graph diagram illustrating various features of an echo. In FIG. 11, “+” denotes positive amplitudes while “−” denotes negative amplitudes. Referring to FIG. 11, feature A is the overall maximum (A⁺) and overall minimum (A⁻) amplitudes of the echo. Feature B is the width of the echo measured from the first and last occurrences of 20% of A. Feature B can be normalized by the ToF to create another feature, B/ToF. Feature C is the width of the echo measured from the first and last occurrences of 50% of A. Feature C can be normalized by the ToF to create another feature, C/ToF. Feature D is the time from the first occurrence of 20% of A to the overall maximum amplitude. The ratio of D/B can be found, which is the overall maximum position relative to B. Feature E is the time from the first occurrence of 50% of A to the overall maximum amplitude. The ratio of E/C can be found, which is the overall maximum position relative to C. The average of feature F (avg F) is a measure of the absolute value of noise preceding the echo by approximately 10% to 15% of the ToF or approximate ToF. From this, the feature A/(avg F) can be found, which is the peak-to-noise ratio. Each of these features can also be ascertained or derived from additional echoes in the signal, such as the second echo, third echo, etc.

Other features or values can also be derived from the echoes and from the features noted above, including the following features listed in Table 1:

TABLE 1

| Feature | Indicates |
|---|---|
| A₁/A₂ | Ratio of overall maximums |
| (time of A⁺) − (time of A⁻) | Peak separation |
| [(time of A₁⁺) − (time of A₁⁻)]/ | Ratio of peak separations |
| [(time of A₂⁺) − (time of A₂⁻)] | |
| (D⁺/B⁺)/(D⁻/B⁻) | Ratio of peak positions within |
| | echo, relative to B |
| (E⁺/C⁺)/(E⁻/C⁻) | Ratio of peak positions within |
| | echo, relative to C |
| B₁/B₂ | Ratio of echo widths, using |
| | B-type echo width |
| C₁/C₂ | Ratio of each widths, using |
| | C-type echo width |
| (D₁/B₁)/(D₂/B₂) | Ratio of overall max |
| | positions, using B-type echo |
| | width |
| (E₁/C₁)/(E₂/C₂) | Ratio of overall max |
| | positions, using C-type echo |
| | width |
| (avg F₁)/(avg F₂) | Ratio of noise preceding each |
| | echo |
| (A₁/(avg F₁))/(A₂/(avg F₂)) | Ratio of peak-to-noise ratios |

Still other features or values can be derived from the echoes and from the features noted above. Many of the features described so far are based on the overall maximum A and its location in time. Feature B, for example, is the width of the echo measured according to the first and last occurrence of an amplitude that is 20% the value of A. However, instead of using the maximum amplitude (A) and its location in time to derive the features noted above, a weighted average of the amplitudes and its location in time can be used. Thus, another set of features can be derived by finding the weighted average of amplitudes and its location in time within the echo-width B, then using that value as a replacement for A to derive the other features. The same can be done for amplitudes that fall within echo-width C. One variation that results in two additional sets of features is to use the weighted average of the squares of the amplitudes of the echo and its location in time that are within echo-width B and within echo-width C. Because voltage is the quantity being measured, this variation would relate to the energy in the signal.

Another feature is a “double-peak factor” (DPF). This is a measure of the second highest peak amplitude in the echo that falls within the echo-widths B & C, divided by A. If the DPF is high, it would tend to indicate that the echo has a double peak, which could make an outlier more likely to occur. Thus, the DPF could be a useful feature for detecting outliers. Relatedly, another feature is a “triple-peak factor” (TPF). This is a measure of the third highest peak amplitude in the echo that falls within the echo-widths B & C, divided by A. If the TPF is high, it would also tend to indicate that the echo has a triple peak and an outlier more likely to occur.

Another feature is a “rectangularity factor” (RF). This is a measure of the average amplitude of all other peaks within the echo that fall within echo-widths B & C, divided by A. The higher the value of RF, the more rectangular the shape of the echo envelope. The lower the value of RF, the more triangular the shape of the echo envelope.

Another feature is the ratio of DPF₁/DPF₂, where DPF₁ is the double-peak factor of the first echo and DPF₂ is the double-peak factor of the second echo. Two other features are the ratio of TPF₁/TPF₂, and the ratio of RF₁/RF₂.

Another set of features relates to how the ToFs are found. For example, as described above, the ToF can be found using cross correlation and the flexible-window algorithm, which generally will result in accurate ToF measurements. However, the ToFs can also be found using the overall peaks (as described in the '614 and '524 applications), weighted-average location of the amplitudes, and weighted-average location of the squares of the amplitudes.

Another feature is “secondary-echo spacing.” Each echo has a primary set of peaks and a secondary set of peaks as illustrated in FIG. 12. The secondary set of peaks are modal waves that result from mode conversion and indirect paths taken by the wave energy, as explained in detail below. This feature is a measure of the ToF divided by the time of the secondary-echo overall peaks minus the time of A. This feature likely correlates with bolt aspect ratio.

Another feature is a “1^{st}-echo delay.” This is a measure of the time of the first echo minus the ToF, divided by the ToF. This feature can be calculated using the various echo-location types and ToFs found in different ways as explained above. For example, the “time of the first echo” can be based on A, a weighted-average location of the amplitudes, or a weighted-average location of the squares of the amplitudes. The ToF can be found using cross correlation, the overall peaks (as described in the '614 and '524 applications), weighted-average location of the amplitudes, and weighted-average location of the squares of the amplitudes.

Another set of features includes the echo area under the curve (i.e., absolute value of area under positive and negative amplitudes) and the echo area under the squares of the amplitudes for each of the 1^{st} and 2^{nd} echoes, and for each of echo widths B and C, and the ratios of each value.

Another set of features is to normalize the features described above by dividing each feature by the ToF (to the extent not already normalized by the ToF), and then separately by each echo width.

Another set of features is to compute all of the values for the features described above for both positive and negative amplitudes (to the extent not already done), and then to compute the mean of those values.

Another set of features is to compute the 1^{st} to 2^{nd} echo ratios for all of the values for the features described above (to the extent not already done).

Another set of features is to compute all of the values described above for both raw signals and filtered signals. The filtered signals can be band pass filtered as explained above.

Another set of features is to compute the raw-signal-to-filtered signal ratios for all values described above.

Another set of features is to compute shear-signal-to-longitudinal-signal ratios for all values described above.

Another set of features is to compute the ratio of every two features, including for both shear and longitudinal waves, and for both the first and second echoes of each.

Another set of features is to compute the maximum amplitude of the raw cross-correlation function.

Another set of features is to compute the ratio of the maximum amplitude of the normalized cross-correlation function to that of the raw cross-correlation function.

Another set of features is to compute the length of the first-echo window and the length of the second-echo window used in the cross-correlation function.

Another set of features is to compute the maximum amplitude in the raw cross-correlation function divided by the window length. Another feature is the amplitudes of each alternate peak in the normalized cross-correlation function.

Another set of features is to compute the ratio of the amplitude of each alternate peak in the normalized cross-correlation function to the maximum amplitude in the normalized cross-correlation function.

### Machine Learning Models

As explained above, ultrasonic longitudinal and shear wave signals can be processed to determine (i) a ToF for shear wave signals, (ii) a ToF for longitudinal wave signals, (iii) a UT response, and (iv) numerous signal-characterizing features. This and other data, such as bolt temperature and bolt size, can be used to train machine learning models on different characteristics of bolts. The machine learning models can also use this data when collected from target bolts to predict different characteristics of the target bolts.

For example, suppose there are hundreds of bolts on a structure, such as a tower for a wind turbine, that are to be audited to determine whether their residual tension is sufficient to meet engineering specifications for that structure. Using the inventions disclosed herein, a set of test bolts can be selected to create training data. The test bolts need not be disposed on the same structure and can instead be disposed on a different structure or even examined in a laboratory setting. Of course, bolts on the same structure to be audited can also be used to create training data. Each test bolt can then be examined a plurality of times (e.g., 20 times) at a plurality of known levels of tension (e.g., by setting the test bolt to levels of tension). Using the methods described above or other methods, the ToFs and signal-characterizing features can be derived or ascertained from each test event. In this example, if each of the 50 test bolts were examined 20 individual times using longitudinal waves at 20 different known levels of tension, and 20 individual times using shear waves at 20 different known levels of tension, the data set would comprise at least 20,000 sets of results for longitudinal waves and 20,000 sets of results for shear waves. Each set of results would comprise ToFs for particular wave types, ToF ratios (i.e., UT response), signal-characterizing features, bolt temperature, and bolt size. This large data set can be used as training data for machine learning models. Of course, the number of test bolts can be selected, the number of individual test events conducted, and the number of different levels of tension set in each test bolt can vary when generating training data.

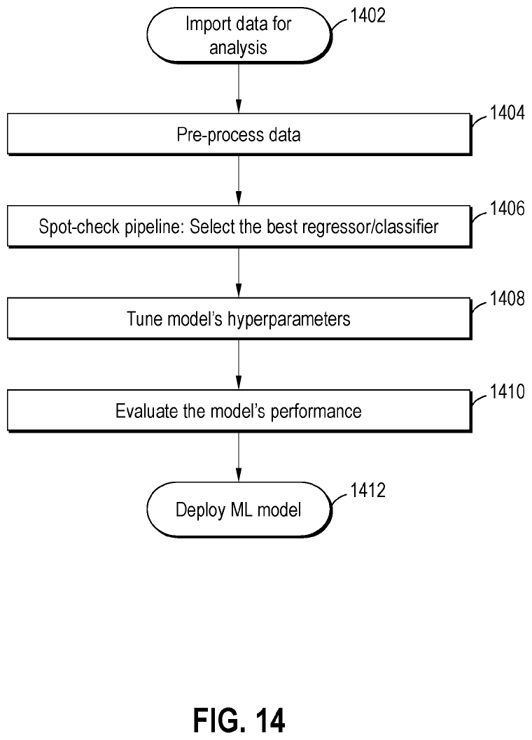

FIG. 13 is a flow diagram illustrating an example method for generating a dataset to train a machine learning model to predict a characteristic of a bolt. At step 1302, each of a plurality of test bolts can be set to a plurality of known levels of tension. One or more test events can be conducted on each test bolt at each level of tension. At step 1304, for each known level of tension set in each test bolt (i.e., each test event), ToF_{Long}, ToF_{Shear}, ToFᵣₐₜᵢₒ, bolt temperature, bolt size, and a feature vector comprising a plurality of signal-characterizing features can be determined. The times-of-flight can be determined, for example, by using the systems and methods disclosed herein. Bolt temperature and bolt size can be determined manually. The signal-characterizing features can be extracted from the data generated during each test event as explained above. At step 1306, additional optional features can be added to the dataset that may be helpful to train certain machine learning models, such as measured bolt length, bolt coating, and outlier status. At step 1308, the data from steps 1304 and 1306 can be saved as a dataset for training machine learning models.

With models trained on this data, they can be used to make predictions about the hundreds of bolts on the structure under audit. For example, a field operator can measure the response from longitudinal waves and shear waves transmitted into a target bolt under audit. The raw data collected from the measurements can be processed to determine ToFs from the target bolt, such as ToF_{Shear}, ToF_{Long}, ToFᵣₐₜᵢₒ, and signal-characterizing features. This data, along with temperature of the target bolt, can be provided as input to one or more machine learning models to make predictions about the target bolts.

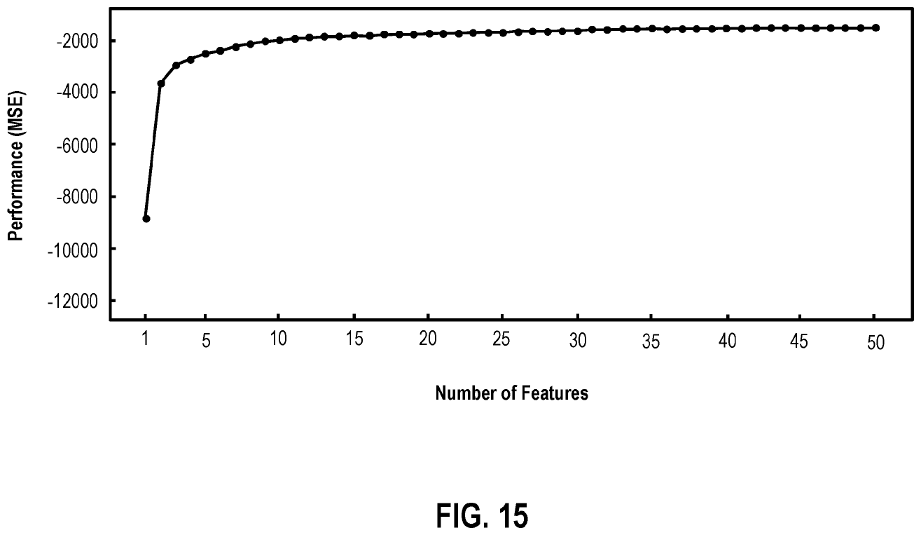

FIG. 14 is a flow diagram illustrating a general method for training supervised regression or classification machine learning models to predict bolt coating, bolt size, and bolt length, to detect and/or remove outliers, to predict stress, and for other aspects of the inventions as explained herein.

Beginning at step 1402, data is imported for analysis. The data can be received from the post-processing methods described above. For example, post-processing software can store data in a table, such as a dataframe, from which the machine learning software can read the data. The data can be arranged, for example, with rows comprising data collected during test events (and, e.g., post-processed) and columns comprising signal-characterizing features and targets. The signal-characterizing features can be generated from the longitudinal and shear wave signals as explained above with the exception of bolt temperature. Temperature can be input manually or automatically, e.g., from a sensor. Targets include the unknown quantities that the machine learning models will be used to predict, such as stress, coating, outlier status, etc.

At step 1404, the data can be pre-processed. It is advantageous to pre-process the data before training a machine learning model to help ensure that the data is valid. For example, any missing values (NaN) or infinite values should be identified and removed or replaced before training a machine learning model. These values can arise, for example, when the post-processor performs calculations that include dividing a number by zero (e.g., when a feature does not exist in the signal based on predefined criteria). Other pre-processing can also be performed.

For example, pre-processing can be used to address multicollinearity, which occurs when there are highly correlated features (e.g., Pearson/Spearman/Kendall Tau correlation coefficient greater than 0.95). Features that are highly correlated contribute minimally to predicting targets while at the same time increasing computational time. It is therefore advantageous to find and remove correlated features to resolve the multicollinearity problem. This can be achieved, for example, by calculating a correlation matrix to find features that are correlated with another feature above a certain threshold, such as 0.95. Once the correlations are found, the first feature can be retained while the other correlated features can be dropped.

Pre-processing can also include specifying a holdout set. Data collected from the test bolts can be divided into training and holdout sets. A training set is the data collected on the bolts from which the machine learning algorithm “learns” relationships between the features and the target variable, such as axial stress. A holdout set, sometimes referred to as “testing” data, provides a final estimate of the machine learning model's performance after it has been trained and validated, which is explained in more detail below in connection with step 1410. The holdout set includes the data collected on a subset of bolts (one or more bolts) that was not used in the training set to train the machine learning model, was not used to make decisions about which algorithms to use, and was not used for improving or tuning algorithms. In this way, the holdout set remains unseen data until it is needed at step 1410.

At step 1406, spot-checking can be performed to determine which regressor/classifier model performs well to make predictions (e.g., stress, outlier detection, bolt coating, etc.). This step includes trying numerous different machine learning algorithms and focusing attention on those that prove most promising to make accurate predictions. Effective evaluation and comparison of these algorithms may require a sequence of steps in the machine learning workflow (i.e., the pipeline). The purpose of the pipeline is to assemble several steps that can be cross-validated while setting different parameters. Three of those steps can include (i) Winsorizing extreme values, (ii) feature selection/engineering, and (iii) classification/regression. Each is now explained in more detail.

(i) Winsorizing. Winsorizing caps or limits extreme values in the feature columns to reduce the effect of outliers. Winsorizing retains the feature values in the data, but caps numeric outliers so that they fall at the edge of the main distribution. The result is similar to clipping in signal processing. For example, suppose a 5^{th} and 95^{th} percentile is specified as lower and upper limits. Values outside of these limits can be replaced with the respective percentile limits themselves (e.g., value at the 3^{rd} percentile can be replaced with the value at the 5^{th} percentile). Three approaches for Winsorizing the data includes (a) Gaussian approximation, (b) inter-quantile range proximity rule (IQR), and (c) percentiles. How far out to cap the extreme values can be based on the performance of the model. It is worth noting that Winsorization can be implemented as a pipeline step. Thus, the same capping/limiting can be applied to future or new data.

(ii) Feature Selection/Engineering. A machine learning model tends to overfit the data if there are many more features than the number of collected samples. It is therefore ideal for the total number of features used for the machine learning model to be a percentage of the total number of samples collected, such as 5%, 10%, 15%, 20%, and so on. For example, suppose that 1000 samples are collected. Ideally, the maximum number of features will be less than this amount, such as by 10%, which would result in 100 features. There are times, however, where the number of features far exceeds the number of samples that can reasonably be collected. For example, the possibility of thousands of different signal-characterizing features are described above. To address the situation where the number of features exceeds the number of samples, certain methods can be implemented to select a subset of features and reduce the likelihood of overfitting.

One method is Sequential Feature Selection (SFS). This method can be used to select a subset of important features that contribute most to the performance of the model (e.g., classifying/detecting outliers, predicting stress, etc.). SFS algorithms are a family of search algorithms used to reduce an initial d-dimensional feature space to a k-dimensional feature subspace, where k is less than d. The goal of feature selection is two-fold: to improve computational efficiency and to improve the model's generalization (i.e., reduce model overfitting) by removing irrelevant features or noise. The features selected by SFS are dependent on the regressor/classifier and the cross-validation (CV) method the user selects as part of the SFS pipeline. From empirical data, some features are known to have a direct impact on the target values. For example, the ToFᵣₐₜᵢₒ and bolt temperature are both known to affect the actual stress in a bolt. Thus, these two features should be included in the final prediction model. However, these features alone are generally not sufficient for highly accurate predictions. Other signal-characterizing features may also be included.

Which features to include can be determined with SFS. For example, one of the numerous signal-characterizing features can be selected for evaluation. That feature, along with the training data for all but one of the test bolts, can be used to make predictions about the one test bolt that was not included. Because the characteristics of the bolt that was not included are known from the measurements that generated the training data in the first place, the performance (i.e., accuracy) of the model can be determined with respect to that feature. Each of the test bolts can be evaluated this way with respect to that particular feature. If the feature was impactful for predictions for only some of the test bolts but not others, then that feature should probably not be included in the final prediction model. On the other hand, if the feature was impactful for accurate predictions for all of the test bolts, such as the ToFᵣₐₜᵢₒ and bolt temperature, then the feature should be included in the final prediction model. Each of the other thousands of signal-characterizing features can be tested this way. The result from this step should identify which features played the largest role in making accurate predictions for all of the test bolts.

Another method to reduce the number of features is Principal Component Analysis (PCA). This method reduces the dimensionality, or features, of a dataset by linearly transforming the data into a new coordinate system where the variation of the features is described by their distance on the x-axis. For example, 32, 64, or 128 components/dimensions can be used to describe most of the signal-characterizing features described above.

(iii) Classification/Regression.

The third processing step is used to define a list of machine learning models to evaluate performance. The models defined will be specific to the type of predictive modeling problem, e.g., classification versus regression. For example, when using machine learning models to predict bolt coating, the objective is to predict that a bolt has one of a finite number of possible coatings, such as hot-dipped galvanized (tZn) or delta seal (DS). Thus, for this particular problem, a classification model is used. On the other hand, a regression model can be used to predict the stress in a bolt since the target/output (i.e., stress) is continuous rather than one of a number of finite possibilities. However, a regression task can be changed to a classification task by creating labels for a range of expected regression outcomes, e.g., based on empirical data. For example, the regression task of predicting stress in a bolt can be changed into a binary classification task by creating only two possible outcomes of “passing” or “failing,” where “passing” is greater than some percentage of the bolt yield strength (e.g., 55%) and “failing” is below the yield strength.

A number of different linear, nonlinear, ensemble, and neural network machine learning algorithms can be used for classification and regression problems. For example, with respect to classification problems, some linear algorithms whose performance can be evaluated at this step include Logistic Regression, Ridge Classifier, Stochastic Gradient Descent Classifier, and Linear Discriminant Analysis. Non-linear algorithms whose performance can be evaluated at this step can include k-Nearest Neighbors Classifier, Decision Tree Classifier, Support Vector Classifier, and Quadratic Discriminant Analysis. Ensemble algorithms whose performance can be evaluated at this step can include Extra Trees Classifier, Random Forest Classifier, Gradient Boosting Machine (GBM) Classifier, AdaBoost Classifier, Extreme Gradient Boosting (XGBoost) Classifier, Light Gradient Boosting Machine (LGBM) Classifier, CatBoost (Categorical Gradient Boosting) Classifier, Voting Classifier, and Stacking Classifier.

As further examples, with respect to regression problems, some linear algorithms whose performance can be evaluated at this step can include Linear Regression, Lasso Regression, Ridge Regression, Elastic Net Regression, Huber Regression, LARS Regression, Lasso-LARS Regression, Stochastic Gradient Descent Regression, and Bayesian Ridge Regression. Non-Linear algorithms whose performance can be evaluated at this step can include k-Nearest Neighbors Regressor, Decision Tree Regressor, and Support Vector Regression. Ensemble algorithms whose performance can be evaluated at this step can include Extra Trees Regressor, Random Forest Regressor, Gradient Boosting Regressor, AdaBoost Regressor, Extreme Gradient Boosting (XGBoost) Regressor, Light Gradient Boosting Machine (LGBM) Regressor, CatBoost Regressor, Voting Regressor, and Stacking Regressor. Neural network algorithms whose performance can be evaluated at this step can include Multi-layer Perceptron (MLP) Regressor and Keras Regressor.

Once the pipeline is spot-checked, the various models can be evaluated to assess their performance. This can be accomplished, e.g., using Leave One Group Out (LOGO) or Leave P-Groups Out (LPGO) cross-validation. LOGO is a cross-validation scheme which holds out the samples according to a provided array of integer groups. This group information can be used to encode arbitrary domain-specific pre-defined cross-validation folds. Each training set is thus constituted by all the samples except the ones related to a specific group.

For example, suppose 50 test bolts are selected to generate training data, which can include, for example, ToF_{Shear}, ToF_{Long}, TOF Shear/ToF_{Long}, bolt temperature, bolt size (diameter), bolt length, and the signal-characterizing features. To train the model, data from 49 of the test bolts can be used to predict the characteristics of the remaining bolt (which characteristics are known a priori). The performance of the model (i.e., accuracy) can then be determined. Then, a different test bolt is held out and the other 49 test bolts are used to predict the characteristics of the withheld test bolt, along with determining the performance of the model. This process can be repeated until each test bolt has been withheld and the remaining 49 test bolts have been used to make predictions about the withheld test bolt. Once complete, the next model can be considered and the process repeated.

LPGO is similar to LOGO except that samples related to P groups (e.g., bolts) for each training/test set are removed. All possible combinations of P groups are left out, meaning that test sets will overlap for P>1.

The metric calculated on the predictions from each model can be specified. Model selection and evaluation using cross-validation take a scoring parameter that controls what metric they apply to the estimators evaluated. For example, scores used for evaluating classification models can include Accuracy Score, Precision Score, Recall Score, F1 Score, ROC AUC (Area Under the Receiver Operating Characteristic Curve), and Jaccard Score. As another example, scores for evaluating regression models can include Mean Absolute Error (MAE), Mean Squared Error (MSE), Root Mean Squared Error (RMSE), Mean Absolute Percentage Error (MAPE), and Max Error.

One benefit of training machine learning models this way is that it enables one to identify which features consistently have the largest impact on the predictions as explained above in connection with SFS. For example, it is possible that the feature A₁/A₂ impacts all fifty predictions of the test bolts, whereas the feature (avg F₁)/(avg F₂) might impact predictions for only 6 of the 50 test bolts. In this example, the feature A₁/A₂ clearly has a greater impact on the predictions than the feature (avg F₁)/(avg F₂). As explained above, this process can be used to identify which features are most impactful for the characteristic to be predicted with the model (e.g., bolt coating, size, length, stress) and should therefore be included in the final model.

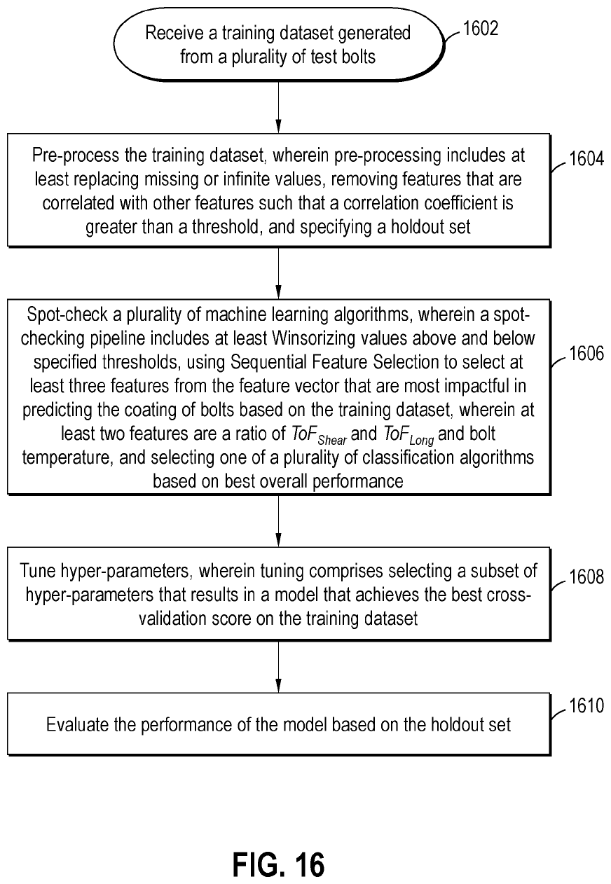

For example, FIG. 15 is a graph diagraph illustrating an example relationship between the number of features selected to train a machine learning model and the mean squared error (MSE). The graph diagram illustrates how the negative MSE can increase by adding extra features, meaning that the error decreases. It is apparent that the first 2-3 features contribute the most to the performance increase, whereas there are diminishing returns for features above 30. Thus, it may be computationally efficient to use only some features to make predictions about unknown characteristics of target bolts, instead of using every feature, which could be in the thousands, tens of thousands, or even millions. Moreover, adding features that contribute little if any impact on the performance of the model actually decreases the performance of the model. These types of features are essentially noise in the model (i.e., random numbers) that may change from one sample to the next. Using these types of features will typically lower the overall performance of the model.

At step 1408, the hyper-parameters of the machine learning model can be tuned. Hyper-parameters are parameters that are not directly learned within the classifiers/regressors (e.g., C, kernel and gamma for Support Vector Classifier, alpha for Lasso, etc.). Often, the general effects of hyper-parameters on a model are known, but how to best set a hyper-parameter and combinations of interacting hyper-parameters for a given dataset can be challenging. One approach is to objectively search the hyper-parameter space and choose a subset that results in a model that achieves the best cross-validation score on a given dataset. This is referred to as hyper-parameter optimization or hyper-parameter tuning. A search can comprise: an estimator (regressor or classifier), a parameter space, a method for searching or sampling candidates, a cross-validation scheme, and a score function.

Two approaches to parameter search include GridSearchCV, which exhaustively considers all parameter combinations, and RandomizedSearchCV, which samples a given number of candidates from a parameter space with a specified distribution. These tools are available in scikit-learn, which is a free software machine learning algorithm for the Python programming language. Both tools have successive halving counterparts: HalvingGridSearch CV and HalvingRandomSearchCV, which can more quickly find a good parameter combination. Due to the time-consuming nature of hyper-parameter tuning, it may be preferable that extensive hyper-parameter tuning of the estimator pipeline (e.g., Winsorizer>SFS>regressor) be carried out only on a few of the top-performing models from the spot-check.

At step 1410, an honest evaluation of model performance can be determined. This step can be advantageous to assess how well the best model selected will perform once deployed in the field. For example, the holdout set created at step 1404 can be used. Because the holdout set is unseen data, it can be used to evaluate the generalization of the model, thereby eliminating any potential biases (i.e., an honest assessment). This should simulate how the model will perform once deployed to the field and used to predict characteristics of target bolts. If there is overfitting, the error would likely be high for this assessment (e.g., significantly higher than the cross-validation score in the hyper-parameter tuning step). That is, the assessment score is not expected to be too different from the score obtained from cross-validation in step 1408. This can serve as a confirmation for the model selected in the spot-check step.

At step 1412, the machine learning model can be deployed to the field and used to predict characteristics of target bolts. For example, one or more machine learning models can be deployed on processing device 230.

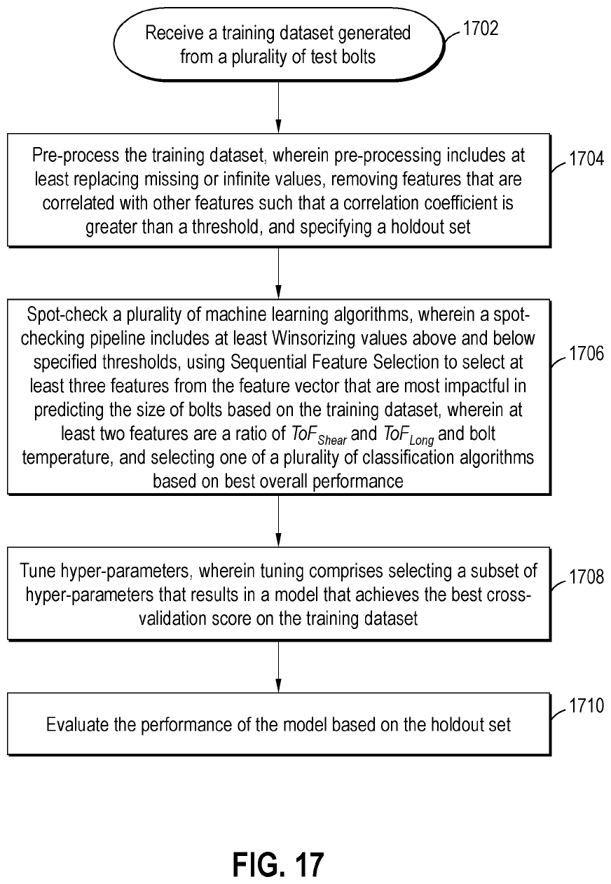

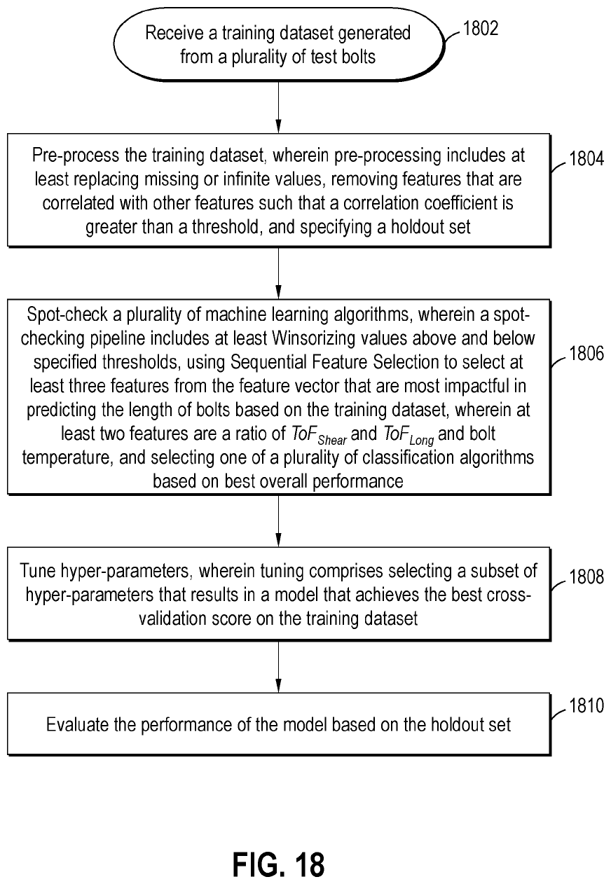

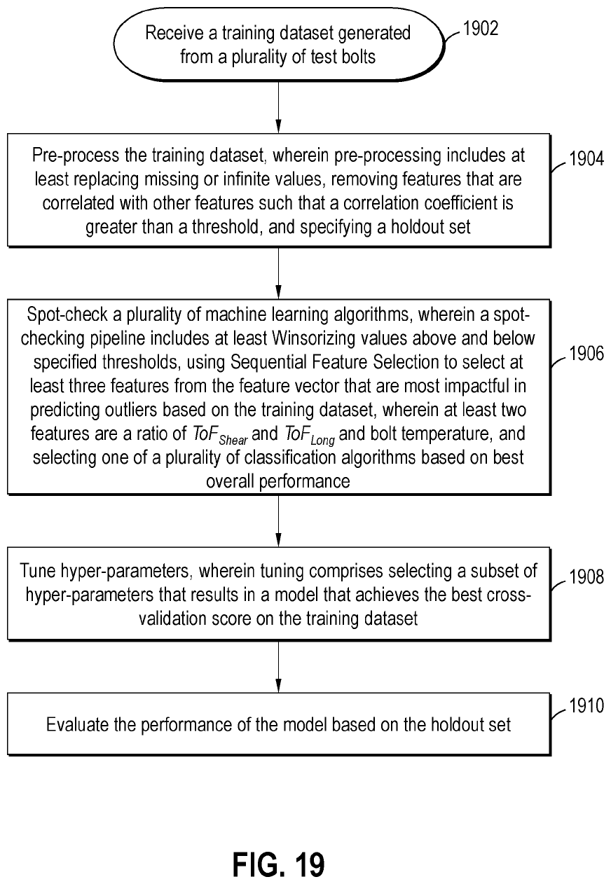

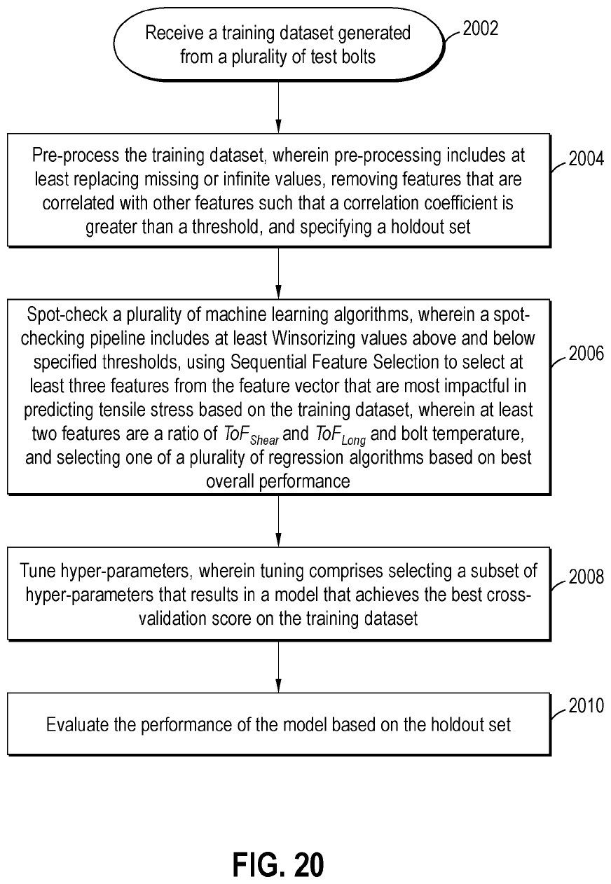

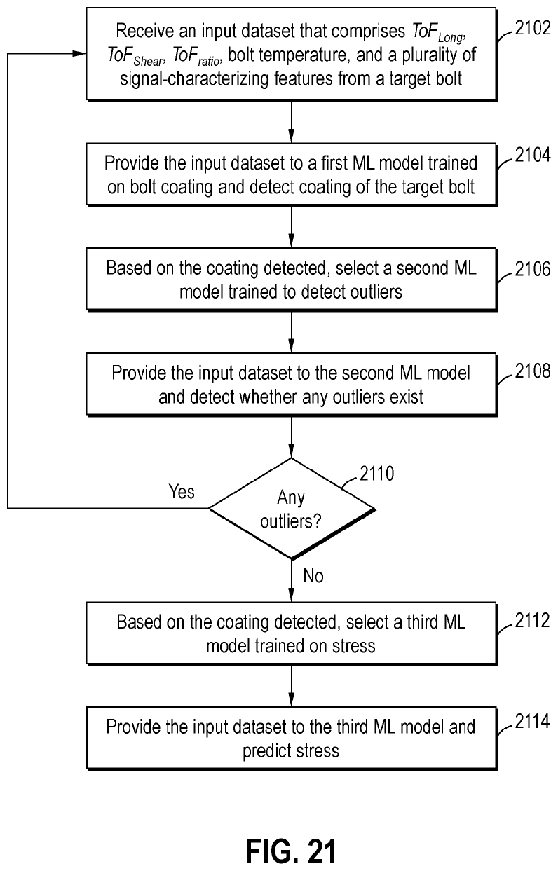

The method of FIG. 14 provides a framework under which different machine learning models can be trained for different aspects of the invention. For example, using the method of FIG. 14, machine learning models can be trained on bolt coating, bolt size, bolt length, outliers, and tensile stress. The models can then be used to predict these characteristics of target bolts in situ. FIGS. 16-20 are example flow diagrams for training supervised machine learning models on different characteristics of bolts according to embodiments of the invention. For example, the method of FIG. 16 can be used to train a machine learning model on bolt coating. The method of FIG. 17 can be used to train a machine learning model on bolt size. The method of FIG. 18 can be used to train a machine learning model on bolt length. The method of FIG. 19 can be used to train a machine learning model to detect outliers. The method of FIG. 20 can be used to train a machine learning model on tensile stress. In each of the methods of FIGS. 16-20, the training dataset can be generated using the method of FIG. 13.

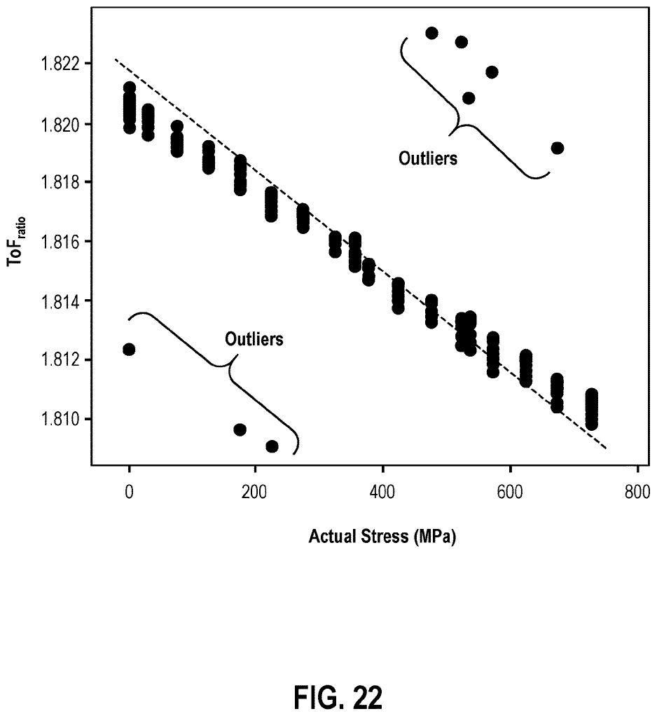

Once the different machine learning models are trained, they can be used to make predictions about target bolts in the field. For example, FIG. 21 is a flow diagram illustrating an example method for using machine learning models to determine stress of a target bolt. The method can be implemented using the systems and methods disclosed herein.

At step 2102, an input dataset can be received. The input dataset can comprise ToF_{Long}, ToF_{Shear}, ToFᵣₐₜᵢₒ, bolt temperature, and a plurality of signal-characterizing features from a target bolt. For example, responses from ultrasonic shear waves and ultrasonic longitudinal waves in the target bolt can be measured. The responses can be measured 1 time, 2 times, 5 times, 10 times, 20 times, and so forth, including any lesser, greater, or intermediate number of times. For example, in some embodiments, a longitudinal wave transducer can be used to generate a longitudinal wave in the target bolt and the response measured. The measurement can be analyzed to ensure it meets certain minimum quality criteria, such as by using the method of FIG. 6. Thereafter, a shear wave transducer can be used to generate a shear wave in the target bolt and the response measured. Similarly, the measurement can be analyzed to ensure it meets certain minimum quality criteria (e.g., using the method of FIG. 6). The data collected from the longitudinal wave and shear wave measurements can be used to compute times-of-flight, and a ratio thereof by using the method of FIG. 9. The data set from these test events, along with signal-characterizing features extracted therefrom and bolt temperature, can be saved as the input dataset.

In another embodiment, the above procedure is repeated 20, 30, 40 times, etc., for longitudinal waves and 20, 30, 40 times, etc., for shear waves. In still other embodiments, the longitudinal and shear wave transducers can generate pulses of waves for consecutive test events, the data from which can be processed (e.g., averaged) to generate one composite signal for longitudinal waves and one composite signal for shear waves. For example, a longitudinal wave transducer connected to the target bolt can be triggered, which in turn generates 32 individual longitudinal wave test events. Software, such as on processing device 230, can receive the raw data from the test events, process the raw data, and generate a single composite signal, such as an average of the test events. Then, a shear wave transducer connected to the target bolt can be triggered, which in turn generates 32 individual shear wave test events. Software can receive the raw data from the test events, process the raw data, and generate a single composite signal, such as an average of the test events. The data from the composite longitudinal wave signal and the composite shear wave signal can be checked to determine whether it meets certain quality criteria, such as by using the method of FIG. 6. If the data passes the quality checks, it can be used to calculate ToFs and a ratio thereof. The ToFs, ToFᵣₐₜᵢₒ, signal-characterizing features extracted therefrom, and bolt temperature can be saved as the input dataset.

At step 2104, the input dataset can be provided to a first machine learning model that has been trained on bolt coating. The first machine learning model can be trained using the method of FIG. 16, for example. Using the input dataset, the first machine learning model can detect the coating of the target bolt.

At step 2106, a second machine learning model that has been trained to detect outliers for bolts can be selected based on the coating of the target bolt that was detected. For example, multiple machine learning models can be trained to detect outliers for different types of bolt coatings using the method of FIG. 19.

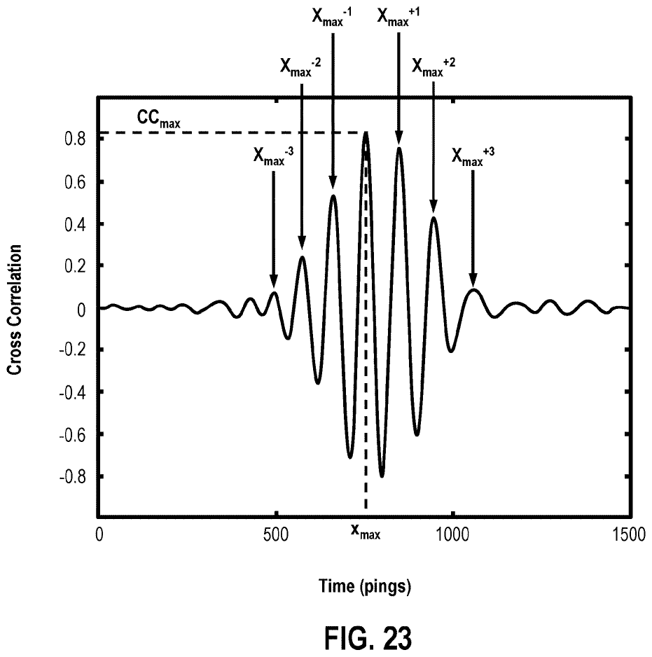

At step 2108, the input dataset can be provided to the second machine learning model selected at step 2106. The second machine learning model can detect whether there are any outliers in the input data set. Outliers are data points that vary from the main linear regression band for stress predictions, which are typically multiples of one wave period. For example, FIG. 22 is a graph diagram illustrating an example main band of a linear regression model and outliers. At step 2110, if outliers are detected in the input dataset, the analysis based on that dataset may not be accurate. Thus, the method can be repeated beginning at step 2102 by collecting a new dataset from the target bolt. (Before a new set of data is collected, the user might also replace the transducer, adjust the pressure on the transducer, or adjust the couplant to help prevent or limit the existence of outliers.)

If outliers are not detected at step 2110, at step 2112, a third machine learning model trained on stress can be selected based on the coating of the target bolt that was detected. For example, multiple machine learning models can be trained on stress using the method of FIG. 20.

At step 2114, the input dataset can be provided to the third machine learning model selected at step 2112 and used to predict the stress/tension in the target bolt. The method of FIG. 21 can be repeated for other target bolts on the structure under audit. In this way, the inventive systems and methods can be used to rapidly and very accurately determine the residual tension/stress in numerous (e.g., hundreds or thousands) target bolts merely by measuring the UT response of the bolt.

### Detecting and Adjusting Shifted ToFs

The maximum-amplitude peak in the cross correlation function is typically the peak that produces a ToF that correlates well with the stress level in a bolt. The correlation between the speed of longitudinal and shear waves in the bolt and the tension in the bolt can be challenging to determine, however, because the wave speeds are relatively insensitive to stress, thereby requiring a high degree of accuracy in the calculations. Also, a number of factors can create subtle differences in the UT signals, such as transducer position and pressure (particularly the geometry of the bolt), heat treatment, coating, imperfections, and others. Due to these factors and the nature of using the cross correlation function to determine the ToF, the ToF may shift by some multiple of a period, where the period is a function of the signal frequency. This is known as the cycle-skip problem. As a result, the greatest peak in the cross correlation function may not correspond to the correct ToF, and the peak corresponding to the correct ToF may have an amplitude that is less than the maximum-amplitude of the cross correlation function. Signal processing that involves detecting a maximum-amplitude peak in the cross correlation function to compute the ToF may therefore result in inaccurate analyses.

In the method of FIG. 21, this potential inaccuracy is cared for by detecting outliers in the data (step 2108). When outliers (shifted ToFs) are detected (step 2108), the data is not used and the method is repeated by collecting a new set of data from the target bolt.

One alternative to detecting outliers and obtaining new data when one is found is to detect that the ToF is shifted, adjust it accordingly, and then use the adjusted ToF instead of collecting new data. Adjusting a shifted ToF provides the machine learning model with an opportunity to produce predictions even when the post-processor has produced one or more shifted ToFs. One key benefit of detecting and adjusting shifted ToFs is that less data is needed, making the prediction analysis more efficient. Also, there are times and/or conditions when a bolt produces shifted ToFs regardless of what the field operator tries. With a detect-and-adjust method, a shifted ToF can be used instead of disregarding the data.

As explained elsewhere herein, the ToF of a signal can be determined from the cross-correlation of two echoes. That is, the ToF can be determined by identifying the maximum amplitude peak in the cross-correlation function, CCₘₐₓ (FIG. 8), and converting its corresponding time stamp, xₘₐₓ (FIG. 8), to a ToF using equation (1). However, when the maximum-amplitude peak in an echo is actually a shifted ToF, equation (1) may result in an incorrect ToF.

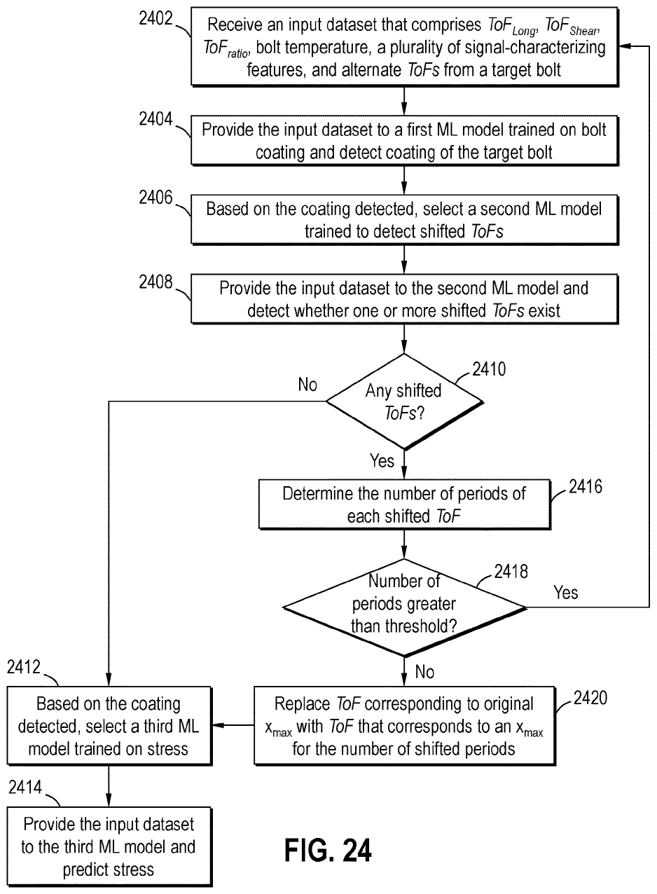

FIG. 23 is a graph diagram illustrating an example cross correlation of two echoes. Suppose that xₘₐₓ illustrated in FIG. 23 is based on a ToF shifted by one multiple of a period. In that case, although CCₘₐₓ corresponds to xₘₐₓ, the ToF derived therefrom will not be correct. Instead, it is possible that xₘₐₓ⁺¹, which corresponds to an amplitude less than CCₘₐₓ and a shift in xₘₐₓ by one period (thus, “+1”), may correlate better to the stress level being determined. However, because xₘₐₓ⁺¹ does not correspond to CCₘₐₓ, it will not be identified using an algorithm that is based on CCₘₐₓ because it does not correspond to the maximum-amplitude peak.

To account for this, a method can be employed that identifies the ToF as shifted and by how many peaks (e.g., periods) it is shifted. For example, a shifted ToF can be detected by comparing the calculated ToF with an expected ToF for the specific bolt length at an applied load level. The ToF can then be assigned an integer value to indicate by how many periods it is shifted. For example, a value of 0 can indicate that the ToF identified is the correct ToF. A value of −4, −3, −2, and −1 can indicate that the ToF is shifted by 4, 3, 2, and 1 periods before the maximum-amplitude peak, respectively. A value of +4, +3, +2, and +1 can indicate that the ToF is shifted by 4, 3, 2, and 1 periods after the maximum-amplitude peak, respectively.

Once the shifted ToF and the amount of shift is identified, the method can adjust the ToF associated with the “correct” xₘₐₓ. This can be achieved by providing the machine learning model with alternative ToFs in the event a shifted ToF is detected. For example, the post-processor can provide the machine learning model with input data that includes 1, 2, 3, 4, 5, or other integer values that correspond to the number of peaks before and after the maximum-amplitude peak. For example, in some embodiments, the post-processor provides the machine learning model with 6 alternate ToFs—three that correspond to peaks before the maximum-amplitude peak and three that correspond to peaks after the maximum-amplitude peak. In FIG. 23, timestamps corresponding to these alternate ToFs are labeled xₘₐₓ⁻¹, xₘₐₓ⁻², xₘₐₓ⁻³ and xₘₐₓ⁺¹, xₘₐₓ⁺², xₘₐₓ⁺³, respectively. Thus, after the machine learning model detects a shifted ToF, it can switch from the original ToF (based on CCₘₐₓ and xₘₐₓ) to the alternate ToF that corresponds to how many periods off the model determined the ToF to be. If the shifted ToF is predicted by the machine learning model to be more than the number of alternates provided in either direction, the data can be disregarded.

For example, suppose that the machine learning model determines that the ToF for longitudinal waves is accurate (not shifted), but that the ToF for shear waves is shifted by two periods too high. In that case, the machine learning model can adjust the ToF for shear waves by switching the original ToF with the ToF associated with xₘₐₓ⁺². The UT response (i.e., ToFᵣₐₜᵢₒ) can then be determined by using xₘₐₓ for longitudinal waves and xₘₐₓ⁺² for shear waves.

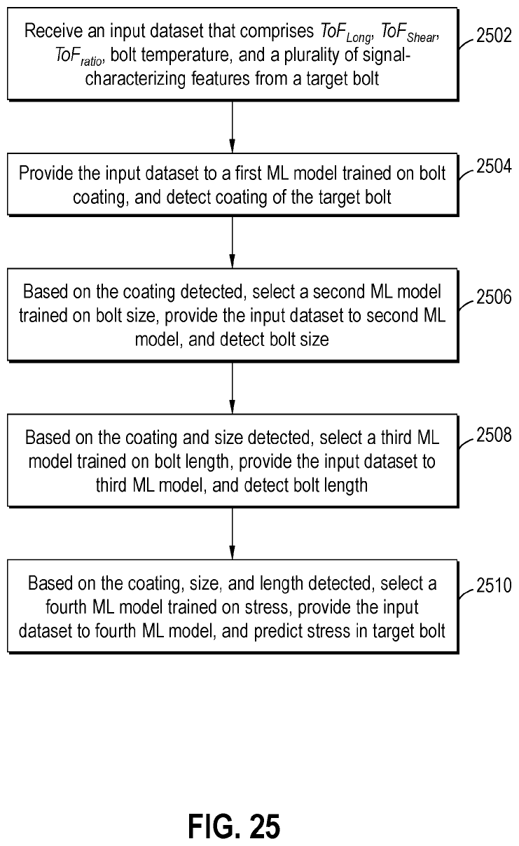

FIG. 24 is a flow diagram illustrating an example method for using machine learning models to determine stress of a target bolt. The method can be implemented using the systems and methods disclosed herein.

At step 2402, an input dataset can be received. The input dataset can comprise ToF_{Long}, ToF_{Shear}, ToFᵣₐₜᵢₒ, bolt temperature, a plurality of signal-characterizing features, and alternate ToFs from a target bolt.

At step 2404, the input dataset can be provided to a first machine learning model that has been trained on bolt coating. The first machine learning model can be trained using the method of FIG. 16, for example. Using the input dataset, the first machine learning model can detect the coating of the target bolt.

At step 2406, a second machine learning model that has been trained to detect shifted ToFs can be selected based on the coating of the target bolt that was detected. The second machine learning model can be a multi-class classification model that can detect whether a ToF is shifted, and if so, by how many wave periods. For example, in some embodiments, up to three wave-period shifts are detected. In these embodiments, the classifier prediction can take one of seven values: −3 if a shifted ToF is detected that is three wave periods low, −2 if a shifted ToF is detected that is two wave periods low, −1 if a shifted ToF is detected that is one wave period low, 0 if no shifted ToFs are detected, 1 if a shifted ToF is detected that is one wave period high, 2 if a shifted ToF is detected that is two wave periods high, and 3 if a shifted ToF is detected that is three periods high. Several multi-class classification models can be trained, each for a different bolt coating. Thus, at step 2406, the second machine learning model can be selected based on the coating of the target bolt.

If shifted ToFs are not detected at step 2410, the method of FIG. 24 proceeds to step 2412 and selects a third machine learning model, which is trained on stress, based on the coating of the target bolt detected. At step 2414, the input dataset is provided to the third machine learning model selected and a stress/tension prediction is made based on the third machine learning model and the input dataset.

However, if it is determined at step 2410 that one or more shifted ToFs are present in the input dataset, the second machine learning model can determine the number of periods of each shifted ToF at step 2416. At step 2418, if the number of periods is greater than a certain threshold (e.g., 3 periods), the method can be repeated beginning at step 2402 by receiving a new input dataset from the target bolt.

If, at step 2418, it is determined that the number of periods is less than the threshold, at step 2420, the ToF corresponding to the original xₘₐₓ for the shifted ToF can be replaced by an alternate ToF that corresponds to an xₘₐₓ for the number of shifted periods. The method can proceed to step 2412, where a third machine learning model, which is trained on stress, can be selected based on the coating of the target bolt that was detected. At step 2414, the input dataset is provided to the third machine learning model selected and a stress/tension prediction is made based on the third machine learning model and the input dataset.

The method of FIG. 24 could be modified to include another machine learning model that detects the size of the bolt. For example, in some applications, the method of FIG. 24 could be used in an environment in which the sizes of the bolts being investigated are known. In such an environment, there may be no need to detect the size of target bolts and the method of FIG. 24 can be applied. On the other hand, the sizes of target bolts may not be known, or they may vary in size. In that case, an additional step can be added to the method of FIG. 24 so that a machine learning model, which is trained on bolt size, is also included.

### One-Shot Method

An alternative to detecting outliers as in the method of FIG. 21, or detecting and adjusting shifted ToFs as in the method of FIG. 24, is to train multiple stress prediction models for different combinations of bolt sizes and nominal bolt lengths. For example, the method of FIG. 17 can be used to train a machine learning model based on bolt size, while the method of FIG. 18 can be used to train a machine learning model based on bolt length. Additionally, separate machine learning models can be trained to predict stress (e.g., using the method of FIG. 20) for different combinations of bolt sizes and bolt lengths. The proper stress prediction model can then be selected once the size and nominal length of the target bolt has been detected.

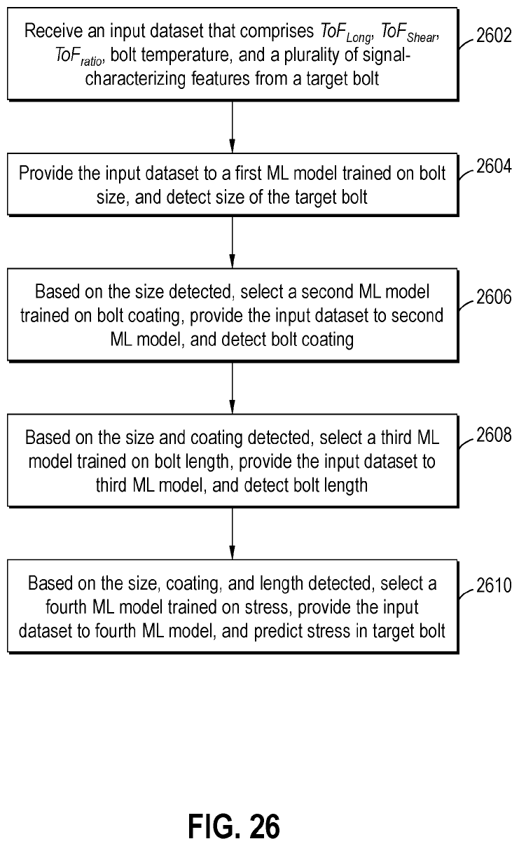

FIG. 25 is a flow diagram illustrating an example method for using machine learning models to determine stress of a target bolt. The method can be implemented using the systems and methods disclosed herein.

Steps 2502 and 2504 of FIG. 25 are the same as steps 2102 and 2104 of FIG. 21. For convenience and brevity, the details of steps 2502 and 2504 are not repeated here, and reference is instead made to steps 2102 and 2104 of FIG. 21 for those details.

At step 2506, a second machine learning model that has been trained on bolt size can be selected based on the coating detected from the target bolt. The input dataset can be provided to the second machine learning model and the size of the target bolt can be detected.

At step 2508, a third machine learning model that has been trained on nominal bolt lengths can be selected based on the coating and size of the target bolt that were detected. For example, multiple machine learning models can be trained for different combinations of bolt sizes and bolt coatings.

At step 2510, a fourth machine learning model that has been trained on stress can be selected based on the combination of coating, size, and length of the target bolt that has been detected. For example, multiple machine learning models can be trained for different combinations of these characteristics. Once the correct fourth machine learning model has been selected, the input dataset can be provided to the model and the stress/tension of the target bolt can be predicted.

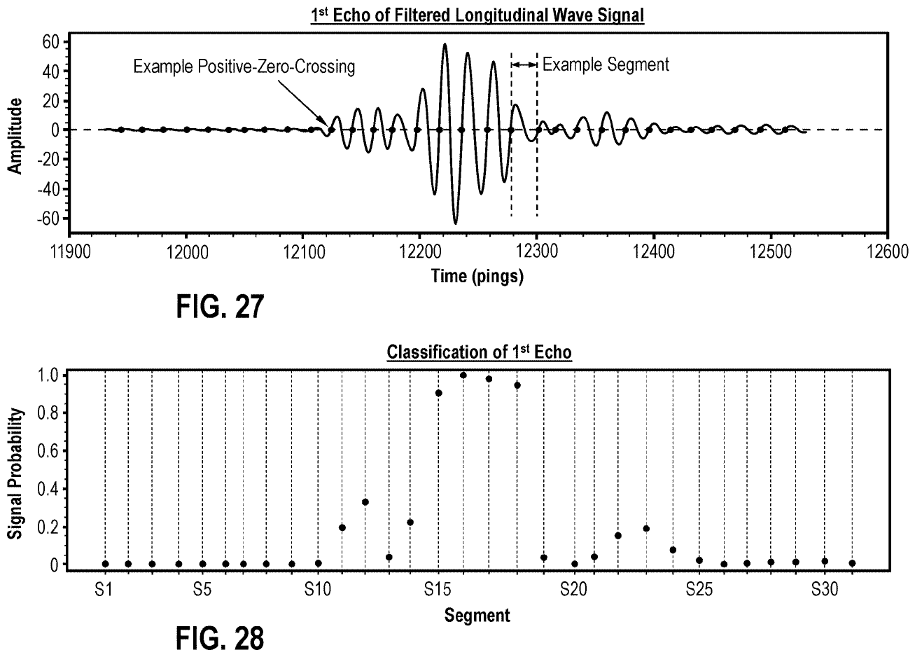

One alternative to flow of the method of FIG. 25 is to first detect bolt size, and then detect bolt coating. This alternative method is provided in FIG. 26. FIG. 26 is a flow diagram illustrating an example method for using a machine learning model to determine stress of a target bolt. The method can be implemented using the systems and methods disclosed herein.

### Ultrasonic Signal Onset (USO) and Ultrasonic Signal End (USE)

Cross-correlation is an effective way to calculate a ToF from data relating to ultrasonic shear and longitudinal waves. In particular, the flexible-window algorithm can produce highly accurate calculations for ToFs. Machine learning models can also be used to confirm calculated ToFs or to calculate ToFs.

As explained above, calculating a ToF can prove challenging sometimes due to the cycle-skip problem, which is a phenomenon in which the error between the estimated and the actual ToFs equals a multiple of the signal period. Cycle-skips are caused mainly by waveform changes, energy attenuation, and noise pollution. One way to address the cycle-skip problem is to use the detect-and-adjust method explained above. Another way is to use ultrasonic signal onset (USO) and ultrasonic signal end (USE), which is now explained.

The overall method comprises three main parts. First, a rough position for USO and USE are determined for a signal. This can be achieved by dividing the received signal into segments and classifying each segment as either an ultrasonic signal or as a noise signal. The USO and USE can be determined by analyzing the results from the classification. Second, a ToF is determined by analyzing multiple-zero-crossings and using a time value for a fixed positive zero-crossing. Because only information inside each segment is used in the classification process, the method is insensitive to waveform changes. Further, by including frequency in the analysis, the method is undisturbed by noises whose frequency is different from the ultrasonic frequency. Third, the parameters that impact the determination of USO and USE and the selection of positive zero-crossing time values are optimized. This can be achieved by using an optimization algorithm, such as Genetic Algorithm or Bayesian optimization. More information on USO and multiple-zero-crossings can be found in Fang et al., “A simple and easy-implemented time-of-flight determination method for liquid ultrasonic flow meters based on ultrasonic signal onset detection and multiple-zero-crossing technique,” MEASUREMENT 168 (2021) 108398, the disclosure of which is incorporated herein by reference in its entirety.

### (i) Determining Rough Positions of USO and USE

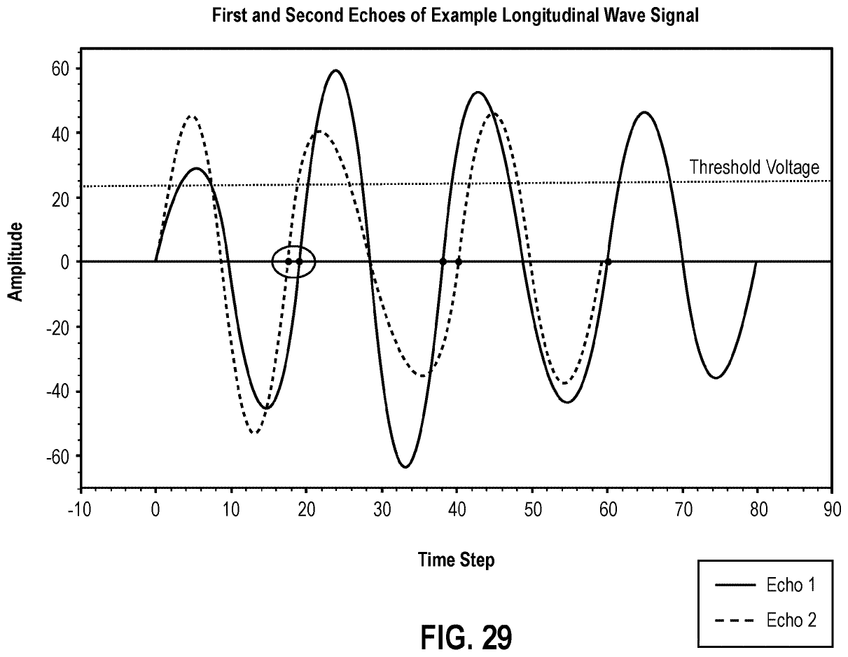

The steps explained below can be applied to both longitudinal and shear wave signals. For convenience, they are described in connection with an example longitudinal wave signal. An advantageous first step in determining rough positions of USO and USE is to filter the received signal to remove unwanted noise. For example, an FIR band-pass filter or an IIR band-pass filter can be used. From the filtered signal, the first two consecutive echoes can be extracted. Each echo can then be divided into segments according to positive-zero-crossings with linear interpolation. A positive-zero-crossing is a point on the received signal where the amplitude changes from negative to positive and crosses zero. For example, FIG. 27 is a graph diagram illustrating the first echo of an example filtered longitudinal wave signal. Each positive-zero-crossing is indicated by a black circle on line where amplitude equals zero. The segments extend from each black circle until one ping before the next black circle, an example of which is illustrated in FIG. 27. In some cases, the positive-zero-crossing may not line up with an integer value on the x-axis, which in the case of FIG. 27 is measured in units of pings. For example, a positive-zero-crossing may occur between 12301 and 12302 pings, such as around 12301.4 pings. In such cases, the value of pings for the positive-zero-crossing can be estimated, such as with linear interpolation between the two values.

Each segment can be classified as either part of an ultrasonic signal or part of a noise signal by analyzing the frequency and energy content in each segment. The frequency content can be characterized by the number of points in the signal segment. For example, suppose that a transducer generates a signal at exactly 5 MHz, which is sampled at exactly 100 MHz. If no noise is present in the signal (i.e., idealized), each segment would contain exactly 20 pings (i.e., 100 MHz/5 MHz), which is one full period of the signal. When noise is present, however, the number of pings in some segments will likely deviate from 20 and the positive-zero-crossings will shift. Thus, one might conclude that, unless a segment has exactly 20 pings in this hypothetical example, that segment is part of a noise signal. However, any time instruments are involved, idealized frequencies are hardly ever achieved. For example, a transducer rated for 5 MHz might generate a signal that varies by some amount centered on the rated frequency. This variation can be accounted for so that a segment is not misclassified by specifying an acceptable tolerance level for what is considered a noise signal or an ultrasonic signal. For example, suppose a 5 MHz transducer actually generates a signal that varies from 4.5 MHz to 5.5 MHz (i.e., +/−10% of the rated frequency). In this case, segments that range from approximately 18 pings to 22 pings are likely ultrasonic signals rather than noise signals. Fang et al. refers to the acceptable tolerance as a shift factor α (alpha). Thus, when analyzing a segment for frequency content, values below 18 pings might be classified as a noise signal, values between 18 to 22 pings might be classified as an ultrasonic signal, and values above 22 pings might be classified as a noise signal.

However, frequency is not the only metric by which the segments are classified—the energy content in each segment is also considered. Therefore, to simplify calculations, it is helpful to normalize both the frequency and energy content of each segment. Fang et al. explains that frequency can be normalized with the following transformation:

$$f 1 = \{ \begin{matrix}{e}^{n - \frac{fs}{f} + α} , & n < [ \frac{fs}{f} ] - α \\ 1 , & [ \frac{fs}{f} ] - α \leq n \leq [ \frac{fs}{f} ] + α \\ {e}^{\frac{fs}{f} + α - n} , & n > [ \frac{fs}{f} ] + α\end{matrix}$$

where n is the number of discrete points in the signal segment (e.g., pings), f is the rated frequency of the transducer, fₛ is the sampling frequency, a is a shift factor, and the brackets indicate rounding the number to the nearest integer value.

Similarly, the energy content in each segment can be normalized with the following transformation:

$$f 2 = 1 - {e}^{( - β * E )}$$

where β (beta) is a scaling factor and E is the energy in the signal segment. For a signal segment with n discrete sampling points, E can be calculated as:

$$E = \frac{{\sum }_{k = 1}^{n} {v}_{k}^{2}}{n}$$

where vₖ represents the voltage of the k^{th} discrete sampling point.

With the frequency and energy content of each segment normalized, a probability that the analyzed signal segment belongs to the ultrasonic signal can be calculated by multiplying the normalized frequency and the normalized energy:

$${Probability}_{( signal )} = {f}_{1} \times {f}_{2}$$

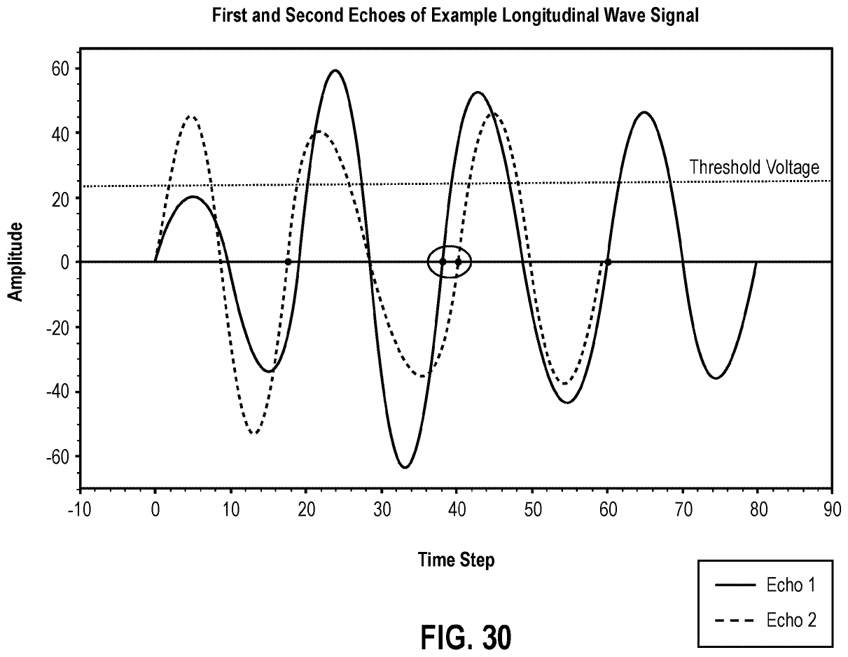

FIG. 28 is a graph diagram illustrating the classification of each segment of the example signal of FIG. 27. As illustrated in FIG. 28, the probability that a segment is part of the ultrasonic signal will tend toward 1 while the probability that the segment is part of the noise signal will keep away from 1. That is, when the product of the normalized frequency and the normalized energy is close to 1, the segment likely contains the ultrasonic signal, whereas when the product of the normalized frequency and the normalized energy is closer to 0, the segment likely contains the noise signal.

From FIG. 28, it is apparent where the probabilities diverge. For example, segments S1 to S14 and S19 to S31 are part of the noise signal whereas segments S15 to S18 are part of the ultrasonic signal. The amount of divergence illustrated in FIG. 28 may not always be the case, making it more challenging to determine what threshold probability should be used to determine whether a segment is noise or an ultrasonic signal. Fang et al. proposes that upper and lower thresholds (L1 and L2) can be established, from which an average can be determined (L) to delineate which segments are part of the noise signal and which segments are part of the ultrasonic signal.

However, an alternative to establishing thresholds is to use machine learning. For example, a k-means algorithm can be used, which is an unsupervised clustering algorithm that partitions n data points into k clusters. Here, there would be two clusters: noise or ultrasonic. The algorithm can thus identify which cluster each segment belongs to even when the divergence between probabilities of noise versus ultrasonic is not easily determined. Once the clusters are established, the rough USO can be determined as the first segment in the ultrasonic signal cluster. In FIG. 28, the rough USO is at segment S15. The rough USE can be determined as the time value that precedes the first data point in the noise signal subsequent to the ultrasonic signal. In FIG. 28, the noise signal begins again at segment S19. Thus, the rough USE is the last ping of segment S18 (or stated differently, one ping that precedes segment S19). The same procedure can be applied to determine a rough USO and rough USE for the second echo of the filtered longitudinal wave signal.

### (ii) Determining Accurate ToF Using Multiple-Zero-Crossings and USO and USE

In some embodiments, the rough USOs for the first and second echoes may be sufficient to calculate a ToF. For example, the time value of the rough USO for the first echo can be subtracted from the time value of the rough USO for the second echo. Since the rough USOs indicate the approximate beginning of the ultrasonic signal for each echo, the difference should be very close to the actual ToF of the signal.

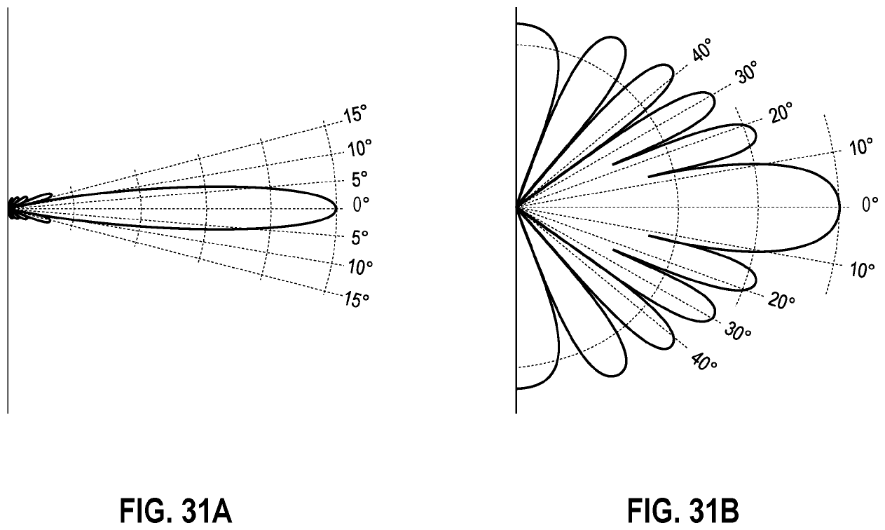

For greater accuracy in calculating a ToF, the rough USOs can be used as reference points in time. For example, the signal parts of the first and second echoes can be overlaid so that they both begin at the same point, say time t₀=0. (The signal part of each echo is USO to USE.) FIG. 29 is a graph diagram illustrating signal parts of first and second echoes of an example longitudinal wave signal. A threshold voltage can be established to ensure that the signal parts calculated for each echo did not inadvertently include a noise signal. For example, a threshold voltage can be set to, e.g., 40% of the peak amplitude of the signal. In FIG. 29, the peak amplitude is approximately 60, and so the threshold voltage is set to about 24.

For each echo, the positive-zero-crossing time values that come after the first intersection of the echo and the threshold voltage can be identified. In FIG. 29, the positive-zero-crossings for each echo are illustrated with black circles. To calculate a ToF, a pair of relative positive-zero-crossing time values from the first and second echoes that are closest to each other (presuming their preceding peaks were above the threshold) can be identified, which occurs at around t=20 in FIG. 29 (indicated by the oval). The time difference between these two positive-zero-crossing time values in the original signal is equal to the ToF of the signal under consideration. This can be calculated as t_{p-z-c (echo 2)}−t_{p-z-c (echo 1)}. That is, the positive-zero-crossing identified for the first echo can be translated to the actual time value in the original signal using the rough USO as a reference point. Similarly, the positive-zero-crossing identified for the second echo can be translated to the actual time value in the original signal using the rough USO as a reference point. The ToF can be calculated as the actual time value for the second echo minus the actual time value for the first echo.

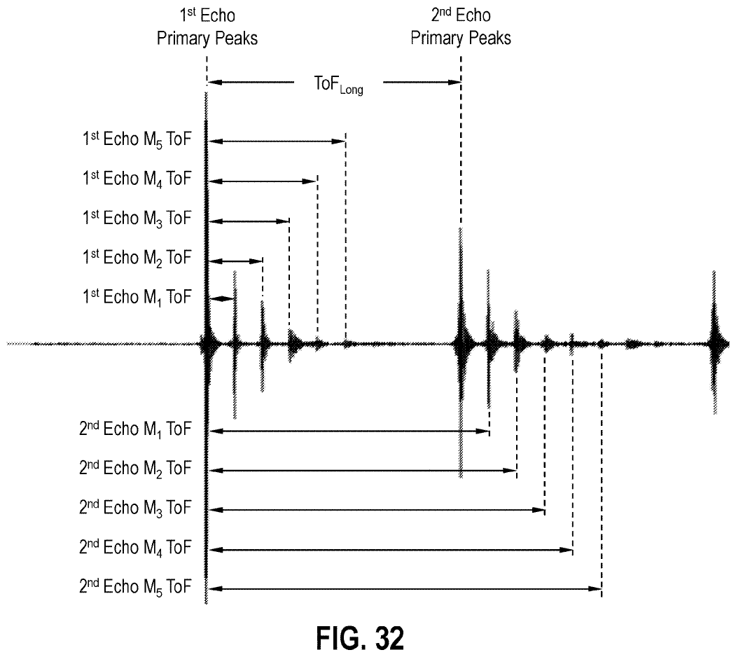

FIG. 30 is a graph diagram illustrating signal parts of first and second echoes of an example longitudinal wave. In FIG. 30, the first peak of echo 1 following the rough USO point does not exceed the threshold voltage. That might indicate that a portion of the first echo that was determined to be the ultrasonic signal was in fact noise. Thus, the first positive-zero-crossing of echo 1 after an amplitude of echo 1 that passes the threshold occurs at around t=40. Accordingly, the closest positive-zero-crossings are identified at around t=40 (indicated by the oval). The corresponding time values can be translated to the original signal using the rough USOs as a reference point, and the difference is the ToF.

(iii) Finding Optimal Values for the Parameters α and β

Optimal values for α and β for each type of signal (i.e., longitudinal and shear) and for each echo of the signals should be determined when applying the USO/USE technique for predicting bolt tension. This can accomplished, for example, using Bayesian Optimization or Genetic Algorithm Optimization. Such optimization algorithms can be used to find an optimal (or near-optimal) combination of these parameters, each chosen from a set of alternatives to maximize (or minimize) the objective functions.

There are two primary objectives for optimization: (1) to minimize the mean square error of a regression line fitted to the ToFᵣₐₜᵢₒ (e.g., ToF_{Shear}/ToF_{Long}), and (2) to minimize the cull rate of what is considered bad data (or minimize the number of discarded signals). The optimization can be performed on a set of longitudinal wave and shear wave signals collected from a plurality of test bolts at a plurality of known levels of tension using, e.g., the LPGO cross-validation method explained above. In this way, the machine learning model with optimized parameters will generalize well on future unseen data collected on new bolts.

The USO/USE method explained above can be used when collecting training data to train a machine learning model to predict stress/residual tension. That is, the method can be employed on all collected signals (and all echoes in those signals) for all test bolts at all known levels of tension. The method can also be used when collecting raw data from test events on target bolts. As explained above, the method can be used to determine a ToF for each type of signal, as well as a check to confirm the accuracy of ToFs calculated by other means. Additionally, the USO and USE values calculated in the method can be used to establish windows when performing cross-correlation to find a ToF. For example, as explained above, the flexible-window algorithm is an effective way to accurately calculate a ToF. However, the algorithm involves many computations to find an appropriate starting point and end point for the windows. As an alternative, the USO can be used as a starting point for a window, and the USE can be used as the end point for the window. With the starting point and end point determined, portions of the echoes falling within the windows can be cross-correlated to find a ToF.

One variation on the USO/USE method described above is to use a proportional voltage threshold to select positive-zero-crossings in each echo instead of setting the threshold to a fixed value (e.g., 40% of peak amplitude). In this way, the threshold value can be calculated according to the peak value of the ultrasonic echo signal, rather than as a percentage of the overall amplitude of the signal.

Another variation is to invert the second echo by multiplying the amplitudes by −1, then comparing the similarity of the signal parts of the two echoes in (1) the original format, and (2) the inverted second echo format using cross-correlation. The scenario that results in the higher peak in the cross-correlation function can be used for ToF estimation by the methods described herein.

Another variation is to use an algorithm, such as the k-means clustering algorithm, to find α and β for each individual signal/echo in such a way that divides the raw frequency and raw energy of the echo into three and two clusters, respectively (i.e., based on the normalizing calculations explained above). For example, it is possible that there will not be one single set of model parameters (e.g., α1, α2, β1, β2) that generalizes on all signals collected on test bolts at different tension levels. That is because the signals may vary enough in shape such that it may be challenging to find an optimal set of parameters that results in a correct ToF.

### Using Higher Order Modes

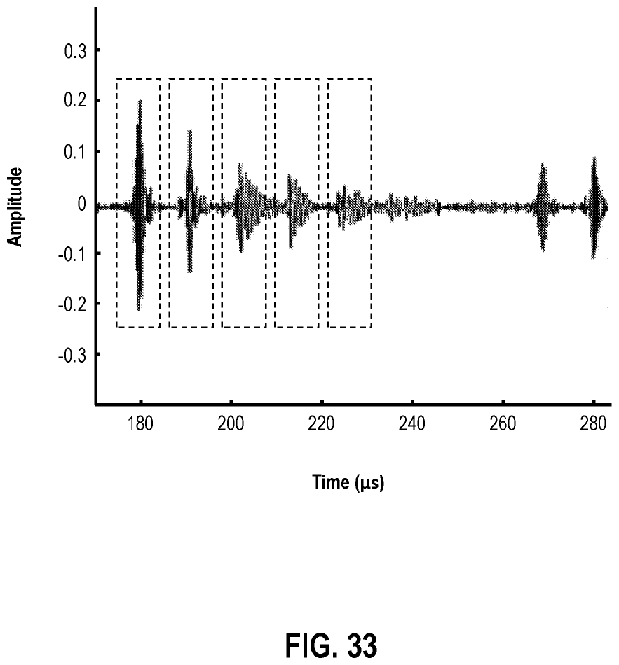

The embodiments described herein can take advantage of higher order modes of longitudinal waves to improve accuracy, increase confidence in predictions, and reduce cull rates for more efficient performance. When a longitudinal wave is transmitted in a bolt, it will include a direct wave, which propagates in a direction parallel to the longitudinal axis of the bolt (i.e., at 0° to the axis), and higher order modes, which are portions of the wave transmitted at increasing angles relative to the longitudinal axis of the bolt. For example, FIGS. 31A and 31B are graph diagrams illustrating 2-dimensional beam patterns for longitudinal waves. Both beam patterns include a main lobe, or direct wave, that is emitted at 0° and side lobes, or modals, that are emitted at increasing angles on either side of the direct wave. The extent to which the direct wave is dominant depends on several factors, including the frequency of the transducer and the size of the active element. For example, the beam pattern illustrated in FIG. 31A has a much larger direct wave (i.e., more energy) relative to the modals in FIG. 31A than the direct wave in FIG. 31B relative to the modals in FIG. 31B.

Direct waves travel in a direction parallel to the longitudinal axis of the bolt and reflect back from the distal end of the bolt, while the higher order mode waves will reflect off the side walls of the bolt. When those reflections occur, the mode of the wave changes from longitudinal to shear, and vice versa. Thus, a longitudinal wave transmitted in a bolt also contains information about shear waves due to mode conversion. The reflection paths of the higher order mode waves follow Snell's law. Because the angle from 0° increases with increasing mode, the number of reflections of the mode from the side wall also increases. The higher the mode, the more reflections will occur and the longer it will spend in shear mode. The increased travel length combined with the increased time spent in shear mode causes the higher order modes to arrive later in time at the transducer than the direct wave. In FIG. 12, for example, the first modal of the first echo is identified as a first set of secondary peaks.

The relationship between the direct wave and the higher order mode waves of each echo can be used to increase the reliability of ToF measurements. This can be achieved, for example, by determining a ToF for each modal of longitudinal waves (and the direct longitudinal and shear waves) and using ratios of the various ToFs calculated. This is now explained in more detail.

### (i) Calculating Modal ToFs and Ratios Thereof

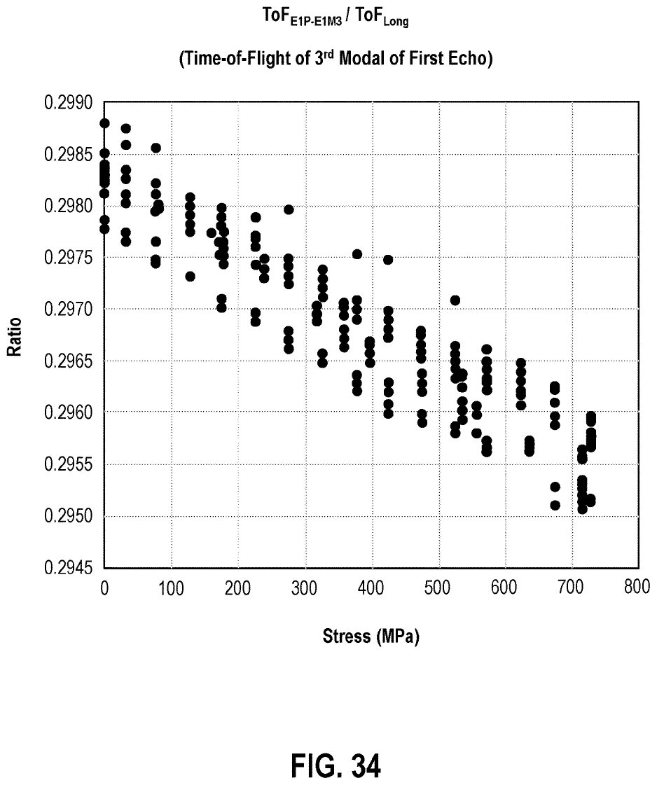

A ToF for a modal is a measurement of time taken from the initial excitation that generated the wave to that modal set of peaks in the first echo. Such ToFs can be measured during each test event and used in the embodiments herein. In practice, however, the initial excitation is often clipped and too noisy to use. Thus, in some embodiments, true modal ToFs can be replaced by the difference in time between the modes and the primary peak of the first echo. For example, FIG. 32 is a graph diagram illustrating ten such measurements for a longitudinal wave signal. Although not true “modal ToFs,” they are referred to herein as such.

Modal ToFs can be calculated by cross correlating each modal with the first echo primary of the signal. For example, the flexible window algorithm described in connection with the method of FIG. 9 can be appropriately adapted for modal waves to perform the cross correlations. Alternatively, a rigid window can be established to identify the locations of the modals, and once found, the modals can be cross correlated with the echo primary. These locations can be identified in different ways. For example, because the location of modal peaks is a function of bolt dimensions, and if the bolt dimensions are known (e.g., using nominal values, predicted by a machine learning model, etc.), the location of the modal peaks can be identified accordingly and the windows can be appropriately established. In cases where bolt dimensions are not known, the location of the modal peaks can be identified by searching the portion of the signal after the echo primary and running an appropriate function to determine the time location of each modal peak.

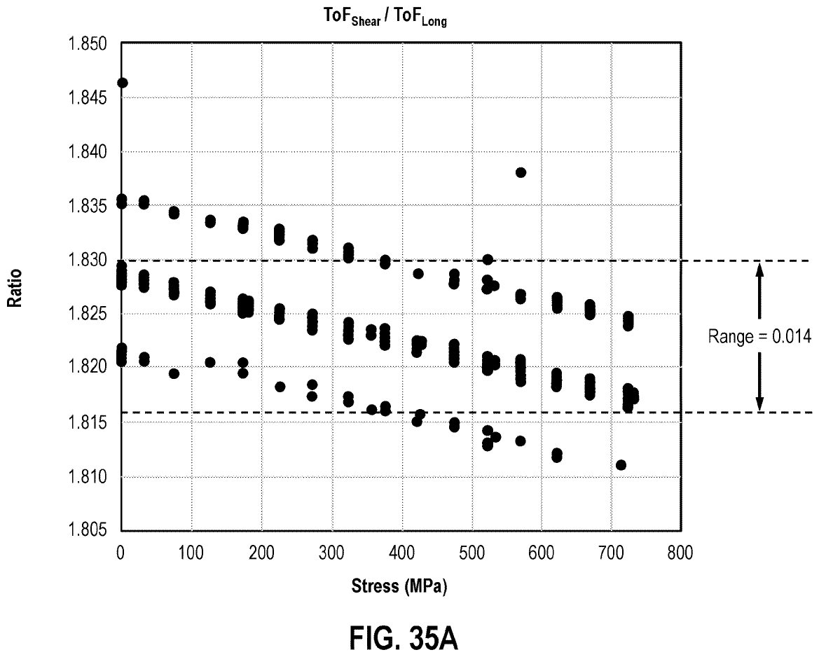

With locations of the modal peaks identified, cross correlation can be used to calculate the modal ToFs. For example, windows sufficiently sized to capture each set of peaks in the first echo can be established. In some embodiments, this is achieved by setting the beginning of each window to a location that precedes the location of each set of peaks, such as 100 pings, 200 pings, 300 pings, and so on, and setting the end of each window to a location that sufficiently captures the set of peaks, such as 300 pings, 400 pings, 500 pings, and so on, after the peaks. In other embodiments, the windows can be centered over the maximum peaks and set to approximately the modal peak spacing. FIG. 33 is a graph diagram illustrating windows around each set of peaks in the first echo. The same procedure can be used to establish windows around the modal peaks in the second echo, third echo, and so forth.

With the windows established, each pair can be used to calculate different ToFs, including modal-to-modal ToFs. For example, the first echo primary can be cross correlated with each modal in the first echo, with each modal in the second echo, with each modal in the third echo, and so on. (The cross correlation of the first echo primary and the second echo primary is simply the ToF of the longitudinal wave.) Similarly, the first modal of the first echo can be cross correlated with the second modal of the first echo, the third modal of the first echo, the fourth modal of the first echo, and so on. This procedure can be repeated for each modal, giving rise to numerous different ToF measurements. Table 2 includes a non-exhaustive list of ToF measurements and shorthand descriptors that will be used in this disclosure:

TABLE 2

| No. | ToF Measurement of | Shorthand |
|---|---|---|
| 1 | Longitudinal waves | ToF_{Long} |
| 2 | Shear waves | ToF_{Shear} |
| 3 | First echo primary to first modal of first echo | ToF_{E1P-E1M1} |
| 4 | First echo primary to second modal of first echo | ToF_{E1P-E1M2} |
| 5 | First echo primary to third modal of first echo | ToF_{E1P-E1M3} |
| 6 | First echo primary to fourth modal of first echo | ToF_{E1P-E1M4} |
| 7 | First echo primary to fifth modal of first echo | ToF_{E1P-E1M5} |
| 8 | First echo primary to first modal of second echo | ToF_{E1P-E2M1} |
| 9 | First echo primary to second modal of second | ToF_{E1P-E2M2} |
| | echo | |
| 10 | First echo primary to third modal of second echo | ToF_{E1P-E2M3} |
| 11 | First echo primary to fourth modal of second echo | ToF_{E1P-E2M4} |
| 12 | First echo primary to fifth modal of second echo | ToF_{E1P-E2M5} |
| 13 | First modal of first echo to second modal of first | ToF_{E1M1-E1M2} |
| | echo | |
| 14 | First modal of second ccho to second modal | ToF_{E2M1-E2M2} |
| | of second ccho | |

Of course, many other ToF measurements can be calculated and used in the embodiments herein. For example, most of the ToF measurements listed in Table 2 are referenced from the first echo primary, but the second echo primary, third echo primary, and so on, can also be used. As another example, Table 2 lists modals only up to the fifth mode, but higher order modes can also be used. Thus, the ToF measurements can be based on permutations of different echoes and different modal waves within each echo.

Several ratios can be constructed based on the various ToF measurements as shown in Table 3:

TABLE 3

| No. | Ratios of ToF Measurements |
|---|---|
| 1 | ToF_{E1P-E1M1}/ToF_{Long} |
| 2 | ToF_{E1P-E1M2}/ToF_{Long} |
| 3 | ToF_{E1P-E1M3}/ToF_{Long} |
| 4 | ToF_{E1P-E1M4}/ToF_{Long} |
| 5 | ToF_{E1P-E1M5}/ToF_{Long} |
| 6 | ToF_{E1P-E2M1}/ToF_{Long} |
| 7 | ToF_{E1P-E2M2}/ToF_{Long} |
| 8 | ToF_{E1P-E2M3}/ToF_{Long} |
| 9 | ToF_{E1P-E2M4}/ToF_{Long} |
| 10 | ToF_{E1P-E2M5}/ToF_{Long} |
| 11 | ToF_{E1P-E1M1}/ToF_{Shear} |
| 12 | ToF_{E1P-E1M2}/ToF_{Shear} |
| 13 | ToF_{E1P-E1M3}/ToF_{Shear} |
| 14 | ToF_{E1P-E1M4}/ToF_{Shear} |
| 15 | ToF_{E1P-E1M5}/ToF_{Shear} |
| 16 | ToF_{Shear}/ToF_{E1P-E2M1} |
| 17 | ToF_{Shear}/ToF_{E1P-E2M2} |
| 18 | ToF_{Shear}/ToF_{E1P-E2M3} |
| 19 | ToF_{Shear}/ToF_{E1P-E2M4} |
| 20 | ToF_{Shear}/ToF_{E1P-E2M5} |
| 21 | ToF_{E1M1-E1M2}/ToF_{Long} |
| 22 | ToF_{E1M1-E1M2}/ToF_{Shear} |
| 23 | ToF_{E2M1-E2M2}/ToF_{Long} |
| 24 | ToF_{E2M1-E2M2}/ToF_{Shear} |

When the ratios in Table 3 are plotted as a function of increasing stress, the ratios will exhibit a downward trend, such as that shown in FIG. 22. That is the reason why ToF_{Shear} is in the numerator in ratios 16-20—so that the ratios 16-20 exhibit a downward trend consistent with the other ratios.

### (ii) Using Modal Ratios

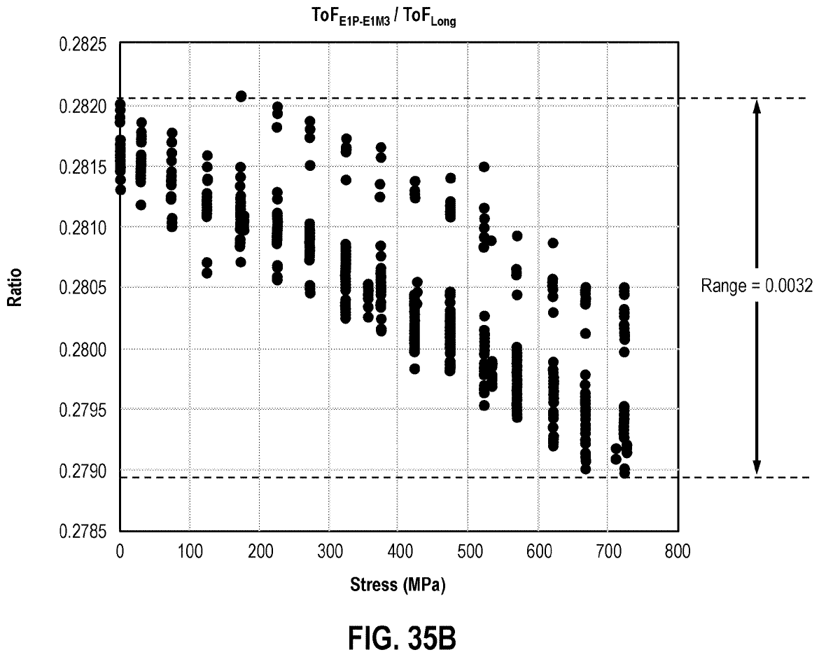

Each of the modal ratios in Table 3 (as well as other ratios not explicitly listed) exhibits a correlation with the tensile stress in the bolt. For example, FIG. 34 is a graph diagram illustrating ToF_{E1P-E1M3}/ToF_{Long} (third modal of echo 1) as a function of stress. The relationship between the ratios of Table 3 and stress is therefore analogous to the ratio of ToF_{Shear}/ToF_{Long} illustrated in FIG. 22. Thus, the ratios can be provided to a machine learning model as additional features to train the model and/or to make stress predictions. For example, in some embodiments, the ratios can be used in the methods of FIGS. 13-14, 16-21, and 24-26.

In other embodiments, the ratios in Table 3 can be used to improve predictions by comparing them to the ratio of ToF_{Shear}/ToF_{Long} as a means for identifying whether there are shifted ToFs in the ToF_{Shear}/ToF_{Long} ratio, thus improving the accuracy of predictions based on the ToF_{Shear}/ToF_{Long} ratio.

### (A) Ratio Comparisons to Validate or Cull Analyses

In the embodiments described herein, one of the overarching goals is to predict the tensile stress/residual tension of a target bolt using only instrumented (i.e., non-destructive) methods. As explained herein, this can be achieved by modeling the ToFᵣₐₜᵢₒ (e.g., ToF_{Shear}/ToF_{Long}) for a plurality of test bolts as a function of stress/tension, then using the model to predict the stress/tension in a target bolt by measuring the ToFᵣₐₜᵢₒ in the target bolt. Several inventive techniques for generating accurate models and other data are described above. For example, as explained above, machine learning models can be trained on data from a plurality of test bolts, then used to make predictions about the stress/tension (among other things) in a target bolt. Generally, the “cleaner” the training data, the more accurate the predictions will be.

The various ToF ratios listed in Table 3 (and others) can be used to “clean” the training data. That is, the ratios can be compared in different ways to determine whether some of the data actually included shifted ToFs (e.g., due to the cycle-skip problem) and is therefore contributing to errors in the model, which will impact the accuracy of predictions based on the model. The ratio-comparison method described below can thus act as a sort of filter to improve the accuracy of models and facilitate more accurate predictions of stress/tension in target bolts.

At a high level, the ratio-comparison seeks to determine whether, for a particular test event, the ToFs calculated from the raw data agree in different spaces. A “space” can be thought of as a relationship between stress/tension and each of the different ToF ratios (e.g., listed in Table 3). For example, the ratio of ToF_{Shear}/ToF_{Long} and stress can be thought of as one “space,” while the ratio of ToF_{E1P-E1M3}/ToF_{Long} and stress can be thought of as another “space.” For any given test event, the relative positions of the ratios within each space should generally agree. The larger the disagreement, the more likely the data included shifted ToFs (i.e., outliers from the main regression band) and should be culled. For example, a range of ToF measurements in the ToF shear/ToF_{Long} space that fall within a main band might be about 0.0130, whereas the range of ToF measurements in main band of the ToF_{E1P-E1M3}/ToF_{Long} space might be about 0.0030. Because ToF_{Long} appears in the denominator for both spaces, a shift in ToF_{Long} (i.e., cycle-skip) will have a different impact in the ToF_{Shear}/ToF_{Long} space versus the ToF_{E1P-E1M3}/ToF_{Long} space. This differing impact will cause the position of a ratio in one space to shift by a different amount in the other space. If the difference in the relative positions within each space exceeds a threshold, it can be concluded that the data included an outlier and should be culled. However, if the difference is below the threshold (or ideally 0), it can be concluded that the ToFs calculated are correct.

The concept of a “space” is introduced here as a helpful way to understand the ratio-comparisons. Of course, the ToF measurements and ratios developed therefrom can be represented in numerous other ways, such as with multi-dimensional arrays.

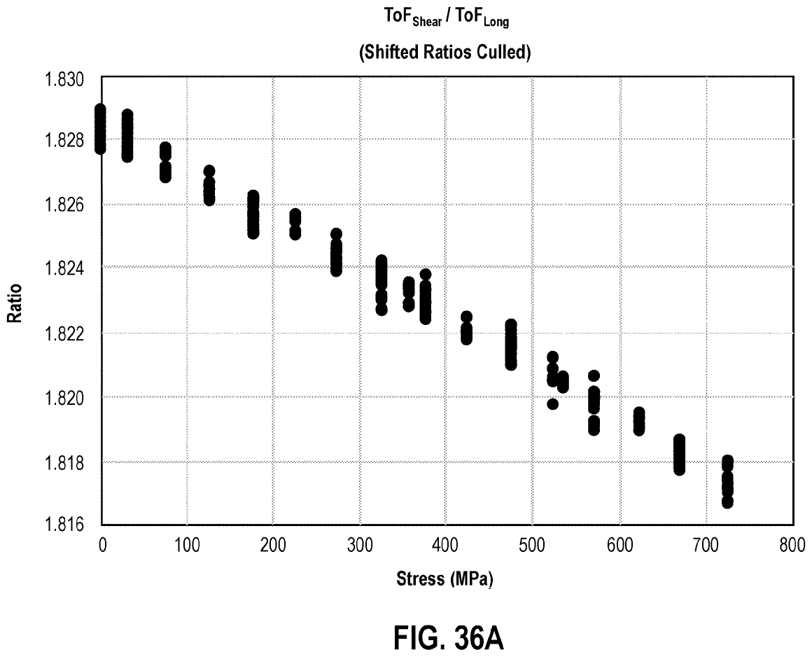

An example is now provided to illustrate how ratio-comparisons can be used to improve the quality of data. Data was collected for several bolts, all nominal size M42-345 mm, from which the various ToF measurements and ratios thereof were calculated. No attention was paid to whether the data included shifted ToFs. FIGS. 30A and 30B are graph diagrams illustrating the ratios ToF_{Shear}/ToF_{Long} (FIG. 30A) and ToF_{E1P-E1M3}/ToF_{Long} (FIG. 30B) calculated from the data as functions of stress. It is apparent from FIGS. 30A and 30B that the data, in fact, contained shifted ToFs because there are bands outside of the main bands. The range of each main band can be estimated based on the maximum and minimum ratio values in what is preliminarily determined to be the main band. These ranges are illustrated with dashed lines in FIGS. 35A and 35B. In the case of FIG. 35A, the range of ratio values spans from 1.816 to 1.830, resulting in a total range of 0.014. In the case of FIG. 35B, the range of ratio values spans from 0.2789 to 0.2821, resulting in a total range of 0.0032.

An alternative to setting the range for ratio limits so that the upper limit is just above the maximum value in the main band and the lower limit is just beneath the minimum value in the main band is to use the midpoints of the main band at the minimum and maximum stress values. For example, in FIGS. 35A and 35B, the minimum stress value is 0 MPa while the maximum stress value is about 740 MPa. The upper ratio limit can be set to the midpoint of the data values for the main band at 0 stress and the lower ratio limit can be set to the midpoint of the data values for the main band at 740 MPa.

The relative positions of ratios calculated from each test event should be approximately equal within each range if there were no shifted ToFs. For example, if a test event is conducted and the ToF_{Shear}/ToF_{Long} ratio for that event is calculated as 1.824, the position of that ratio within the ToF_{Shear}/ToF_{Long} range of FIG. 35A equates to 0.571, or 57.1% of the total range for that ratio (i.e., 1.824−1.816=0.008; 0.008/0.014=0.571). If there are no outliers in the data, the ToF_{E1P-E1M3}/ToF_{Long} ratio calculated from the same test event should also be around 57.1% of that range. Suppose that the ToF_{E1P-E1M3}/ToF_{Long} ratio calculated from the same test event is 0.2807. The position of that ratio within the ToF_{E1P-E1M3}/ToF_{Long} range of FIG. 30B is 0.563, or 56.3% of the total range for that ratio (i.e., 0.2807−0.2789=0.0018; 0.0018/0.0032=0.563). In this case, the difference in ratio positions is only about 0.8%, which suggests there were no outliers in the ToFs because the relative positions within each space generally agree.

On the other hand, suppose the ToF_{E1P-E1M3}/ToF_{Long} ratio results in 0.2811. The corresponding position within the ToF_{E1P-E1M3}/ToF_{Long} range would be 0.687, or 68.7% of the total range for that ratio (i.e., 0.2811−0.2789=0.0022; 0.0022/0.0032=0.687). Consequently, this hypothetical test event resulted in a ratio in one space that is positioned at 57.1% of the total range for that space, but produced a different ratio in another space that is positioned at 68.7% of the total range in that space. The difference in ratio positions for this hypothetical example is 11.6%. Given the significant difference between these ratio positions within their respective ranges, it can be concluded that one or more of the ToFs used in the calculations included an outlier. Accordingly, all data points generated from that test event can be culled from the data set.

It should be noted that if the upper and lower ratio limits are set using the midpoints of the main band, the ratio positions may include values slightly greater than 1 and slightly less than 0. That is because some data points will be above the 0 MPa midpoint and some values will be below the 740 MPa midpoint. Therefore, when performing the method using midpoints, different limits should be used when culling the data to make sure all values in the main band fall within the limits. For example, when midpoints are used, the upper and lower limits can be stretched by some percentage (depending on the data), such as 10%, 15%, 20%, 25% and so on.

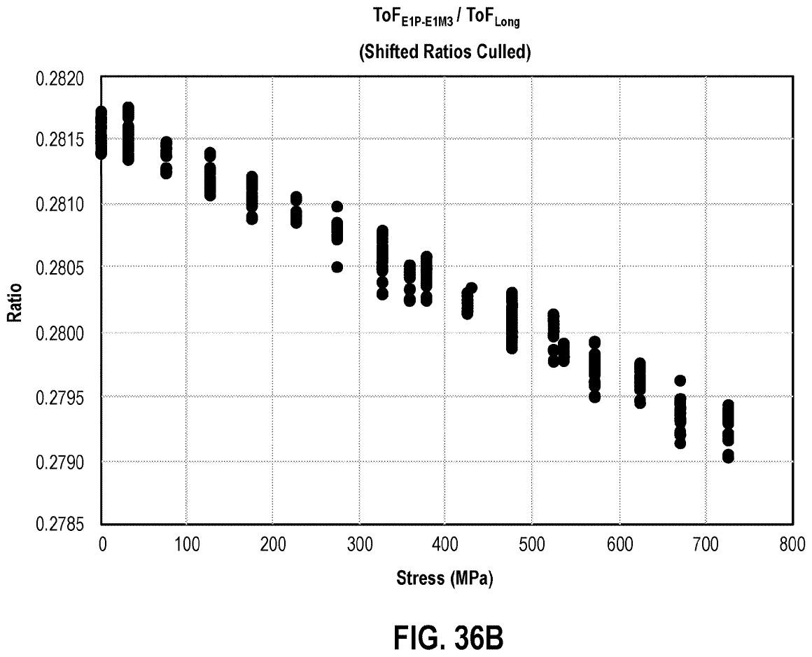

The amount of deviation for corresponding ratio positions that is tolerable can vary. For example, an agreement threshold of 3%, 4%, 5%, 6%, 7%, 8%, 9%, 10% and so can be used. Naturally, the larger the agreement threshold, the more likely it is for outliers to creep in. Conversely, if the agreement threshold is set too low, valid data may be inadvertently culled. Thus, in some embodiments, an agreement threshold of 4% is used. For example, FIGS. 36A and 36B are graph diagrams illustrating the results of performing the ratio-comparison method on all of the data points in FIGS. 35A and 35B using a 4% agreement threshold. As can be seen, what remains are only the main bands for each ratio. Accordingly, the resulting data accurately models the ToFᵣₐₜᵢₒ (e.g., ToF_{Shear}/ToF_{Long}) as a function of stress and can be used to make predictions on target bolts (e.g., by training a machine learning model with the data).

The example above compared the relative positions of data from the ToF_{E1P-E1M3}/ToF_{Long} space against corresponding data in the ToF_{Shear}/ToF_{Long} space. While it may be beneficial to compare positions of other ratios (e.g., from Table 3) against the positions in the ToF_{Shear}/ToF_{Long} space since ToF_{Shear}/ToF_{Long} will ultimately be used for predictions, other spaces can also be used for comparisons since each ratio is calculated based on data from the same test event. Additionally, the ranges in each space were set based on the initial set of collected data. One variation to the ratio-comparison method is to dynamically and recursively update the ranges as data is culled from the data set.

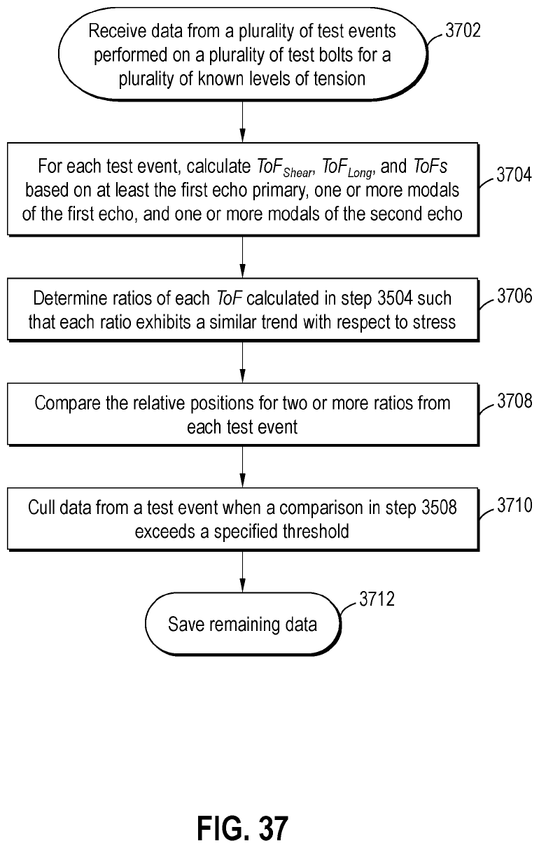

FIG. 37 is a flow diagram illustrating an example method for performing ratio-comparisons based on the above description. The method can be used with the systems and methods disclosed herein.

### (B) Ratio Comparison & Correction

Another way to use ratio comparisons to improve the accuracy of models and predictions is to consider additional ToFs and ToF ratios, even if they include shifted and un-shifted ToFs, and then compare every ToFᵣₐₜᵢₒ constructed from the ToFs to determine which combination of ToFs produces the lowest error. The presumption is that the ToF_{Shear}/ToF_{Long} associated with the combination that produces the lowest error should be the correct ToF_{Shear}/ToF_{Long}. That is, the ToF_{Shear}/ToF_{Long} associated with the lowest error likely does not include shifted ToFs and should put the ratio within the main band. This ToF_{Shear}/ToF_{Long} can then be used to make predictions (e.g., as training data for a machine learning model).

For example, when cross correlation is used to calculate a ToF, it is presumed that the highest peak in the cross correlation is the correct ToF. But that is not always the case. Sometimes, the highest peak in the cross correlation function actually produces a shifted ToF, which will cause a ratio constructed therefrom to fall outside of the main band. Rather than endeavor to determine whether a shifted ToF has occurred, an alternative is to use more than just the highest peak from the cross correlation function to generate several ToFs, then construct several ratios from those ToFs, compare all of the different possible ratio positions, and select the ToF_{Shear}/ToF_{Long} that is associated with the combination of ratio positions that produced the lowest error.

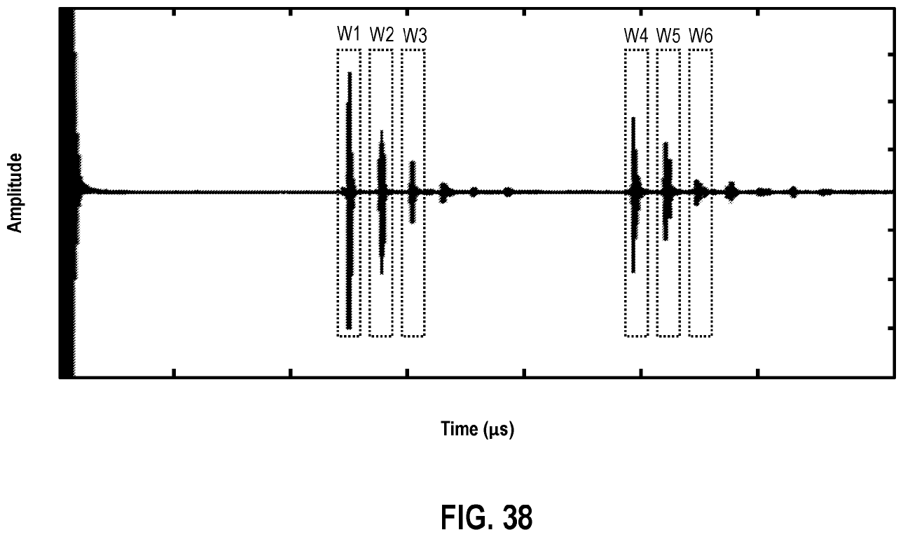

An example is now provided to illustrate the ratio comparison and correction method. Suppose that data is collected from a test event in which a test bolt is set to a known level of tension, such as 650 MPa. The data will result in several echoes, each echo having a primary set of peaks (i.e., direct wave) and several sets of modal peaks. To simplify the example, suppose that only the first two modals from each of the first two echoes will be considered. The location of each primary and the four modal sets of peaks can be identified as explained above. From the locations, windows can be constructed around each set of peaks for cross correlation. FIG. 38 is a graph diagram illustrating an example longitudinal wave signal with windows drawn around each set of peaks that will be considered for cross correlation in this example.

To find ToF_{Long}, windows W1 and W4 can be cross correlated. To find ToF_{E1P-E1M1}, windows W1 and W2 can be cross correlated. To find ToF_{E1P-E1M2}, windows W1 and W3 can be cross correlated. To find ToF_{E1P-E2M1}, windows W1 and W5 can be cross correlated. To find ToF_{E1P-E2M2}, windows W1 and W6 can be cross correlated. Although not shown, the ToF_{Shear} can be found in the same way (i.e., cross correlating the first and second echo primaries). Each cross correlation for each ToF type will result in a function having peaks of varying amplitudes. As explained above, it is often the case that the highest peak corresponds to the correct ToF. But instead of using only the highest peaks, suppose that the two highest peaks from each cross correlation are considered. This will result in two different ToF measurements for each type. Table 4 lists different ToFs that can be measured in this hypothetical example:

TABLE 4
ToF Measurements

| ToF No. | ToF Type |
|---|---|
| 1 | 1ToF_{Long} |
| 2 | 2ToF_{Long} |
| 3 | 1ToF_{Shear} |
| 4 | 2ToF_{Shear} |
| 5 | 1ToF_{E1P-E1M1} |
| 6 | 2ToF_{E1P-E1M1} |
| 7 | 1ToF_{E1P-E1M2} |
| 8 | 2ToF_{E1P-E1M2} |
| 9 | 1ToF_{E1P-E2M1} |
| 10 | 2ToF_{E1P-E2M1} |
| 11 | 1ToF_{E1P-E2M2} |
| 12 | 2ToF_{E1P-E2M2} |

where the “1” or “2” prepended to each ToF type indicates whether it was based on the highest or the second highest peak in the cross correlation function, respectively.

Each ToF type can be used in different combinations with other ToF types to create ratios as explained above. For example, from the 12 ToF types in Table 4, at least the following ratios can be constructed:

TABLE 5
ToF Measurements

| Ratio No. | ToF Ratio |
|---|---|
| 1 | 1ToF_{Shear}/1ToF_{Long} |
| 2 | 1ToF_{Shear}/2ToF_{Long} |
| 3 | 2ToF_{Shear}/1ToF_{Long} |
| 4 | 2ToF_{Shear}/2ToF_{Long} |
| 5 | 1ToF_{E1P-E1M1}/1ToF_{Long} |
| 6 | 1ToF_{E1P-E1M1}/2ToF_{Long} |
| 7 | 2ToF_{E1P-E1M1}/1ToF_{Long} |
| 8 | 2ToF_{E1P-E1M1}/2ToF_{Long} |
| 9 | 1ToF_{E1P-E1M2}/1ToF_{Long} |
| 10 | 1ToF_{E1P-E1M2}/2ToF_{Long} |
| 11 | 2ToF_{E1P-E1M2}/1ToF_{Long} |
| 12 | 2ToF_{E1P-E1M2}/2ToF_{Long} |
| 13 | 1ToF_{E1P-E2M1}/1ToF_{Long} |
| 14 | 1ToF_{E1P-E2M1}/2ToF_{Long} |
| 15 | 2ToF_{E1P-E2M1}/1ToF_{Long} |
| 16 | 2ToF_{E1P-E2M1}/2ToF_{Long} |
| 17 | 1ToF_{E1P-E2M2}/1ToF_{Long} |
| 18 | 1ToF_{E1P-E2M2}/2ToF_{Long} |
| 19 | 2ToF_{E1P-E2M2}/1ToF_{Long} |
| 20 | 2ToF_{E1P-E2M2}/2ToF_{Long} |

In this example, it is presumed that one of Ratio Nos. 1-4 is the correct ToF_{Shear}/ToF_{Long} and includes only un-shifted ToFs, which will result in a ToFᵣₐₜᵢₒ in the main band. But since the correct ratio is not yet known, the ratio comparison and correction method can be used to find it. The method compares the ratio positions for different ToF combinations against corresponding ToF_{Shear}/ToF_{Long} ratio positions to identify the combination that produces the lowest error in positions.

For example, the positions for Ratios Nos. 5, 9, 13, and 17 can be compared against the position for Ratio No. 1. These ratios were chosen for comparison because (i) each is based on the same ToF_{Long} (i.e., 1ToF_{Long}) and (ii) each includes a ToF from the four modals. Another comparison can be the positions for Ratio Nos. 5, 9, 13, and 19 against Ratio No. 1. Table 6 lists different combinations that meet the criteria of (i) and (ii) above with respect to comparison against Ratio No. 1:

TABLE 6
Ratio Position Comparisons against Ratio No. 1

| Comparison No. | Ratio Nos. |
|---|---|
| 1 | 5, 9, 13, 17 |
| 2 | 5, 9, 13, 19 |
| 3 | 5, 9, 15, 17 |
| 4 | 5, 9, 15, 19 |
| 5 | 5, 11, 13, 17 |
| 6 | 5, 11, 13, 19 |
| 7 | 5, 11, 15, 17 |
| 8 | 5, 11, 15, 19 |
| 9 | 7, 9, 13, 17 |
| 10 | 7, 9, 13, 19 |
| 11 | 7, 9, 15, 17 |
| 12 | 7, 9, 15, 19 |
| 13 | 7, 11, 13, 17 |
| 14 | 7, 11, 13, 19 |
| 15 | 7, 11, 15, 17 |
| 16 | 7, 11, 15, 19 |

This same concept is applied for comparisons against each of Ratio Nos. 2, 3, and 4. The difference from each comparison can be squared to find the error, and then the errors summed to find the total error for the comparison. At the end of this example, there will be 64 total error values. The combination that produces the lowest total error (i.e., best ratio-position agreement between each combination of modal ratios and ToF_{Shear}/ToF_{Long}) will likely be based on only un-shifted ToFs. Thus, the ToF_{Shear}/ToF_{Long} associated with that combination is the correct ToFᵣₐₜᵢₒ that should be used to make predictions (e.g., as training data for a machine learning model).

To further illustrate the ratio comparison and correction method, a numerical example is now provided. Consider again the data collected on the set of M42-345 mm bolts (see FIGS. 35A and 35B). This example will illustrate how, if the ToF_{Long} being considered from a test event is shifted one period low, but the ToF_{E1P-E1M3} and ToF_{Shear} are both un-shifted, the ratio positions will no longer agree. For this example, assume the correct ratio position for ToF_{Shear}/ToF_{Long} at 650 MPa is 0.2.

Suppose now that a test event is conducted in which ToF_{Long} is shifted one period low while ToF_{Shear} and ToF_{E1P-E1M3} remain un-shifted. Both ratios will increase because ToF_{Long} is in the denominator of each, but the shift will be by different amounts. Suppose that the frequency of the longitudinal transducer used for the test event is 2.25 MHz, which results in a wave period of 1/2.25 MHz=0.44 μs. Suppose further that longitudinal waves propagate with a velocity of 5.88 mm/μs in the bolt under consideration, that shear waves propagate with a velocity of 3.22 mm/μs, and that ToF_{E1P-E1M3} is about 28% of ToF_{Long}. With these quantities, the ToFs can be calculated as:

$${ToF}_{Shear} = \frac{( 2 \times 345 mm )}{3.22 mm / μs} = 214.29 μs$$

$${ToF}_{Long} = \frac{( 2 \times 345 mm )}{5.88 mm / μs} = 117.35 μs$$

$${ToF}_{Long - 1} = 117.35 μs - 0.44 μs = 116.91 μs$$

$${ToF}_{E 1 P - E 1 M 3} = 0.28 \times 117.35 μs = 32.86 μs$$

When all ToFs are un-shifted, the ratios will be:

$$\frac{{ToF}_{Shear}}{{ToF}_{Long}} = \frac{214.29 μs}{117.35 μs} = 1.8261$$

$$\frac{{ToF}_{E 1 P - E 1 M 3}}{{ToF}_{Long}} = \frac{32.86 μs}{117.35 μs} = 0.28$$

When ToF_{Long} is shifted one period low, the ratios will be:

$$\frac{{ToF}_{Shear}}{{TOF}_{Long}} = \frac{214.29 μs}{116.91 μs} = 1.8329$$

$$\frac{{ToF}_{E 1 P - E 1 M 3}}{{TOF}_{Long}} = \frac{32.86 μs}{116.91 μs} = 0.2811$$

The change in each ratio can be calculated as:

$$Δ \frac{{ToF}_{Shear}}{{TOF}_{Long}} = 1.8329 - 1.8261 = 0.0068$$

$$Δ \frac{{ToF}_{E 1 P - E 1 M 3}}{{TOF}_{Long}} = 0.2811 - 0.28 = 0.0011$$

The changes in each ratio can be converted to changes in ratio positions as:

$$Δ \frac{{ToF}_{Shear}}{{TOF}_{Long}} postion = \frac{Δ \frac{{ToF}_{Shear}}{{TOF}_{Long}}}{( Span of \frac{{ToF}_{Shear}}{{TOF}_{Long}} ratios )} = \frac{0.0068}{0.014} = 0.486$$

$$Δ \frac{{ToF}_{E 1 P - E 1 M 3}}{{TOF}_{Long}} position = \frac{Δ \frac{{ToF}_{E 1 P - E 1 M 3}}{{TOF}_{Long}}}{( Span of \frac{{ToF}_{E 1 P - E 1 M 3}}{{TOF}_{Long}} ratios )} = \frac{0.0011}{0.0032} = 0.344$$

The change in ratio positions for this example, where the ToF_{Long} was shifted down one period, can be added to the correct ratio positions of 0.2 (i.e., when ToF_{Long} was un-shifted):

$$\frac{{ToF}_{Shear}}{{TOF}_{Long}} postion = 0.2 + 0.486 + 0.686$$

$$\frac{{ToF}_{E 1 P - E 1 M 3}}{{TOF}_{Long}} position = 0.2 + 0.344 = 0.544$$

This example shows that when the ToF_{Long} is shifted low by one period, the ratio positions of ToF_{Shear}/ToF_{Long} and ToF_{E1P-E1M3}/ToF_{Long} no longer agree. That is, the shift in ToF_{Long} impacted these two ratios differently. For example, had there been no shifts in ToF_{Long}, the ratio position error would have been (0.2−0.2)², which is to be expected. However, in this example where ToF_{Long} was shifted low by one period, the ratio position error can be calculated as (0.686−0.544)².

So far, the ratio comparison and correction method has been explained in terms of using only two ToFs calculated from cross correlation for only four modals of two echoes. That was only for purposes of explaining the invention. The method can be generalized to include several echoes, several modal waves from each echo, and several ToFs calculated from each cross correlation. For example, in some embodiments, 2, 3, 4, 5, 6, 7, and so on, modals from the first, second, third, and so on echoes can be used. In some embodiments, the highest 2, 3, 4, 5, 6, 7, 8, 9, 10, and so on amplitudes in each cross correlation can be used. In this way, the total number of possible ToF combinations for ratios and thus the total number of comparisons will increase significantly, thereby providing an even higher degree of accuracy in finding the correct ToF_{Shear}/ToF_{Long}.

The total computations can be reduced by using only a subset of the available data. For example, in some embodiments, the longitudinal wave ToFs and shear wave ToFs associated with only some of the peaks from their respective cross correlation functions can be used, such as the 2 highest, 3 highest, 4 highest, and so on. In some embodiments, the number of ToF_{Long} values used may not match the number of ToF_{Shear} values used. For example, in some embodiments, the three highest ToF_{Long} values may be used, but only those ToF_{Shear} values that can produce a ToF_{Shear}/ToF_{Long} ratio that falls within specified ratio limits can be used, which may or may not be three. The ratio limits can be based on, e.g., historical or empirical data.

Another way to reduce the computations is to consider a limited number of echoes. For example, in some embodiments, only the first echo is used. In other embodiments, only the first and second echoes are used.

Yet another way to reduce the computations is to use a limited number of modal ToFs from each echo. For example, in some embodiments, only the first, third, and fifth modal from each echo is used. In other embodiments, only the first, second, and third modal from each echo is used. Yet in other embodiments, only the first five modals from each echo are used.

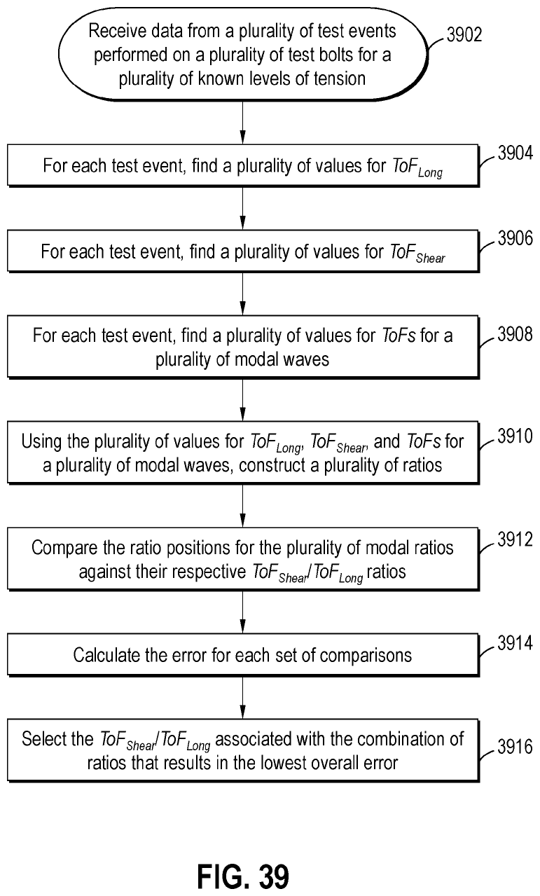

FIG. 39 is a flow diagram illustrating an example method for performing ratio-comparisons based on the description of the ratio comparison and correction method above. The method can be used with the systems and methods disclosed herein.

### (C) Comparing Stress Predictions From Different Models

Ratio comparisons can be used as features to compare stress predictions from two or more machine learning models. For example, training data can be collected from a plurality of test bolts as explained above. Before training a machine learning model, upper and lower modal ratio thresholds can be set to eliminate data points from the collected data that are likely to fall outside of the main band. From the remaining data, a first machine learning model can be trained in which a modal ratio is forced as the first feature to be selected by Sequential Feature Selection (SFS). For example, in some embodiments, the ToF_{E1P-E1M2}/ToF_{Long} is forced as a feature. In other embodiments, ToF_{E1P-E1M3}/ToF_{Long} is forced as a feature. Other modal ratios can also be used as the first-forced feature. In addition to modal ratios, other features (e.g., 3, 4, 5, 6, and so on) can be selected that best reduces the prediction error. In this first model, ToFₛₕₑₐᵣ/ToF_{Long} is excluded because it will be used to train a second model.

Before training a second model, upper and lower ToF_{Shear}/ToF_{Long} thresholds can be set to eliminate data points that are likely to fall outside of the main band. A second machine learning model can then be trained using the remaining data in which ToF_{Shear}/ToF_{Long} is forced as the first feature to be selected by SFS, which additionally selects other features (e.g., 3, 4, 5, 6, and so on) that best reduces the prediction error. In this second model, modal ratios are excluded from selection since they were used in training the first model.

With two independent models trained, two separate stress predictions can be made and compared. If their difference is less than a specified threshold, the prediction from the ToF_{Shear}/ToF_{Long} model can be considered valid and used to make final predictions. If, on the other hand, the difference is larger than the threshold, then no prediction might be made from the ToF_{Shear}/ToF_{Long} model. The threshold can be, for example, a percentage of the maximum stress/tension expected to see in a bolt, such as 15%, 20%, 25%, and so on.

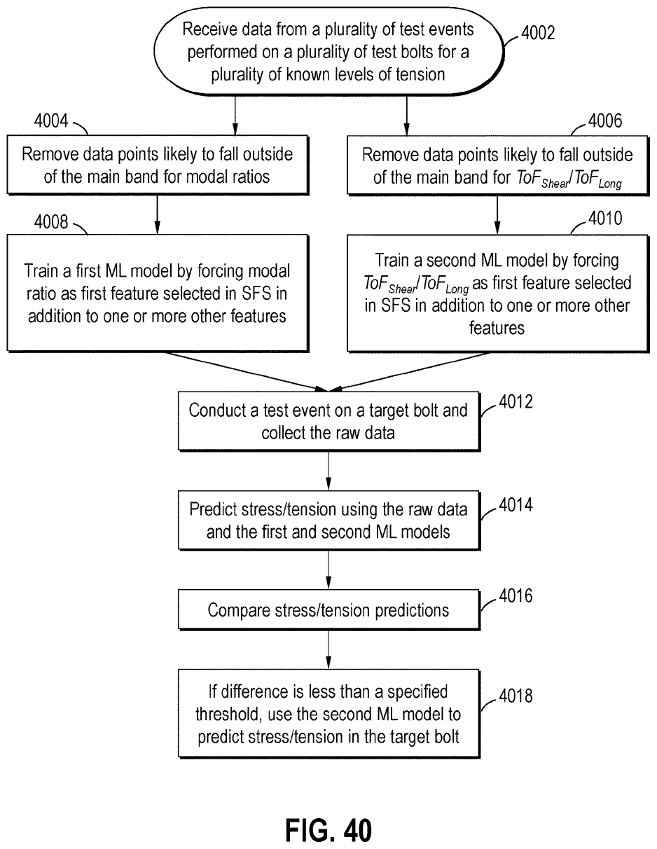

FIG. 40 is a flow diagram illustrating an example method for comparing stress predictions from two machine learning models. The method can be used with the system and methods disclosed herein.

### (D) Comparing Stress Predictions Using Best Fit Lines

An alternative to comparing ratio positions is to compare stress predictions based on best fit lines. For example, the modal ratios can be constructed in the same way as described above. For each ratio type, an equation for a best fit line for each main band can be generated. After each ratio is calculated for a given ToF combination, rather than converting it to a ratio position and comparing the positions, the calculated ratio can be plugged into its respective best-fit line equation to generate a stress value. The stress values can be compared against the stress values for ToF_{Shear}/ToF_{Long}. Similar to above, the lowest overall error for a particular combination is likely associated with the correct ToF_{Shear}/ToF_{Long}, and therefore can be used for predictions (e.g., as training data for a machine learning model).

One benefit of comparing stress predictions instead of ratio positions is that the best-fit line equations can be found using an error-minimizing approach and all data points. By comparison, the ratio-position method depends on the location of the upper and lower ratio limits.

Throughout this disclosure, the ToFᵣₐₜᵢₒ used in describing the embodiments has been based primarily in terms of ToF_{Shear}/ToF_{Long}. This was for convenience only. Every embodiment described herein and/or illustrated in the figures can also be based on ToF_{Long}/ToF_{Shear}.

The methods described herein can be implemented with instructions stored in memory and executed by one or more processors. For example, the methods can be implemented with instructions stored in memory on processing device 230 and executed by processor(s) 242. Alternatively or additionally, the methods can be stored in memory on an external computing device and executed by one or more processors on the computing device. For example, in some embodiments, training data can be collected from a set of test bolts in a laboratory setting and used to train a machine learning model. The methods described herein can be used to process the training data to improve the quality of the data. The machine learning model can be deployed on processing device 230 and used in the field to determine the tensile stress/residual tension in target bolts. For example, in some embodiments, a tablet computer can include software stored thereon that includes machine learning models trained to detect bolt coating, to detect bolt size and length, to detect and replace outliers, and/or to predict stress/tension. A field operator can use the tablet computer and the systems and methods disclosed herein to determine the stress/tension in one or more target bolts disposed on a structure, such as a wind turbine tower. For example, the field operator can perform one or more test events on a target bolt, collect the raw data from each event, and apply the data as input to the machine learning models. The machine learning models can provide the stress/tension predictions in the one or more target bolts in real time.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law. Further, the sequence of steps for the example methods described or illustrated herein are not to be construed as necessarily requiring their performance in the particular order described or illustrated unless specifically identified as requiring so or clearly identified through context. Moreover, the example methods may omit one or more steps described or illustrated, or may include additional steps in addition to those described or illustrated. Thus, one of ordinary skill in the art, using the disclosures provided herein, will appreciate that various steps of the example methods can be omitted, rearranged, combined, and/or adapted in various ways without departing from the spirit and scope of the inventions.

1-11. (canceled)

12. A method for generating a dataset to train a machine learning model to predict a characteristic of a target bolt in situ, the method comprising:
setting each of a plurality of test bolts to a plurality of known levels of tension;
for each known level of tension set in each test bolt,
determining a time-of-flight of longitudinal waves in the test bolt;
determining a time-of-flight of shear waves in the test bolt;
determining a ratio of the time-of-flight of shear waves and the time-of-flight of longitudinal waves;
determining a temperature of the test bolt;
determining a size of the test bolt; and
determining a plurality of signal-characterizing features.

13. The method of claim 12, wherein determining a time-of-flight of longitudinal waves in the test bolt comprises:
receiving a signal from a test event on the test bolt, wherein the signal comprises at least a first echo and a second echo of a longitudinal wave in the test bolt;
determining that the signal passes one or more signal quality checks; and
performing cross correlation on the signal to determine the time-of-flight of the longitudinal wave, wherein performing cross correlation comprises using a flexible window algorithm.

14. The method of claim 13, wherein the flexible window algorithm comprises:
filtering the signal at a dominant frequency;
establishing a first starting point for a first window for the first echo and a second starting point for a second window for the second echo;
establishing a minimum and a maximum size for the first and second windows;
establishing a plurality of delay times for the second window;
for each delay time for the second window, establishing a plurality of window sizes for the first and second windows and determining which of the plurality of window sizes meets one or more criteria;
for each window size that meets the one or more criteria, calculating a cross correlation function;
determining a maximum amplitude of all cross correlation functions; and
identifying the time-of-flight of the longitudinal wave as a time value corresponding to the maximum amplitude.

15. The method of claim 12, wherein determining a time-of-flight of shear waves in the test bolt comprises:
receiving a signal from a test event on the test bolt, wherein the signal comprises at least a first echo and a second echo of a shear wave in the test bolt;
determining that the signal passes one or more signal quality checks; and
performing cross correlation on the signal to determine the time-of-flight of the shear wave, wherein performing cross correlation comprises using a flexible window algorithm.

16. The method of claim 15, wherein the flexible window algorithm comprises:
filtering the signal at a dominant frequency;
establishing a first starting point for a first window for the first echo and a second starting point for a second window for the second echo;
establishing a minimum and a maximum size for the first and second windows;
establishing a plurality of delay times for the second window;
for each delay time for the second window, establishing a plurality of window sizes for the first and second windows and determining which of the plurality of window sizes meets one or more criteria;
for each window size that meets the one or more criteria, calculating a cross correlation function;
determining a maximum amplitude of all cross correlation functions; and
identifying the time-of-flight of the shear wave as a time value corresponding to the maximum amplitude.

17. The method of claim 12, wherein determining a plurality of signal-characterizing features comprises:
receiving a first signal from a first test event on the test bolt, wherein the first signal comprises at least a first echo and a second echo of a longitudinal wave in the test bolt;
receiving a second signal from a second test event on the test bolt, wherein the second signal comprises at least a first echo and a second echo of a shear wave in the test bolt;
extracting one or more features from the first signal;
extracting one or more features from a cross correlation performed on the first signal;
extracting one or more features from the second signal; and
extracting one or more features from a cross-correlation performed on the second signal.

18-22. (canceled)

23. A method for predicting tensile stress of a target bolt in situ, the method comprising:
receiving an input dataset comprising data relating to a target bolt;
providing the input dataset to a first machine learning model that is trained on bolt coating;
detecting the coating of the target bolt;
based on the coating of the target bolt that is detected, selecting a second machine learning model that is trained to detect an aspect of the input dataset;
providing the input dataset to the second machine learning model;
detecting the aspect of the input dataset;
based on the coating of the target bolt that is detected, selecting a third machine learning model that is trained on stress;
providing the input dataset to the third machine learning model;
and predicting stress in the target bolt based on the third machine learning model and the input dataset.

24. A processing device for predicting tensile stress of a target bolt in situ, the processing device comprising:
memory, wherein the memory stores:
a first machine learning model that is trained on bolt coating and configured to detect one of a plurality of different types of bolt coatings;
a plurality of second machine learning models that are trained to an aspect of a dataset, wherein the plurality of second machine learning models correspond to different types of bolt coatings; and
a plurality of third machine learning models that are trained on stress, wherein the plurality of third machine learning models correspond to different types of bolt coatings;
an input configured to receive raw data relating to reflections of ultrasonic shear waves and reflections of ultrasonic longitudinal waves in the target bolt;
a processor coupled to the memory, wherein the memory stores instructions that, when executed by the processor, cause the processor to:
determine a time-of-flight of shear waves (ToF_{Shear}) in the target bolt from the raw data;
determine a time-of-flight of longitudinal waves (ToF_{Long}) in the target bolt from the raw data;
determine a ratio of ToF_{Shear} and ToF_{Long} (ToFᵣₐₜᵢₒ);
receive a temperature value of the target bolt;
determine the coating of the target bolt based on the first machine learning model, ToF_{Shear}, ToF_{Long}, ToFᵣₐₜᵢₒ, and temperature value;
select one of the plurality of second machine learning models based on the detected coating of the target bolt;
detect an aspect of or make a determination about ToF_{Shear}, ToF_{Long}, ToFᵣₐₜᵢₒ, or temperature value;
select one of the plurality of third machine learning models based on the detected coating of the target bolt; and
predict the stress in the target bolt based on the third machine learning model selected, ToF_{Shear}, ToF_{Long}, ToFᵣₐₜᵢₒ, and temperature value.

25-26. (canceled)

27. A method for predicting tensile stress of a target bolt in situ, the method comprising:
receiving an input dataset, wherein the input dataset comprises data relating to a time-of-flight of longitudinal waves in the target bolt, a time-of-flight of shear waves in the target bolt, a temperature of the target bolt, and a plurality of signal-characterizing features;
providing the input dataset to a first machine learning model that is trained on bolt coating;
detecting the coating of the target bolt;
based on the coating of the target bolt that is detected, selecting a second machine learning model that is trained on bolt size;
providing the input dataset to the second machine learning model selected;
detecting the size of the target bolt;
based on the coating and size of the target bolt that are detected, selecting a third machine learning model that is trained on bolt length;
providing the input dataset to the third machine learning model selected;
detecting the length of the target bolt;
based on the coating, size and length of the target bolt that are detected, selecting a fourth machine learning model that is trained on stress;
providing the input dataset to the fourth machine learning model selected;
and predicting stress in the target bolt based on the fourth machine learning model and the input dataset.

28. A processing device for predicting tensile stress of a target bolt in situ, the processing device comprising:
memory, wherein the memory stores:
a first machine learning model that is trained on bolt coating and configured to detect one of a plurality of different types of bolt coatings;
a plurality of second machine learning models that are trained on bolt size, wherein the plurality of second machine learning models correspond to different types of bolt coatings;
a plurality of third machine learning models that are trained on bolt length, wherein the plurality of third machine learning models correspond to combinations of different types of bolt coatings and different bolt sizes; and
a plurality of fourth machine learning models that are trained on stress, wherein the plurality of fourth machine learning models correspond to combinations of different types of bolt coatings, bolt sizes, and bolt lengths;
an input configured to receive raw data relating to reflections of ultrasonic shear waves and reflections of ultrasonic longitudinal waves in the target bolt;
a processor coupled to the memory, wherein the memory stores instructions that, when executed by the processor, cause the processor to:
determine a time-of-flight of shear waves (ToF_{Shear}) in the target bolt from the raw data;
determine a time-of-flight of longitudinal waves (ToF_{Long}) in the target bolt from the raw data;
determine a ratio of ToF_{Shear} and ToF_{Long} (ToFᵣₐₜᵢₒ);
receive a temperature value of the target bolt;
determine the coating of the target bolt based on the first machine learning model, ToF_{Shear}, ToF_{Long}, ToFᵣₐₜᵢₒ, and temperature value;
determine the size of the target bolt based the coating of the target bolt, one of the plurality of second machine learning models, ToF_{Shear}, ToF_{Long}, ToFᵣₐₜᵢₒ, and temperature value;
determine the length of the target bolt based on the coating of the target bolt, the size of the target bolt, one of the plurality of third machine learning models, ToF_{Shear}, ToF_{Long}, ToFᵣₐₜᵢₒ, and temperature value; and
determine the stress in the target bolt based on the coating of the target bolt, the size of the target bolt, the length of the target bolt, one of the plurality of fourth machine learning models, ToF_{Shear}, ToF_{Long}, ToFᵣₐₜᵢₒ, and temperature value.

29. The method of claim 23, wherein the input dataset comprises data relating to a time-of-flight of longitudinal waves in the target bolt, a time-of-flight of shear waves in the target bolt, a temperature of the target bolt, and a plurality of signal-characterizing features.

30. The method of claim 29, wherein the second machine learning model is trained to detect outliers in the input dataset; and
wherein detecting the aspect of the input dataset comprises determining that no outliers are present in the input dataset.

31. The method of claim 29, wherein the input dataset further comprises one or more alternate times-of-flight;
wherein the second machine learning model is trained to detect shifted times-of-flight;
wherein detecting the aspect of the input dataset comprises detecting that the input dataset includes at least one shifted time-of-flight;
wherein the method further comprises determining that the number of wave periods that the at least one shifted time-of-flight is shifted does not exceed a threshold;
replacing the shifted time-of-flight in the input dataset with one of the one or more alternate times-of-flight to revise the input dataset; and
wherein the revised input dataset is provided to the third machine learning model.

32. The processing device of claim 24, wherein the plurality of second machine learning models are trained to detect outliers; and
wherein the instructions that, when executed by the processor, cause the processor to detect an aspect of or make a determination about ToF_{Shear}, ToF_{Long}, ToFᵣₐₜᵢₒ, or temperature value comprise determining that ToFᵣₐₜᵢₒ does not contain any outliers based on the second machine learning model selected, ToF_{Shear}, ToF_{Long}, ToFᵣₐₜᵢₒ, and temperature value.

33. The processing device of claim 24, wherein the plurality of second machine learning models are trained to detect shifted times-of-flight;
wherein the instructions that, when executed by the processor, cause the processor to detect an aspect of or make a determination about ToF_{Shear}, ToF_{Long}, ToFᵣₐₜᵢₒ, or temperature value comprise detecting that at least one of ToF_{Shear}, ToF_{Long}, and ToFᵣₐₜᵢₒ comprises a shifted time-of-flight; and
wherein the instructions that, when executed by the processor, further cause the processor to:
determine one or more alternate times-of-flight;
determine that the number of wave periods that the shifted time-of-flight is shifted does not exceed a threshold; and
replace the shifted time-of-flight for the at least one of ToF_{Shear}, ToF_{Long}, and ToFᵣₐₜᵢₒ with one of the one or more alternate times-of-flight.
